(19) United States
(12) Patent Application Publication
(10) Pub. No.: US 2025/0322676 A1
(43) Pub. Date: Oct. 16, 2025

(54) FRUIT MONITORING SYSTEM USED IN CROP MANAGEMENT SYSTEM

(71) Applicant: Agricultural Corporation ioCrops Inc., Pohang-si (KR)

(72) Inventors: Jinhyung CHO, Seoul (KR); Yongjin SHIN, Seoul (KR); Toil KIM, Seoul (KR); Sohee SIM, Seoul (KR)

(73) Assignee: Agricultural Corporation ioCrops Inc., Pohang-si (KR)

(21) Appl. No.: 19/251,524

(22) Filed: Jun. 26, 2025

Related U.S. Application Data
(63) Continuation of application No. PCT/KR2023/021812, filed on Dec. 28, 2023.

(30) Foreign Application Priority Data
Dec. 29, 2022 (KR) 10-2022-0188525
Jul. 31, 2023 (KR) 10-2023-0099680

(51) Int. Cl. G06V 20/68; G06V 20/10

(52) U.S. Cl. CPC G06V 20/68; G06V 20/188

(57) ABSTRACT

A method for counting fruits corresponding to a crop row located in a greenhouse may comprise the steps of: acquiring a plurality of images corresponding to a first crop row; acquiring representative distance values for a plurality of a fruit areas on the basis of the plurality of images corresponding to the first crop row; on the basis of the representative distance values for the plurality of fruit areas; calculating a first threshold distance value for distinguishing the first crop row from the second crop row; and determining the number of fruits corresponding to the first crop row by comparing the representative distance values for the plurality of fruit areas with the first threshold distance value.

### CROSS-REFERENCE TO RELATED APPLICATIONS

This application is a continuation of International Application No. PCT/KR2023/021812 filed on Dec. 28, 2023, which claims priority to Korean Patent Application No. 10-2022-0188525 filed on Dec. 29, 2022 and Korean Patent Application No. 10-2023-0099680 filed on Jul. 31, 2023, the entire contents of which are herein incorporated by reference.

### TECHNICAL FIELD

The present disclosure relates to a crop management system and, more particularly, to a fruit monitoring system used in a crop management system.

### BACKGROUND ART

Agriculture belongs to an industrial sector providing the fundamental energy for people to live, and has been evaluated as a large-scale industrial sector since the past.

However, the rate at which cutting-edge technology is applied appears to be low compared to other industrial sectors considering its scale.

However, recently, there have been movements to apply cutting-edge technologies such as smart farms and smart greenhouses in the agricultural sector, which may be considered as a sector outside of the cutting-edge technologies, and thus, related technologies are being studied.

However, in reality, only technologies are currently being studied to the extent of collecting data related to greenhouses.

Accordingly, there is a need to develop technologies that go beyond simply obtaining the data related data on greenhouses and meaningfully monitor fruits by using the data related data on the greenhouses.

In addition, there is also a need to develop a technology determining the actual ripeness of a number of fruits located in a greenhouse, rather than a technology simply determining the ripeness of a single fruit in a laboratory.

### SUMMARY

### Technical Problem

An objective of the present disclosure is to provide a method of counting fruits corresponding to a specific crop row among fruits located in a greenhouse.

Another objective of the present disclosure is to provide a method of generating a map of fruits by obtaining images of a plurality of crop plants located in a greenhouse.

A yet another objective of the present disclosure is to provide a method of obtaining representative ripeness values representing the ripeness of different sides of a fruit located in a greenhouse.

The problems to be solved in the embodiments of the present disclosure are not limited to the above-mentioned problems, and the problems not mentioned will be clearly understood by those skilled in the art to which the embodiments of the present disclosure belong from the present specification and accompanying drawings.

### Technical Solution

According to an embodiment of the present disclosure, there is provided a method for counting fruits corresponding to a crop row, performed by one or more processors, comprising: obtaining a plurality of images corresponding to a first crop row, wherein at least one image of the plurality of images represents at least one fruit located in a second crop row, obtaining a representative distance values for a plurality of fruit regions based on the plurality of images corresponding to the first crop row, calculating a first threshold distance value for distinguishing between the first crop row and the second crop row, based on the representative distance values for the plurality of fruit regions and determining a number of fruits corresponding to the first crop row by comparing the representative distance values for the plurality of fruit regions with the first threshold distance value.

According to another exemplary embodiment of the present disclosure, there is provided a method for generating a map of fruits by moving a vehicle to which an image acquisition device is attached and obtaining images of a plurality of crop plants located in a greenhouse, the method including: obtaining feature values for at least one fruit region on the basis of a first image obtained from the image acquisition device at a first time point; obtaining feature values for at least one fruit region on the basis of a second image obtained from the image acquisition device at a second time point after the first time point; generating at least one piece of point data on the basis of a vehicle position at the first time point and the feature values for the at least one fruit region obtained on the basis of the first image; generating at least one piece of point data on the basis of a vehicle position at the second time point and the feature values for the at least one fruit region obtained on the basis of the second image; generating at least one sub-point data set by clustering a plurality of point data generated on the basis of at least the first and second images; and generating at least one representative value for at least one fruit on the basis of the at least one sub-point data set.

According to another exemplary embodiment of the present disclosure, there is provided a method of obtaining representative ripeness values for fruits by moving a vehicle to which an image acquisition device is attached and obtaining images of a plurality of crop plants located in a greenhouse, the method including: obtaining a plurality of images from the image acquisition device; obtaining a fruit image set representing at least a part of the same fruit on the basis of the plurality of images, wherein the fruit image set includes a first fruit image representing a first side of a target fruit and a second fruit image representing a second side of the target fruit, and the first side of the target fruit is different from the second side of the target fruit; obtaining ripeness values respectively corresponding to the plurality of fruit images included in the fruit image set, wherein the ripeness values include a first ripeness value corresponding to the first fruit image representing the first side of the target fruit and a second ripeness value corresponding to the second fruit image representing the second side of the target fruit; and obtaining a representative ripeness value for the target fruit on the basis of the ripeness values.

The problem solutions of the present disclosure are not limited to the above-described solutions, and solutions that are not mentioned may be understood clearly to those skilled in the art to which the present disclosure belongs from the present specification and the accompanying drawings.

### Advantageous Effects

According to one exemplary embodiment of the present disclosure, there may be provided a method of counting fruits corresponding to a specific crop row among fruits located in a greenhouse.

According to another exemplary embodiment of the present disclosure, there may be provided a method of generating a map of fruits by obtaining images of a plurality of crop plants located in a greenhouse.

According to a yet another exemplary embodiment of the present disclosure, there may be provided a method of obtaining a representative ripeness value by obtaining images of different sides of a fruit located in a greenhouse.

The effects of the embodiments of the present disclosure are not limited to the above-described effects, and the effects not mentioned herein may be clearly understood by those skilled in the art to which the embodiments of the present disclosure belong from the present specification and accompanying drawings.

### DESCRIPTION OF DRAWINGS

FIG. 1 is a view illustrating a crop management system according to one exemplary embodiment.

FIG. 2 is a view illustrating a fruit detection module according to one exemplary embodiment.

FIG. 3 is a view illustrating a fruit detection module according to one exemplary embodiment.

FIG. 4 is a view illustrating image data for at least one crop plant according to one exemplary embodiment.

FIG. 5 is a view illustrating a greenhouse environment according to one exemplary embodiment.

FIG. 6 is a view illustrating a fruit counting method according to one exemplary embodiment.

FIG. 7 is a view illustrating a greenhouse environment according to one exemplary embodiment.

FIG. 8 is a view illustrating a fruit counting method according to one exemplary embodiment.

FIG. 9 is a view illustrating a fruit counting method according to one exemplary embodiment.

FIG. 10 is a view illustrating a fruit counting method according to one exemplary embodiment.

FIGS. 11A and 11B are a view more specifically illustrating a fruit counting method according to one exemplary embodiment.

FIG. 12 is a view illustrating a fruit counting method according to one exemplary embodiment.

FIG. 13 is a view illustrating a fruit counting method according to one exemplary embodiment.

FIG. 14 is a view illustrating a fruit map generation method according to one exemplary embodiment.

FIGS. 15A, 15B, 15C, 16A, 16B and 16C are views more specifically illustrating a method of obtaining feature values for a fruit region and a method of generating point data according to one exemplary embodiment.

FIG. 17 is a view more specifically illustrating a method of clustering a plurality of point data according to one exemplary embodiment.

FIG. 18 is a view more specifically illustrating a method of generating at least one representative value for at least one fruit according to one exemplary embodiment.

FIG. 19 is a view exemplarily illustrating a fruit map generated according to one exemplary embodiment.

FIG. 20 is a view illustrating a fruit counting method according to one exemplary embodiment.

FIG. 21 is a view illustrating an environment for monitoring a crop row included in a greenhouse according to one exemplary embodiment.

FIG. 22 is a view illustrating a method of generating a plurality of enhanced point data according to one exemplary embodiment.

FIG. 23 is a view illustrating a ripeness determination module according to one exemplary embodiment.

FIG. 24 is a view illustrating a ripeness determination module according to one exemplary embodiment.

FIG. 25 is a view illustrating a fruit map generation method according to one exemplary embodiment.

FIG. 26 is a view illustrating a situation in which a problem may occur in obtaining a ripeness value for a single fruit.

FIG. 27 is a view illustrating a method of obtaining ripeness values for at least one fruit located in a greenhouse according to one exemplary embodiment.

FIGS. 28 and 29 are views illustrating a method of obtaining ripeness values for at least one fruit located in a greenhouse according to one exemplary embodiment.

FIG. 30 is a view illustrating a method of obtaining an image set representing the same fruit according to one exemplary embodiment.

FIG. 31 is a view illustrating a method of obtaining an image set representing the same fruit according to one exemplary embodiment.

FIG. 32 is a view illustrating a method of obtaining a representative ripeness value for a fruit according to one exemplary embodiment.

FIG. 33 is a view illustrating a method of obtaining a plurality of ripeness values for a fruit according to one exemplary embodiment.

FIG. 34 is a view illustrating a method of obtaining a representative ripeness value for a fruit according to one exemplary embodiment.

FIG. 35 is a view illustrating a method for generating a representative ripeness value according to one exemplary embodiment.

### DETAILED DESCRIPTION

Exemplary embodiments described in the present specification are intended to clearly describe the idea of the present disclosure to those skilled in the art. Therefore, the present disclosure is not limited by the exemplary embodiments, and the scope of the present disclosure should be interpreted as encompassing modifications and variations without departing from the idea of the present disclosure.

Terms used in the present specification are selected from among general terms, which are currently widely used, in consideration of functions in the present disclosure and may have meanings varying depending on intentions of those skilled in the art, judicial precedents in the field of art, the emergence of new technologies, or the like. However, in contrast, in a case where a specific term is defined and used with an arbitrary meaning, the meaning of the term will be described separately. Accordingly, the terms used in the present specification should be interpreted on the basis of the actual meanings and the whole context throughout the present specification rather than on the basis of just names for the terms.

The accompanying drawings are intended to easily describe the present disclosure, and shapes shown in the drawings may be exaggerated as necessary in order to aid in understanding the present disclosure. Therefore, the present disclosure is not limited by the drawings.

When an element and/or a component or layer described in the present specification is referred to as “on” or “over” another element and/or component or layer, this case may include not only a case where the element and/or component is directly “on” the other element and/or component or layer, but also a case where there is another layer or another element and/or component interposed therebetween.

Throughout the present specification, the same reference numbers may in principle represent the same components.

Numbers (e.g., first, second, etc.) used in a process of describing the present specification may be understood as identification symbols for distinguishing one element and/or component from other elements and/or components.

The compound words “module” and “unit/part” for components used in the descriptive course of the present specification are used or mixed interchangeably depending on the case of writing the specification, and may not have distinct meanings or roles, which are distinct from each other in themselves.

When it is determined that detailed descriptions of well-known elements/components or functions related to the present disclosure may obscure the subject matter of the present disclosure, detailed descriptions thereof will be omitted herein as necessary.

According to an embodiment of the present disclosure, there is provided a method for counting fruits corresponding to a crop row, performed by one or more processors, comprising: obtaining a plurality of images corresponding to a first crop row, wherein at least one image of the plurality of images represents at least one fruit located in a second crop row, obtaining a representative distance values for a plurality of fruit regions based on the plurality of images corresponding to the first crop row, calculating a first threshold distance value for distinguishing between the first crop row and the second crop row, based on the representative distance values for the plurality of fruit regions and determining a number of fruits corresponding to the first crop row by comparing the representative distance values for the plurality of fruit regions with the first threshold distance value.

Here, the obtaining the representative distance values for the plurality of fruit regions comprises: detecting a fruit regions included in the plurality of images corresponding to the first crop row; and calculating the representative values for the detected fruit regions.

Here, the obtaining the representative distance values for the plurality of fruit regions comprises: obtaining a pixel coordinate value and a distance value for a first fruit region included in a first image among the plurality of images corresponding to the first crop row, obtaining a pixel coordinate value and a distance value for a second fruit region included in a second image among the plurality of images corresponding to the first crop row, obtaining a representative distance value for a third fruit region based on the pixel coordinate value and the distance value of the first fruit region and the pixel coordinate value and the distance value of the second fruit region, wherein the first fruit region, the second fruit region, and the third fruit region correspond to a first fruit located in the first crop row.

Here, the calculating the representative distance values for the detected fruit regions comprises: calculating a first representative distance value based on distance values corresponding to pixel coordinates included in a first fruit region.

Here, the calculating the first representative distance value based on the distance values corresponding to the pixel coordinates included in the first fruit region comprises: selecting a first distance value corresponding to a first pixel coordinate among the pixel coordinates included in the first fruit region as the first representative distance value.

Here, the first pixel coordinate is a pixel coordinate located at the center among the pixel coordinates included in the first fruit region.

Here, the calculating the first representative distance value based on the distance values corresponding to the pixel coordinates included in the first fruit region comprises: calculating the first representative distance value by applying weights to the distance values corresponding to the pixel coordinates included in the first fruit region.

Here, the weights are Gaussian-shaped weights set based on distances from a center pixel coordinate among the pixel coordinates included in the first fruit region.

Here, the first threshold distance value is calculated based on a distribution of the representative distance values for the plurality of fruit regions.

Here, the calculating the first threshold distance value for the first crop row based on the representative distance values for the plurality of fruit regions comprises: generating a first histogram data based on the representative distance values for the plurality of fruit regions; and calculating the first threshold distance value based on the first histogram data.

Here, a size of a unit distance range of the first histogram data is 10 cm or less.

Here, the calculating the first threshold distance value based on the first histogram data comprises: obtaining a first sub-distribution data and a second sub-distribution data by applying the first histogram data to at least one mixture model; and calculating the first threshold distance value based on the first sub-distribution data and the second sub-distribution data.

Here, the method for counting fruits corresponding to the crop row comprises: obtaining a plurality of images corresponding to a second crop row; obtaining a second representative distance values for second fruit regions based on the plurality of images corresponding to the second crop row; calculating a second threshold distance value for the second crop row based on the second representative distance values for the second fruit regions; and determining a number of fruits corresponding to the second crop row by comparing the second representative distance values for the second fruit regions with the second threshold distance value.

Here, the first threshold distance value and the second threshold distance value are different from each other.
the plurality of images corresponding to the first crop row includes images obtained while a vehicle to which an image acquisition device is attached is moved in a first direction along a first rail located in a greenhouse, and wherein the plurality of images corresponding to the second crop row includes images obtained while the vehicle to which the image acquisition device is attached is moved in a second direction, different from the first direction, along the first rail located in the greenhouse.

According to another exemplary embodiment of the present disclosure, there is provided a method for generating a map of fruits by moving a vehicle to which an image acquisition device is attached and obtaining images of a plurality of crop plants located in a greenhouse, the method including: obtaining feature values for at least one fruit region on the basis of a first image obtained from the image acquisition device at a first time point; obtaining feature values for at least one fruit region on the basis of a second image obtained from the image acquisition device at a second time point after the first time point; generating at least one piece of point data on the basis of a vehicle position at the first time point and the feature values for the at least one fruit region obtained on the basis of the first image; generating at least one piece of point data on the basis of a vehicle position at the second time point and the feature values for the at least one fruit region obtained on the basis of the second image; generating at least one sub-point data set by clustering a plurality of point data generated on the basis of at least the first and second images; and generating at least one representative value for at least one fruit on the basis of the at least one sub-point data set.

Here, the image acquisition device may be a depth camera.

Here, feature values for at least one fruit region obtained on the basis of the first image may include pixel coordinate values for the at least one fruit region and distance values for the at least one fruit region. Feature values for the at least one fruit region obtained on the basis of the second image may include pixel coordinate values for the at least one fruit region and distance values for the at least one fruit region.

Here, the at least one piece of point data generated in the step of generating the at least one piece of point data may include position coordinate values on the basis of the feature values for the at least one fruit region obtained on the basis of the first image and the vehicle position at the first time point. The at least one piece of point data generated in the step of generating the at least one piece of point data may include position coordinate values on the basis of the feature values for the at least one fruit region obtained on the basis of the second image and the vehicle position at the second time point.

Here, at least one representative value, which is for the at least one fruit and is generated in the step of generating the at least one representative value for the at least one fruit on the basis of the at least one sub-point data set, may include representative position coordinate values.

Here, at least one piece of point data may include first point data for a first fruit and second point data for a second fruit, the at least one piece of point data being generated in the step of generating the at least one piece of point data on the basis of both the feature values for the at least one fruit region obtained on the basis of the first image and the vehicle position at the first time point. The at least one piece of point data may include third point data for the first fruit and fourth point data for the second fruit, the at least one piece of point data being generated in the step of generating the at least one piece of point data on the basis of both the feature values for the at least one fruit region obtained on the basis of the second image and the vehicle position at the second time point.

Here, the position coordinate values of the first point data and the position coordinate values of the third point data may be different from each other, and the position coordinate values of the second point data and the position coordinate values of the fourth point data may be different from each other.

Here, the at least one sub-point data set may include a first sub-point data set and a second sub-point data set, the at least one sub-point data set being generated in the step of generating the at least one sub-point data set by clustering the plurality of point data generated on the basis of the at least the first and second images. The first point data and the third point data may be included in the first sub-point data set, and the second point data and the fourth point data may be included in the second sub-point data set.

Here, at least one representative value for at least one fruit may include first representative position coordinate values generated on the basis of the first sub-point data set and second representative position coordinate values generated on the basis of the second sub-point data set, the at least one representative value for the at least one fruit being generated in the step of generating the at least one representative value for the at least one fruit on the basis of the at least one sub-point data set.

Here, the first representative position coordinate values are generated on the basis of at least the position coordinate values of the first point data and the position coordinate values of the third point data. The second representative position coordinate values are generated on the basis of at least the position coordinate values of the second point data and the position coordinate values of the fourth point data.

Here, the method for generating the map for the fruit may further include a step of generating a fruit map corresponding to the greenhouse on the basis of at least one representative value for at least one fruit.

According to another exemplary embodiment of the present disclosure, there is provided a method of obtaining representative ripeness values for fruits by moving a vehicle to which an image acquisition device is attached and obtaining images of a plurality of crop plants located in a greenhouse, the method including: obtaining a plurality of images from the image acquisition device; obtaining a fruit image set representing at least a part of the same fruit on the basis of the plurality of images, wherein the fruit image set includes a first fruit image representing a first side of a target fruit and a second fruit image representing a second side of the target fruit, and the first side of the target fruit is different from the second side of the target fruit; obtaining ripeness values respectively corresponding to the plurality of fruit images included in the fruit image set, wherein the ripeness values include a first ripeness value corresponding to the first fruit image representing the first side of the target fruit and a second ripeness value corresponding to the second fruit image representing the second side of the target fruit; and obtaining a representative ripeness value for the target fruit on the basis of the ripeness values.

Here, the obtaining of the ripeness values respectively corresponding to the plurality of fruit images may include: obtaining the first ripeness value by applying the first fruit image to a trained first ripeness determination model; and obtaining the second ripeness value by applying the second fruit image to a trained second ripeness determination model, wherein the trained second ripeness determination model is a different model from the trained first ripeness determination model.

Here, training data used for training the trained first ripeness determination model may be identical to training data used for training the trained second ripeness determination model.

Here, the trained first ripeness determination model is trained by using the training data including a fruit image and a label value corresponding to any one of ripeness, ripening, and unripeness. The trained second ripeness determination model is trained by using the training data including a fruit image and a label value corresponding to any one of ripeness, ripening, and unripeness.

Here, the obtaining of the ripeness values respectively corresponding to the plurality of fruit images may include: obtaining a first ripeness value by applying the first fruit image to the trained ripeness determination model; and obtaining a second ripeness value by applying the second fruit image to the trained ripeness determination model.

Here, the obtaining of the representative ripeness value for the target fruit includes: determining whether a first condition is satisfied; determining whether a second condition is satisfied; and determining whether a third condition is satisfied. The first condition is a condition in which the number of ripeness values corresponding to a first class is greater than the number of ripeness values corresponding to a second class, and the number of ripeness values corresponding to the first class is greater than the number of ripeness values corresponding to a third class. The second condition is a condition in which the number of ripeness values corresponding to the third class is greater than the number of ripeness values corresponding to the first class, and the number of ripeness values corresponding to the third class is greater than the number of ripeness values corresponding to the second class. The third condition is a condition in which the number of ripeness values corresponding to the third class is greater than the number of ripeness values corresponding to the first class. In a case where the first condition is satisfied, a representative ripeness value for the target fruit is obtained as a ripeness value corresponding to a first stage. In a case where the first condition is not satisfied and the second condition is satisfied, a representative ripeness value for the target fruit is obtained as a ripeness value corresponding to a fourth stage. In a case where the first condition is not satisfied, the second condition is not satisfied, and the third condition is satisfied, a representative ripeness value for the target fruit is obtained as a ripeness value corresponding to a third stage. In a case where none of the first to third conditions are satisfied, a representative ripeness value for the target fruit is obtained as a ripeness value corresponding to a second stage. The first class is a class corresponding to unripeness, the second class is a class corresponding to ripening, and the third class is a class corresponding to ripeness. This may mean that the level of ripeness of the fruit increases as operation progresses from the first stage to the fourth stage.

Here, the obtaining of the fruit image set may include: identifying a first fruit region on the basis of a first image among a plurality of images; obtaining first feature values for the first fruit region and a first fruit image representing the first fruit region; assigning a first identifier to the first fruit region; identifying a second fruit region on the basis of a second image among a plurality of images; obtaining second feature values for the second fruit region and a second fruit image representing the second fruit region; and assigning the first identifier to the second fruit image when a predetermined standard is satisfied by comparing the first feature values with the second feature values.

Here, the obtaining of the representative ripeness value on the basis of the ripeness values may include obtaining a representative ripeness value for a target fruit on the basis of ripeness values for a plurality of fruit images to which a first identifier is assigned.

Here, the vehicle position at the time when the first image is obtained may be different from the vehicle position at the time when the second image is obtained.

Here, the first feature values may include first pixel coordinate values of the first fruit region, and the second feature values may include second pixel coordinate values of the second fruit region.

Here, the second pixel coordinate values may be values of coordinates located within a region previously set on the basis of the first pixel coordinate values.

Here, the obtaining of the fruit image set includes: identifying the first fruit region on the basis of the first image among the plurality of images; obtaining the first feature values for the first fruit region and the first fruit image representing the first fruit region; identifying the second fruit region on the basis of the second image among the plurality of images; obtaining the second feature values for the second fruit region and the second fruit image representing the second fruit region; generating the first point data on the basis of the first feature values and the vehicle position at the time when the first image is obtained; generating the second point data on the basis of the second feature values and the vehicle position at the time when the second image is obtained; generating the first sub-point data set by clustering at least the first point data and the second point data; and generating the first identifier for the first sub-point data set.

Here, the obtaining of the representative ripeness value on the basis of the ripeness values may include obtaining the representative ripeness value on the basis of ripeness values of fruit images corresponding to the first sub-point data set.

Here, the first identifier may be an identifier corresponding to the target fruit.

Here, the plurality of images includes at least the first image and the second image. The first fruit image is included in the first image, and the second fruit image is included in the second image. First coordinate values corresponding to the first fruit image within the first image may be different from second coordinate values corresponding to the second fruit image within the second image.

Here, the first coordinate values are positioned on a first side from the center of the first image, and the second coordinate values are positioned on a second side from the center of the second image. In a case where the first image is an image obtained before the second image, a direction from the first side toward the second side may be opposite to a movement direction of the vehicle.

Here, a first region of the target fruit may be represented on both the first fruit image and the second fruit image. A second region of the target fruit may be represented only on the first fruit image. A third region of the target fruit may be represented only on the second fruit image.

Here, the size of the first fruit image may be different from the size of the second fruit image.

Here, the plurality of images includes at least the first and second images. The first fruit image is included in the first image and the second fruit image is included in the second image, wherein in a case where a distance from the center of the first image to a position of the first coordinate values corresponding to the first fruit image is greater than a distance from the center of the second image to a position of the second coordinate values corresponding to the second fruit image, the size of the first fruit image may be smaller than the size of the second fruit image.

Here, the obtaining of the ripeness values respectively corresponding to the plurality of fruit images includes: obtaining a first ripeness value by applying the first fruit image to a trained ripeness determination model; and obtaining a second ripeness value by applying the second fruit image to the trained ripeness determination model, wherein the first fruit image and the second fruit image may be changed to have the same size and applied to the trained ripeness determination model.

Here, the plurality of images may be images obtained while the vehicle to which the image acquisition device is attached moves between one crop row and another crop row located in the greenhouse.

Here, the obtaining of the ripeness values may include: selecting at least a first fruit image and

a second fruit image from among a plurality of fruit images included in a fruit image set; and obtaining ripeness values respectively corresponding to the selected first fruit image and second fruit image.

Here, the obtaining of the fruit image set includes: obtaining a plurality of fruit images representing at least a part of the same fruit; and obtaining the fruit image set by selecting fruit images according to preset conditions from among the fruit images, so that the fruit image set may not include the earliest obtained fruit image and the latest obtained fruit image among the plurality of fruit images representing the at least a part of the same fruit.

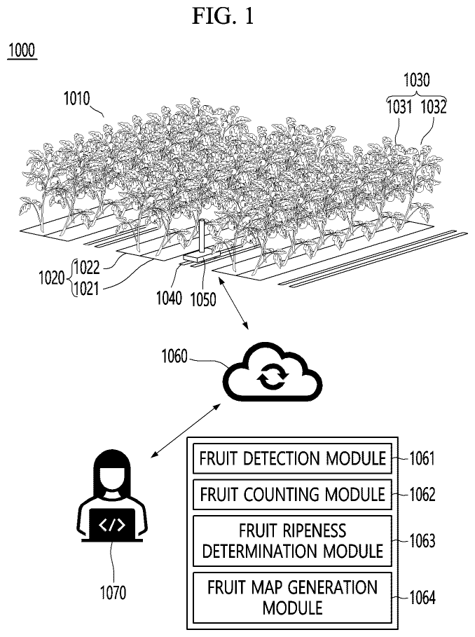

FIG. 1 is a view illustrating a crop management system according to one exemplary embodiment.

Referring to FIG. 1, the crop management system 1000 according to one exemplary embodiment may include a monitoring robot 1050 and a server 1060.

In this case, the crop management system 1000 according to one exemplary embodiment may be a system for monitoring states of at least one crop plant located in a greenhouse 1010.

For example, the crop management system 1000 according to one exemplary embodiment may be a system for detecting each fruit included in the at least one crop plant located in the greenhouse 1010, determining the number of fruits, or determining the ripeness of each fruit, but is not limited thereto.

In addition, for example, the crop management system 1000 according to one exemplary embodiment may be a system for generating a map related to the fruits included in the at least one crop plant located in the greenhouse 1010, but is not limited thereto.

In addition, the greenhouse 1010 according to one exemplary embodiment may include each crop row in which a plurality of crop plants is arranged.

For example, the greenhouse 1010 according to one exemplary embodiment may include, but is not limited to, a plurality of crop rows, including a first crop row 1020 and a second crop row 1030, in which the plurality of crop plants is arranged.

In addition, at least one crop row included in the greenhouse 1010 according to one exemplary embodiment may include at least one sub-crop row.

For example, the first crop row 1020 included in the greenhouse 1010 according to one exemplary embodiment may include a first sub-crop row 1021 and a second sub-crop row 1022, and the second crop row 1030 may include a third sub-crop row 1031 and a fourth sub-crop row 1032, but is not limited thereto.

In this case, as shown in FIG. 1, the sub-crop rows may mean physically separated crop rows, but it is not limited thereto, and may mean different parts of crop plants grown in directions different from each other in one row.

For example, the first sub-crop row 1021 may mean a crop row of crop plants specified by stems growing to the right among the crop plants included in the first crop row 1020, and the second sub-crop row 1022 may mean a crop row of crop plants specified by stems growing to the left among the crop plants included in the first crop row 1020, but is not limited thereto.

In addition, the concept of sub-crop rows described above is only content described for convenience of description, and may be expressed by various terms in order to express the right, left, front, back, or the like of one crop row.

In addition, the greenhouse 1010 according to one exemplary embodiment may include at least one rail for guiding a movement path of the monitoring robot 1050.

For example, the greenhouse 1010 according to one exemplary embodiment may include a first rail 1040 for guiding a movement path of the monitoring robot 1050.

In addition, the at least one rail included in the greenhouse 1010 according to one exemplary embodiment may be arranged between at least one or more crop rows.

For example, the first rail 1040 included in the greenhouse 1010 according to one exemplary embodiment may be arranged between the first crop row 1020 and the second crop row 1030, but is not limited thereto.

In addition, for example, the first rail 1040 included in the greenhouse 1010 according to one exemplary embodiment may be arranged between the first sub-crop row 1021 included in the first crop row 1020 and the third crop row 1031 included in the second crop row 1030, but is not limited thereto.

The monitoring robot 1050 according to one exemplary embodiment may be a robot for obtaining monitoring data on the crop plants located in the greenhouse 1010.

In this case, the monitoring robot 1050 according to one exemplary embodiment may include at least one communication unit.

For example, the monitoring robot 1050 according to one exemplary embodiment may include the at least one communication unit capable of wireless communication such as WiFi, Bluetooth, Beacon, Near Field Communication (NFC), ZigBee, WiGig, Radio Frequency Identification (RFID), Infrared Data Association (IrDA), Ultra-Wideband (UWB), and WiHD, but is not limited thereto.

In addition, in this case, the monitoring robot 1050 according to one exemplary embodiment may include at least one input unit.

For example, the monitoring robot 1050 according to one exemplary embodiment may include the at least one input unit such as a keyboard, a mouse, a key pad, a dome switch, a touch pad (static/capacitive), a button, etc., but is not limited thereto.

In addition, in this case, the monitoring robot 1050 according to one exemplary embodiment may include at least one positioning unit.

For example, the monitoring robot 1050 according to one exemplary embodiment may include the at least one positioning unit among various positioning units, including: a positioning unit operating through satellite communication such as a Global Positioning System (GPS) and a Global Navigation Satellite System (GNSS); a positioning unit operating through short-range communication such as Bluetooth, a Beacon, Near Field Communication (NFC), ZigBee, WiGig, Radio Frequency Identification (RFID), infrared Data Association (IrDA), and Ultra-Wideband (UWB); and other positioning units.

In addition, the monitoring robot 1050 according to one exemplary embodiment may move on the at least one rail located in the greenhouse 1010.

For example, the monitoring robot 1050 according to one exemplary embodiment may move on the first rail 1040 located in the greenhouse 1010, but is not limited thereto.

In addition, the monitoring robot 1050 according to one exemplary embodiment may include at least one sensor for obtaining monitoring data.

For example, the monitoring robot 1050 according to one exemplary embodiment may include a camera device for obtaining image data on the crop plants located in the greenhouse 1010, but is not limited thereto.

In addition, for example, the monitoring robot 1050 according to one exemplary embodiment may include a depth camera device for obtaining depth image data on the crop plants located in the greenhouse 1010, but is not limited thereto.

In this case, the depth image data may be expressed as distance image data, etc., and a depth value included in the depth image data may be expressed as a distance value, etc.

In addition, the monitoring robot 1050 according to one exemplary embodiment may be moved by human manipulation, but is not limited thereto, and may detect the surroundings so as to move automatically.

In addition, the monitoring robot 1050 according to one exemplary embodiment may move on the at least one rail located in the greenhouse 1010 and obtain monitoring data on the crop plants.

For example, the monitoring robot 1050 according to one exemplary embodiment may move in a first direction on the first rail 1040 located in the greenhouse 1010 to obtain a plurality of image data for the first crop row 1020, and may move in a second direction on the first rail 1040 located in the greenhouse 1010 to obtain a plurality of image data for the second crop row 1030, but is not limited thereto.

In addition, for example, the monitoring robot 1050 according to one exemplary embodiment may move in the first direction on the first rail 1040 located in the greenhouse 1010 to obtain a plurality of image data for the first sub-crop row 1021 included in the first crop row 1020, and may move in the second direction on the first rail 1040 located in the greenhouse 1010 to obtain a plurality of image data for the third sub-crop row 1031 included in the second crop row 1030, but is not limited thereto.

In addition, the monitoring robot 1050 according to one exemplary embodiment may transmit the obtained monitoring data to the server 1060.

For example, the monitoring robot 1050 according to one exemplary embodiment may move in the first direction on the first rail 1040 located in the greenhouse 1010 and transmit a plurality of depth image data obtained for the first crop row 1020 to the server 1060 through the communication unit, but is not limited thereto.

In addition, for example, the monitoring robot 1050 according to one exemplary embodiment may move in the second direction on the first rail 1040 located in the greenhouse 1010 and transmit a plurality of depth image data obtained for the second crop row 1030 to the server 1060 through the communication unit, but is not limited thereto.

In addition, the monitoring robot 1050 according to one exemplary embodiment may transmit at least one piece of identification information through the communication unit.

For example, the monitoring robot 1050 according to one exemplary embodiment may transmit identification ID information of the monitoring robot 1050 to the server 1060 through the communication unit, but is not limited thereto.

In addition, the monitoring robot 1050 according to one exemplary embodiment may transmit at least one piece of positioning information through the communication unit.

For example, the monitoring robot 1050 according to one exemplary embodiment may transmit the positioning information obtained through the positioning unit to the server 1060 through the communication unit, but is not limited there

In addition, the monitoring robot 1050 according to one exemplary embodiment may transmit at least one piece of information at various time points through the communication unit.

For example, the monitoring robot 1050 according to one exemplary embodiment may transmit at least one piece of information to the server in real time through the communication unit, but is not limited thereto.

In addition, for example, the monitoring robot 1050 according to one exemplary embodiment may transmit at least one piece of information to the server at regular intervals, but is not limited thereto.

In addition, for example, the monitoring robot 1050 according to one exemplary embodiment may transmit at least one piece of information to the server at a time when a specific trigger is obtained, but is not limited thereto.

The server 1060 according to one exemplary embodiment may have at least one module among a fruit detection module 1061, a fruit counting module 1062, a fruit ripeness determination module 1063, and a fruit map generation module 1064.

In this case, the fruit detection module 1061 according to one exemplary embodiment may be a module for detecting information related to fruits included in monitoring data obtained from the monitoring robot 1050.

For example, the fruit detection module 1061 according to one exemplary embodiment may be a module for detecting a fruit region included in a plurality of image data obtained from the monitoring robot 1050 and extracting the fruit region, but is not limited thereto.

However, the fruit detection module 1061 according to one exemplary embodiment will be described in more detail below by using other drawings.

In addition, the fruit counting module 1062 according to one exemplary embodiment may be a module for outputting information related to the number of fruits included in the crop plants located in the greenhouse 1010 on the basis of monitoring data obtained from the monitoring robot 1050.

For example, the fruit counting module 1062 according to one exemplary embodiment may be a module for outputting information on the number of fruits included in the plurality of crop plants located in the greenhouse 1010 on the basis of a plurality of image data obtained from the monitoring robot 1050, but is not limited thereto.

In addition, for example, the fruit counting module 1062 according to one exemplary embodiment may be a module for outputting information on the number of fruits included in a plurality of crop plants located in a specific region of the greenhouse 1010 on the basis of a plurality of image data obtained from the monitoring robot 1050, but is not limited thereto.

For a more specific example, the fruit counting module 1062 according to one exemplary embodiment may be a module for outputting information on the number of fruits included in a plurality of crop plants located in the first crop row 1020 and the number of fruits included in a plurality of crop plants located in the second crop row 1030 on the basis of a plurality of image data obtained from the monitoring robot 1050, but is not limited thereto.

However, the fruit counting module 1062 according to one exemplary embodiment will be described in more detail below by using other drawings.

In addition, the ripeness determination module 1063 according to one exemplary embodiment may be a module for determining the level of ripeness of at least one fruit included in at least one crop plant located in the greenhouse 1010 on the basis of monitoring data obtained from the monitoring robot 1050.

For example, the fruit ripeness determination module 1063 according to one exemplary embodiment may be a module for outputting ripeness information for a first fruit included in a first crop plant and for outputting ripeness information for a second fruit included in a second crop plant on the basis of a plurality of image data obtained from the monitoring robot 1050, but is not limited thereto.

However, the fruit ripeness determination module 1063 according to one exemplary embodiment will be described in more detail below by using other drawings.

In addition, the fruit map generation module 1064 according to one exemplary embodiment may be a module for providing a map for a plurality of fruits included in a plurality of crop plants located in the greenhouse 1010 on the basis of monitoring data obtained from the monitoring robot 1050.

For example, the fruit map generation module 1064 according to one exemplary embodiment may be a module for providing a map corresponding to a three-dimensional virtual space for the positions and ripeness of a plurality of fruits included in a plurality of crop plants located in the greenhouse 1010 on the basis of a plurality of image data obtained from the monitoring robot 1050, but is not limited thereto.

However, the fruit map generation module 1064 according to one exemplary embodiment will be described in more detail below by using other drawings.

The crop management system 1000 according to one exemplary embodiment may further include a remote manager 1070.

In this case, the remote manager 1070 according to one exemplary embodiment is described as a person performing a role for the convenience of describing the system, but the remote manager 1070 may be understood as a terminal that is related to the remote manager 1070 or used by the remote manager 1070, and may be understood as a robot, a server, and the like capable of performing the role of the remote manager 1070.

A remote manager terminal 1070 according to one exemplary embodiment may obtain information output from the server 1060 and be provide with a display for this information.

For example, the remote manager terminal 1070 according to one exemplary embodiment may obtain information on a fruit detection result output from the server 1060, but is not limited thereto.

In addition, for example, the remote manager terminal 1070 according to one exemplary embodiment may obtain information on the number of fruits output from the server 1060, but is not limited thereto.

In addition, for example, the remote manager terminal 1070 according to one exemplary embodiment may obtain information on fruit ripeness output from the server 1060, but is not limited thereto.

In addition, for example, the remote manager terminal 1070 according to one exemplary embodiment may obtain information on a fruit map output from the server 1060, but is not limited thereto.

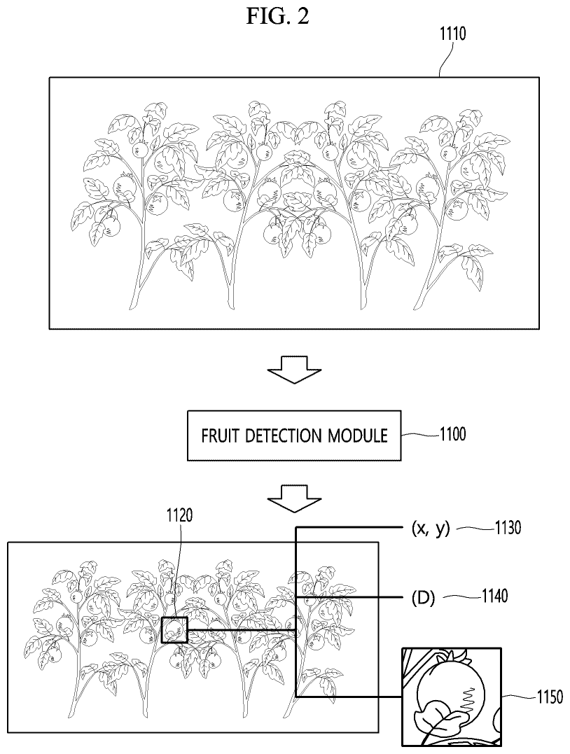

FIG. 2 is a view illustrating a fruit detection module according to one exemplary embodiment.

Referring to FIG. 2, the fruit detection module 1100 according to one exemplary embodiment may be a module for outputting at least one kind of pixel coordinate values 1130 for at least one fruit region 1120 included in crop plants, depth values 1140 for the fruit region 1120, and cropped image data 1150 for the fruit region 1120 on the basis of at least one piece of image data 1110 for the crop plants.

The at least one piece of image data 1110 for the crop plants according to one exemplary embodiment may be an image obtained from a monitoring robot included in a crop management system.

For example, first image data included in the at least one piece of image data 1110 for the crop plants according to one exemplary embodiment may be an image obtained from the monitoring robot at a first time point, but is not limited thereto.

In addition, the at least one piece of image data 1110 for the crop plants according to one exemplary embodiment may be image data including at least a part of at least one or more crop plants.

For example, the at least one piece of image data 1110 for the crop plants according to one exemplary embodiment may be image data including at least a part of a plurality of crop plants, but is not limited thereto.

In addition, the at least one piece of image data 1110 for the crop plants according to one exemplary embodiment may be image data including pixel coordinates, pixel values for color, and pixel values for distance.

For example, the at least one piece of image data 1110 for the crop plants according to one exemplary embodiment may be depth image data including pixel coordinates, RGB values corresponding to the pixel coordinates, and depth values corresponding to the pixel coordinates, but is not limited thereto.

In addition, the at least one piece of image data 1110 for the crop plants according to one exemplary embodiment may include regions corresponding to at least one fruit region included in a crop plant.

For example, the at least one piece of image data 1110 for the crop plants according to one exemplary embodiment may include a region for a first fruit included in a first crop plant, but is not limited thereto.

In addition, a fruit region 1120 according to one exemplary embodiment may mean a region determined to correspond to a fruit within the at least one piece of image data 1110 for the crop plants.

In addition, as illustrated in FIG. 2, the fruit region 1120 according to one exemplary embodiment may be specified as a bounding box shape and may be specified as various shapes, such as a shape in which a region corresponding to the fruit is segmented, but is not limited thereto.

In addition, pixel coordinate values 1130 corresponding to the fruit region 1120 according to one exemplary embodiment may be selected as a pair of pixel coordinates from among a plurality of pixel coordinates included in the fruit region 1120.

For example, first pixel coordinate values corresponding to the first fruit region may be selected as a pair of second pixel coordinates from among the plurality of pixel coordinates included in the first fruit region, but is not limited thereto.

In addition, the pixel coordinate values 1130 corresponding to the fruit region 1120 according to one exemplary embodiment may be calculated on the basis of the plurality of pixel coordinates included in the fruit region 1120.

For example, the first pixel coordinate values corresponding to the first fruit region may be calculated as pixel coordinates of the center of the plurality of pixel coordinates included in the first fruit region, but is not limited thereto.

In addition, a depth value 1140 corresponding to a fruit region 1120 according to one exemplary embodiment may be selected as one depth value among a plurality of depth values corresponding to the plurality of pixel coordinates included in the fruit region 1120.

For example, a first depth value corresponding to the first fruit region may be selected as a first depth value corresponding to the first pixel coordinates located at the center among the plurality of pixel coordinates included in the first fruit region, but is not limited thereto.

In addition, the depth value 1140 corresponding to the fruit region 1120 according to one exemplary embodiment may be calculated on the basis of a plurality of depth values corresponding to the plurality of pixel coordinates included in the fruit region 1120.

For example, the first depth value corresponding to the first fruit region may be calculated by assigning weights to the plurality of depth values corresponding to the plurality of pixel coordinates included in the first fruit region, but is not limited thereto.

For a more specific example, the first depth value corresponding to the first fruit region may be calculated by applying Gaussian-shaped weights to the plurality of depth values corresponding to the plurality of pixel coordinates included in the first fruit region, but is not limited thereto.

For a more specific example, the first depth value corresponding to the first fruit region may be calculated by applying Laplacian form weights to the plurality of depth values corresponding to the plurality of pixel coordinates included in the first fruit region, but is not limited thereto.

In addition, the fruit detection module 1100 according to one exemplary embodiment may be implemented by using a machine learning method. For example, the fruit detection module 1100 according to one exemplary embodiment may be a model implemented through supervised learning, but is not limited thereto, and may be a model implemented through unsupervised learning, semi-supervised learning, reinforcement learning, etc.

In addition, the fruit detection module 1100 according to one exemplary embodiment may be implemented with at least one artificial neural network (ANN). For example, the fruit detection module 1100 according to one exemplary embodiment may include at least one artificial neural network layer among various artificial neural network layers such as a feedforward neural network, a radial basis function network or a Cohen self-organizing network, a convolutional neural network (CNN), a recurrent neural network (RNN), a long short term memory network (LSTM), or gated recurrent units (GRUs), but is not limited thereto.

In addition, the at least one artificial neural network layer included in the fruit detection module 1100 according to one exemplary embodiment may use the same or different activation functions.

In this case, the activation functions may include a sigmoid function, a hyperbolic tangent function (Tanh function), a rectified linear unit function (ReLU function), a leaky ReLU function, an exponential linear unit function (ELU function), a Softmax function, etc., but is not limited thereto, and may include various activation functions (including custom activation functions) for outputting result values or transmitting the result values to another artificial neural network layer.

In addition, the fruit detection module 1100 according to one exemplary embodiment may be trained by using a training data set including at least one piece of image data for the crop plants.

For example, the fruit detection module 1100 according to one exemplary embodiment may be trained by using a training data set including at least one piece of image data for the crop plants and annotations corresponding the image data, but is not limited thereto.

In addition, the fruit detection module 1100 according to one exemplary embodiment may be trained by using at least one loss function.

In this case, the at least one loss function may include a Mean Squared Error (MSE), a Root Mean Squared Error (RMSE), Binary Crossentropy, Categorical Crossentropy, Sparse Categorical Crossentropy, etc., but is not limited thereto, and may include various functions (including custom loss functions) for calculating a difference between a predicted result value and an actual result value.

In addition, at least one optimizer may be used for training of the fruit detection module 1100 according to one exemplary embodiment.

In this case, the at least one optimizer may include Gradient Descent, Batch Gradient Descent, Stochastic Gradient Descent, Mini-batch Gradient Descent, Momentum, AdaGrad, RMSProp, AdaDelta, Adam, NAG, NAdam, RAdam, AdamW, etc., but is not limited thereto.

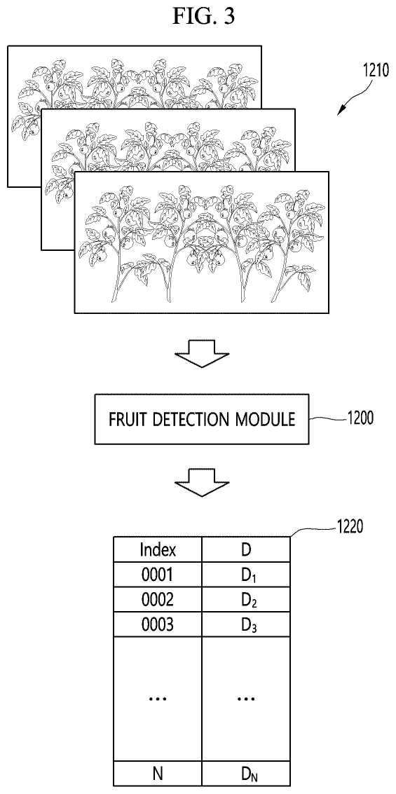

FIG. 3 is a view illustrating a fruit detection module according to one exemplary embodiment.

Referring to FIG. 3, the fruit detection module 1200 according to one exemplary embodiment may be a module for outputting at least one representative value 1220 for a plurality of fruit regions included in a plurality of crop plants on the basis of a plurality of image data 1210 for crop plants.

In this case, since the above-described content may be applied to the fruit detection module 1200, redundant descriptions will be omitted.

The plurality of image data 1210 for the crop plants according to one exemplary embodiment may be images obtained from a monitoring robot included in a crop management system.

For example, in image data included in the plurality of image data 1210 for the crop plants according to one exemplary embodiment, first image data may be an image obtained from the monitoring robot at a first time point, second image data may be an image obtained from the monitoring robot at a second time point, and third image data may be an image obtained from the monitoring robot at a third time point, but is not limited thereto.

In addition, the plurality of image data 1210 for the crop plants according to one exemplary embodiment may be images obtained when the monitoring robot included in the crop management system moves on at least one rail located in a greenhouse.

For example, in the image data included in the plurality of image data 1210 for the crop plants according to one exemplary embodiment, the first image data may be an image obtained at the first time point by the monitoring robot that is moved on a first rail located in the greenhouse and located at a first position, the second image data may be an image obtained at the second time point by the monitoring robot that is moved on the first rail and located at a second position, and the third image data may be an image obtained at the third time point by the monitoring robot is moved on the first rail and located at a third position, but is not limited thereto.

In addition, the plurality of image data 1210 for the crop plants according to one exemplary embodiment may be image frames continuously obtained while the monitoring robot included in the crop management system moves on the at least one rail located in the greenhouse.

In addition, the plurality of image data 1210 for the crop plants according to one exemplary embodiment may include a plurality of image data for one crop plant.

For example, the plurality of image data 1210 for the crop plants according to one exemplary embodiment may include the first image data expressing at least a part of a first crop plant, the second image data expressing at least another part of the first crop plant, and the third image data expressing at least a yet another part of the first crop plant, but is not limited thereto.

In addition, since the plurality of image data 1210 for the crop plants according to one exemplary embodiment includes the plurality of image data for one crop plant, a plurality of detections for one fruit may be performed.

For example, in image data included in the plurality of image data 1210 for the crop plants according to one exemplary embodiment, a detection of a first fruit may be performed within the first image data, a detection of the first fruit may be performed within the second image data, and a detection of the first fruit may be performed within the third image data.

Accordingly, the fruit detection module 1200 according to one exemplary embodiment may include various algorithms allowing the same fruits to be determined as one fruit.

For example, the fruit detection module 1200 according to one exemplary embodiment may include an algorithm for determining identity on the basis of a positional relationship between each of fruit regions in order to determine that a first fruit region that is a fruit region for the first fruit included in the first image data, a second fruit region that is a fruit region for the first fruit included in the second image data, and a third fruit region that is a fruit region for the first fruit included in the third image data are the same fruit region, but is not limited thereto, and various algorithms for determining that identical objects included in consecutive image frames are the same object may be included.

In addition, the at least one representative value 1220 for the plurality of fruit regions according to one exemplary embodiment may include a depth value for each of the plurality of fruit regions.

For example, the at least one representative value 1220 for the plurality of fruit regions according to one exemplary embodiment may include a first depth value for the first fruit region and a second depth value for the second fruit region, but is not limited thereto.

In addition, the at least one representative value 1220 for the plurality of fruit regions according to one exemplary embodiment may be obtained on the basis of the depth value for the fruit region obtained from each of the plurality of image data.

For example, the first depth value for the first fruit region may be obtained on the basis of the second depth value for the second fruit region for the first fruit included in the first image data, and the third depth value for the third fruit region for the first fruit included in the second image data, but is not limited thereto.

In addition, the at least one representative value 1220 for the plurality of fruit regions according to one exemplary embodiment may include index values for the plurality of fruit regions.

In this case, the index values may correspond to the number of detected fruits.

Accordingly, according to one exemplary embodiment, in a case where the monitoring robot moves on a first rail, obtains image data for a first crop row, inputs a plurality of obtained image data into the fruit detection module 1200, and outputs the at least one representative value 1220 for the plurality of fruit regions, the number of the plurality of fruit regions or index values for the plurality of fruit regions may correspond to the number of fruits included in the first crop row.

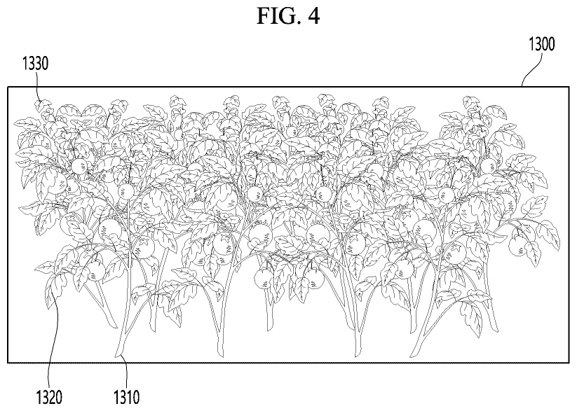

However, in a case where determining the number of fruits included in each crop row by the operation described above, a problem may arise where the number of fruits is different from the actual number of fruits, and this matter will be described in more detail below with reference to FIG. 4.

FIG. 4 is a view illustrating image data for at least one crop plant according to one exemplary embodiment.

Referring to FIG. 4, the image data 1300 according to one exemplary embodiment may include an image of at least a part of a first crop plant 1310 included in a first crop row located in a greenhouse.

In addition, referring to FIG. 4, the image data 1300 according to one exemplary embodiment may include an image of at least some of crop plants included in another crop row in addition to the crop plants included in the first crop row located in the greenhouse.

For example, the image data 1300 according to one exemplary embodiment may include: an image of at least a part of a second crop plant 1320 included in a second crop row adjacent to the first crop row; and an image of at least a part of a third crop plant 1330 included in a third crop row adjacent to the second crop row.

In this case, the second crop row may mean a sub-crop row described above.

Accordingly, in a case where the image data 1300 according to one exemplary embodiment is used in the above-described fruit detection modules, detections may be performed for not only fruits included in the first crop row, but also fruits included in other crop rows other than the first crop row.

In addition, since the fruits located in the second crop row or the third crop row are often blocked from view by the crop plants located in the first crop row, it is also difficult to determine the number of fruits located in the second crop row or third crop row by using the image data 1300 according to one exemplary embodiment.

That is, various methods are required to be introduced in order to accurately determine the number of fruits included in the first crop row by using the image data 1300 according to one exemplary embodiment.

Hereinafter, methods for accurately determining the number of fruits included in a crop row will be described in more detail.

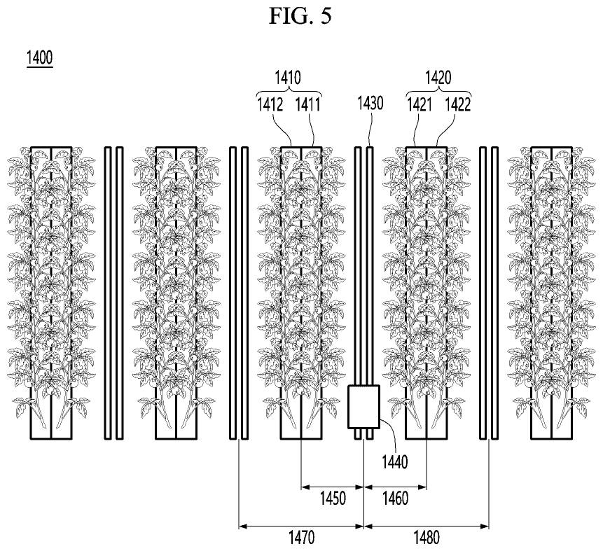

FIG. 5 is a view illustrating a greenhouse environment according to one exemplary embodiment.

Referring to FIG. 5, a greenhouse 1400 according to one exemplary embodiment may include each crop row in which a plurality of crop plants is arranged. For example, the greenhouse 1400 according to one exemplary embodiment may include a first crop row 1410 and a second crop row 1420. The first crop row 1410 may include a first sub-crop row 1411 and a second sub-crop row 1412. The second crop row 1420 may include a third sub-crop row 1421 and a fourth sub-crop row 1422. Since the above-described content may be applied to this, redundant descriptions will be omitted.

In addition, referring to FIG. 5, the greenhouse 1400 according to one exemplary embodiment may include a plurality of rails arranged between the plurality of crop rows. For example, the greenhouse 1400 according to one exemplary embodiment may include the first rail 1430 arranged between the first crop row 1410 and the second crop row 1420. Since the above-described content may be applied to this, redundant descriptions will be omitted.

In addition, referring to FIG. 5, at least one monitoring robot 1440 may be placed in the greenhouse 1400 according to one exemplary embodiment. Since the above-described content may be applied to this, redundant descriptions will be omitted.

Referring back to FIG. 5, the crop rows and rails included in the greenhouse 1400 according to one exemplary embodiment may be arranged to have a predetermined distance therebetween.

For example, in the crop rows and rails included in the greenhouse 1400 according to one exemplary embodiment, the first crop row 1410 and the first rail 1430 may be arranged so that a distance therebetween is a first distance 1450, and the second crop row 1420 and the first rail 1430 may be arranged so that a distance therebetween is a second distance 1460. The greenhouse 1400 according to one exemplary embodiment may be designed so that the first distance 1450 and the second distance 1460 are the same, but is not limited thereto.

In addition, the plurality of rails included in the greenhouse 1400 according to one exemplary embodiment may be arranged to have a predetermined distance.

For example, in the rails included in the greenhouse 1400 according to one exemplary embodiment, the first rail 1430 and a second rail may be arranged so that a distance therebetween is a third distance 1470, and the first rail 1430 and a third rail may be arranged so that a distance therebetween is a fourth distance 1480. The greenhouse 1400 according to one exemplary embodiment may be designed so that the third distance 1470 and the fourth distance 1480 are the same, but is not limited thereto.

In addition, the plurality of crop rows included in the greenhouse 1400 according to one exemplary embodiment may be arranged to have a predetermined distance therebetween.

For example, in the crop rows included in the greenhouse 1400 according to one exemplary embodiment, the first crop row 1410 and the second crop row 1420 may be arranged so that a distance therebetween is a fifth distance, and the first crop row 1410 and a third crop row may be arranged so that a distance therebetween is a sixth distance. The greenhouse 1400 according to one exemplary embodiment may be designed so that the fifth distance and the sixth distance are the same, but is not limited thereto.

As described above, the greenhouse 1400 according to one exemplary embodiment may be designed so that each component included in the greenhouse 1400 is arranged according to a predetermined rule.

Accordingly, in the case of the greenhouse designed as described above, a predetermined threshold value for distance may be used to determine which fruit is included in a particular crop row.

For example, according to one exemplary embodiment, the predetermined threshold value may be used to determine a fruit included in the particular crop row, and the predetermined threshold value may be a value determined on the basis of a distance between a rail and a crop row, which are included in the greenhouse 1400.

In addition, for example, according to one exemplary embodiment, the predetermined threshold value may be used to determine a fruit included in a particular crop row, and the predetermined threshold value may be a value determined on the basis of a distance between a rail and an adjacent rail, which are included in the greenhouse 1400.

In addition, for example, according to one exemplary embodiment, the predetermined threshold value may be used to determine a fruit included in a particular crop row, and the predetermined threshold value may be a value determined on the basis of a distance between a crop row and an adjacent crop row, which are included in the greenhouse 1400.

Hereinafter, a method of counting fruits for a crop row by using a predetermined threshold value will be described in more detail.

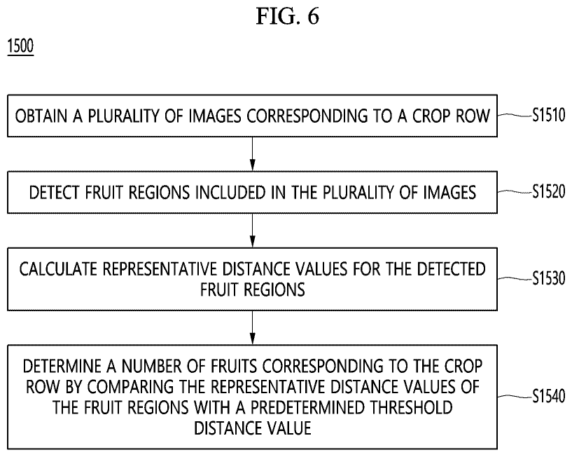

FIG. 6 is a view illustrating a fruit counting method according to one exemplary embodiment.

Referring to FIG. 6, the fruit counting method 1500 according to one exemplary embodiment may include: step S1510 of obtaining a plurality of images corresponding to a crop row; step S1520 of detecting fruit regions included in the plurality of images; step S1530 of calculating representative distance values for the detected fruit regions; and step S1540 of determining the number of fruits corresponding to the crop row by comparing the representative distance values for the fruit regions with a preset threshold distance value.

In this case, the step S1510 of obtaining the plurality of images corresponding to the crop row according to one exemplary embodiment, the step S1520 of detecting the fruit regions included in the plurality of images, and the step S1530 of calculating the representative distance values for the detected fruit regions may be performed in the fruit detection module described above.

For example, according to one exemplary embodiment, the step S1510 of obtaining the plurality of images corresponding to the crop row may be performed in a data acquisition unit included in a fruit detection module, but is not limited thereto.

In addition, for example, the step S1520 of detecting the fruit regions included in the plurality of images according to one exemplary embodiment may be performed in an image analysis unit included in the fruit detection module, but is not limited thereto.

In addition, for example, the step S1530 of calculating the representative distance values for the detected fruit regions according to one exemplary embodiment may be performed in a fruit distance calculation unit, but is not limited thereto.

In the step S1510 of obtaining the plurality of images corresponding to the crop row according to one exemplary embodiment, the plurality of images corresponding to the crop row may include a plurality of images corresponding to a first crop row.

In addition, in the step S1510 of obtaining the plurality of images corresponding to the crop row according to one exemplary embodiment, the content of the image data described above may be applied to the plurality of images corresponding to the crop row, so redundant descriptions will be omitted.

The step S1520 of detecting the fruit regions included in the plurality of images according to one exemplary embodiment may include a step of outputting at least one kind of pixel coordinate values, distance values, and crop plant image data for a fruit region located within at least one image included in the plurality of images. Since the content described with reference to FIGS. 2 and 3 may be applied to this, redundant descriptions will be omitted.

The step S1530 of calculating the representative distance values for the detected fruit regions according to one exemplary embodiment may include a step of calculating distance values for fruit regions located in the at least one image included in the plurality of images. Since the content described through FIGS. 2 and 3 may be applied to this, redundant descriptions will be omitted.

In addition, the step S1530 of calculating the representative distance values for the detected fruit regions according to one exemplary embodiment may include a step of outputting at least one distance value for the plurality of fruit regions included in the plurality of crop plants included in the plurality of images. Since the content described through FIG. 3 may be applied to this, redundant descriptions will be omitted.

The step S1540 of determining the number of fruits corresponding to the crop row by comparing the representative distance values for the fruit regions with the preset threshold distance value according to one exemplary embodiment may include a step of determining fruit regions whose representative distance values are smaller than a preset threshold distance value among the fruit regions as fruit regions corresponding to a crop row.

For example, in the step S1540 of determining the number of fruits corresponding to the crop row by comparing the representative distance values for the fruit regions with the preset threshold distance value according to one exemplary embodiment, 800 fruit regions whose representative distance values are smaller than the preset threshold distance value among 1,000 fruit regions may be determined as fruit regions corresponding to the first crop row, but is not limited thereto.

In addition, the step S1540 of determining the number of fruits corresponding to the crop row by comparing the representative distance values for the fruit regions with the preset threshold distance value according to one exemplary embodiment may include a step of determining the number of fruits corresponding to a crop row on the basis of the number of determined fruit regions.

For example, in the step S1540 of determining the number of fruits corresponding to the crop row by comparing the representative distance values for the fruit regions with the preset threshold distance value according to one exemplary embodiment, the number of fruits corresponding to the first crop row may be determined to be 800 in a case where the 800 fruit regions, among 1,000 fruit regions, each having the representative distance value smaller than the preset threshold distance value are determined as the fruit regions corresponding to the first crop row, but is not limited thereto.

In addition, for example, in the step S1540 of determining the number of fruits corresponding to the crop row by comparing the representative distance values for the fruit regions with the preset threshold distance value according to one exemplary embodiment, the number of fruits corresponding to the first crop row including the first sub-crop row and the second sub-crop row may be determined as 1,550 in a case where there are 800 fruit regions whose representative distance values are smaller than the preset threshold distance value among 1,000 fruit regions obtained on the basis of the plurality of images corresponding to the first sub-crop row, and there are 750 fruit regions whose representative distance values are smaller than the preset threshold distance value among 950 fruit regions obtained on the basis of the plurality of images corresponding to the second sub-crop row, but is not limited thereto.

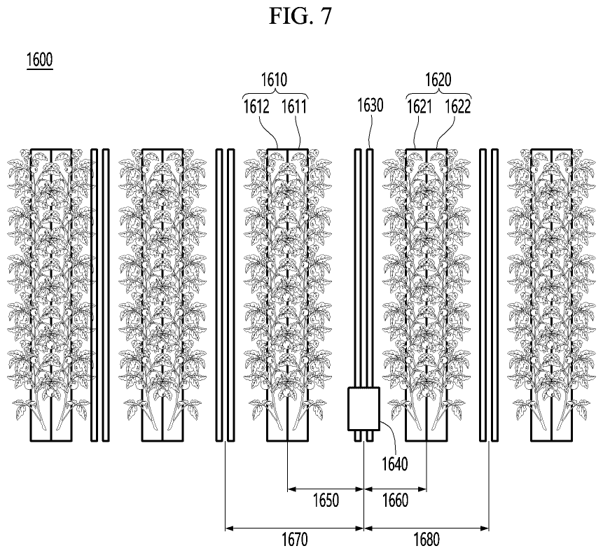

FIG. 7 is a view illustrating a greenhouse environment according to one exemplary embodiment.

Referring to FIG. 7, the greenhouse 1600 according to one exemplary embodiment may include each crop row in which a plurality of crop plants is arranged. For example, the greenhouse 1600 according to one exemplary embodiment may include a first crop row 1610 and a second crop row 1620. The first crop row 1610 may include a first sub-crop row 1611 and a second sub-crop row 1612, and the second crop row 1620 may include a third sub-crop row 1621 and a fourth sub-crop row 1622. Since the above-described content may be applied to this, redundant descriptions will be omitted.

In addition, referring to FIG. 7, the greenhouse 1600 according to one exemplary embodiment may include a plurality of rails arranged between the plurality of crop rows. For example, the greenhouse 1600 according to one exemplary embodiment may include a first rail 1630 arranged between the first crop row 1610 and the second crop row 1620. Since the above-described content may be applied to this, redundant descriptions will be omitted.

In addition, referring to FIG. 7, at least one monitoring robot 1640 may be placed in the greenhouse 1600 according to one exemplary embodiment. Since the above-described content may be applied to this, redundant descriptions will be omitted.

Referring back to FIG. 7, the crop rows and rails included in the greenhouse 1600 according to one exemplary embodiment may be arranged to have at least some distances different from each other.

For example, in the crop rows and rails included in the greenhouse 1600 according to one exemplary embodiment, the first crop row 1610 and the first rail 1630 may be arranged so that a distance therebetween is a first distance 1650, and the second crop row 1620 and the first rail 1630 may be arranged so that a distance therebetween is a second distance 1660. In the greenhouse 1600 according to one exemplary embodiment, the first distance 1650 and the second distance 1660 may be different from each other, but it is not limited thereto.

In addition, a plurality of rails included in the greenhouse 1600 according to one exemplary embodiment may be arranged so as to have at least some distances different from each other.

For example, in the rails included in the greenhouse 1600 according to one exemplary embodiment, the first rail 1630 and a second rail may be arranged so that a distance therebetween is a third distance 1670, and the first rail 1630 and a third rail may be arranged so that a distance therebetween is a fourth distance 1680. In the greenhouse 1600 according to one exemplary embodiment, the third distance 1670 and the fourth distance 1680 may be different from each other, but it is not limited thereto.

In addition, a plurality of crop rows included in the greenhouse 1600 according to one exemplary embodiment may be arranged so as to have at least some distances different from each other.

For example, in the crop rows included in the greenhouse 1600 according to one exemplary embodiment, the first crop row 1610 and the second crop row 1620 may be arranged so that a distance therebetween is a fifth distance, and the first crop row 1610 and a third crop row may be arranged so that a distance therebetween is a sixth distance. In the greenhouse 1600 according to one exemplary embodiment, the fifth distance and the sixth distance are different from each other, but it is not limited thereto.

As described above, in the greenhouse 1600 according to one exemplary embodiment, at least some components among each component included in the greenhouse 1600 may be arranged to deviate from rules.

Accordingly, in the case of the greenhouse as described above, an error may occur depending on crop rows when a predetermined threshold value for distance is used to determine fruits included in a particular crop row.

For example, according to one exemplary embodiment, in a case where the predetermined threshold value is determined on the basis of the first distance 1650 between the first crop row 1610 and the first rail 1630, an error may occur when fruits included in the second crop row 1620 are determined.

Accordingly, more specific methods to solve this problem will be described below.

That is, various methods of adaptively obtaining a threshold distance value for performing a distinction between crop rows will be described below.

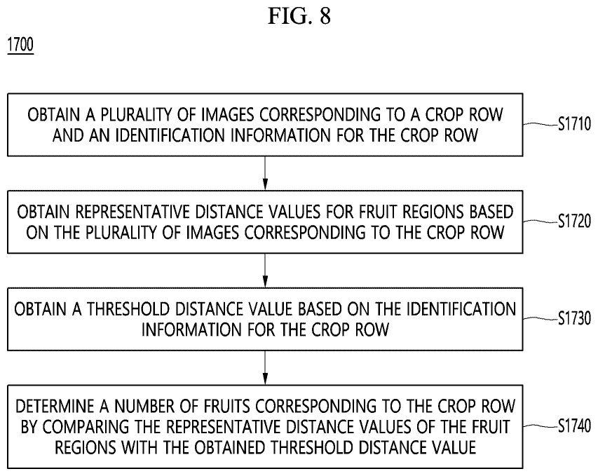

FIG. 8 is a view illustrating a fruit counting method according to one exemplary embodiment.

Referring to FIG. 8, the fruit counting method 1700 according to one exemplary embodiment may include: step S1710 of obtaining a plurality of images corresponding to a crop row and identification information for the crop row; step S1720 of obtaining representative distance values for a plurality of fruit regions on the basis of the plurality of images corresponding to the crop row; step S1730 of obtaining a threshold distance value on the basis of the identification information for the crop row; and step S1740 of determining the number of fruits corresponding to the crop row by comparing the representative distance values for the plurality of fruit regions with the obtained threshold distance value.

In this case, the step S1720 of obtaining the representative distance values for the plurality of fruit regions on the basis of the plurality of images corresponding to the crop row may be performed in the above-described fruit detection module, and may include a step of detecting the above-described fruit regions and calculating representative distance values. However, since the above-mentioned content may be applied to this, redundant descriptions will be omitted.

In the step S1710 of obtaining the plurality of images corresponding to the crop row and the identification information for the crop row according one exemplary embodiment, the content of the image data described above may be applied to the plurality of images corresponding to the crop row, so redundant descriptions will be omitted.

In addition, in the step S1710 of obtaining the plurality of images corresponding to the crop row and the identification information for the crop row according one exemplary embodiment, the identification information for the crop row may be at least one piece of identification information for the crop row that is a target of monitoring.

For example, in the step S1710 of obtaining the plurality of images corresponding to the crop row and the identification information for the crop row according one exemplary embodiment, the identification information for the crop row may include: information that the crop row to be monitored is a specific crop row; information that the crop row to be monitored is one side or the other side of the specific crop row; information that the crop row to be monitored is a front side or a rear side of the specific crop row; information that the crop row to be monitored is a right side or a left side of the specific crop row; and information that the crop row being monitored is a specific sub-crop row, and so on, but is not limited thereto. The identification information for the crop row may include various kinds of information that may be used to identify or distinguish the crop rows to be monitored.

In addition, in the step S1710 of obtaining the plurality of images corresponding to the crop row and the identification information for the crop row according one exemplary embodiment, the identification information for the crop row may be obtained on the basis of position information of a monitoring robot.

For example, in the step S1710 of obtaining the plurality of images corresponding to the crop row and the identification information for the crop row according one exemplary embodiment, the extent of identification for a crop row may be “one side of a first crop row” in a case where a monitoring robot moves in a first direction on a first rail, the extent of identification for a crop row may be “one side of a second crop row” in a case where the monitoring robot moves in a second direction on the first rail, and the extent of identification for a crop row may be “the other side of the first crop row” in a case where a monitoring robot moves in a second direction on a second rail, but is not limited thereto.

In addition, for example, in the step S1710 of obtaining the plurality of images corresponding to the crop row and the identification information for the crop row according one exemplary embodiment, the extent of identification for a crop row may be “a first sub-crop row of a first crop row” in a case where a monitoring robot moves in a first direction on a first rail, the extent of identification for a crop row may be “a third sub-crop row of a second crop row” in a case where the monitoring robot moves in a second direction on the first rail, and the extent of identification for a crop row may be “a second sub-crop row of the first crop row” in a case where a monitoring robot moves in a second direction on a second rail, but is not limited thereto.

However, in the identification information for the crop rows described above, for convenience of description, information-related naming is applied to each of identification information, but in terms of actually implementing this, it may be sufficient to assign identification information for each distinction.

In the step S1730 of obtaining the threshold distance value on the basis of the identification information for the crop row according one exemplary embodiment, the threshold distance value may be obtained as a threshold distance value corresponding to the identification information for the crop row.

For example, a threshold distance value for the first crop row may be obtained as a first threshold distance value, and a threshold distance value for the second crop row may be obtained as a second threshold distance value, but is not limited thereto.

In addition, in the step S1730 of obtaining the threshold distance value on the basis of the identification information for the crop row according one exemplary embodiment, the threshold distance value may be obtained on the basis of a table for matching identification information for a crop row and a threshold distance value.

For example, a table may be stored, in which a threshold distance value for one side of the first crop row is matched to a first distance value that is a distance between the first rail and the first crop row, a threshold distance value for the other side of the first crop row is matched to a second distance value that is a distance between the second rail and the first crop row, and a threshold distance value for one side of the second crop row is matched to a third distance value that is a distance between the first rail and the second crop row. The threshold distance value according to one exemplary embodiment may be obtained on the basis of the above table, but is not limited thereto.

The step S1740 of determining the number of fruits corresponding to the crop row by comparing the representative distance values for the plurality of fruit regions with the obtained threshold distance value may include a step of determining fruit regions whose representative distance values are smaller than the obtained threshold distance value among the plurality of fruit regions as fruit regions corresponding to the crop row.

For example, in the step S1740 of determining the number of fruits corresponding to the crop row by comparing the representative distance values for the fruit regions with the obtained threshold distance value according to one exemplary embodiment, 800 fruit regions whose representative distance values are smaller than the obtained threshold distance value among 1,000 fruit regions may be determined as fruit regions corresponding to the first crop row, but is not limited thereto.

In addition, the step S1740 of determining the number of fruits corresponding to the crop row by comparing the representative distance values for the plurality of fruit regions with the obtained threshold distance value according to one exemplary embodiment may include a step of determining the number of fruits corresponding to the crop row on the basis of the number of determined fruit regions.

For example, in the step S1740 of determining the number of fruits corresponding to the crop row by comparing the representative distance values for the plurality of fruit regions with the obtained threshold distance value according to one exemplary embodiment, the number of fruits corresponding to the first crop row may be determined to be 800 in a case where 800 fruit regions whose representative distance values are smaller than the obtained threshold distance value among 1,000 fruit regions are determined as fruit regions corresponding to the first crop row, but is not limited thereto.

In addition, for example, in the step S1740 of determining the number of fruits corresponding to the crop row by comparing the representative distance values for the plurality of fruit regions with the obtained threshold distance value according to one exemplary embodiment, the number of fruits corresponding to the first crop row including the first sub-crop row and the second sub-crop row may be determined as 1,550 in a case where there are 800 fruit regions whose representative distance values are smaller than the first threshold distance value obtained on the basis of the identification information for the first sub-crop row among 1,000 fruit regions obtained on the basis of the plurality of images corresponding to the first sub-crop row, and also there are 750 fruit regions whose representative distance values are smaller than the second threshold distance value obtained on the basis of the identification information for the second sub-crop row among 950 fruit regions obtained on the basis of the plurality of images corresponding to the second sub-crop row, but is not limited thereto.

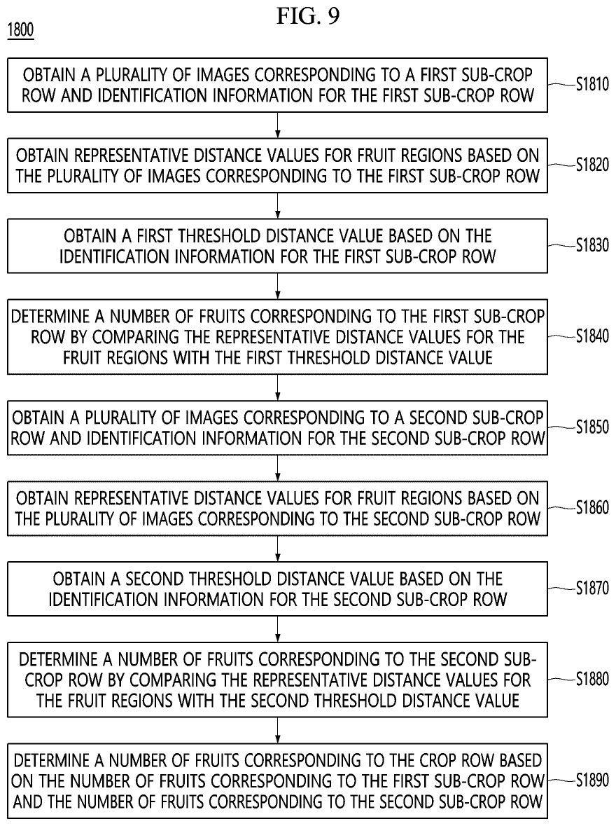

FIG. 9 is a view illustrating a fruit counting method according to one exemplary embodiment.

Referring to FIG. 9, the fruit counting method 1800 may include: step S1810 of obtaining a plurality of images corresponding to a first sub-crop row and identification information for the first sub-crop row; step S1820 of obtaining representative distance values for a plurality of fruit regions on the basis of the plurality of images corresponding to the first sub-crop row; step S1830 of obtaining a first threshold distance value on the basis of the identification information for the first sub-crop row; step S1840 of determining the number of fruits corresponding to the first sub-crop row by comparing the representative distance values for the plurality of fruit regions with the first threshold distance value; step S1850 of obtaining a plurality of images corresponding to a second sub-crop row and identification information for the second sub-crop row; step S1860 of obtaining representative distance values for the plurality of fruit regions on the basis of the plurality of images corresponding to the second sub-crop row; step S1870 of obtaining a second threshold distance value on the basis of identification information for the second sub-crop row; step S1880 of determining the number of fruits corresponding to the second sub-crop row by comparing the representative distance values for the plurality of fruit regions with the second threshold distance value; and step S1890 of determining the number of fruits corresponding to a first crop row on the basis of the number of fruits corresponding to the first sub-crop row and the number of fruits corresponding to the second sub-crop row.

In this case, redundant descriptions will be omitted because the above-described content may be applied to the steps including: the step S1810 of obtaining the plurality of images corresponding to the first sub-crop row and the identification information for the first sub-crop row; the step S1820 of obtaining the representative distance values for the plurality of fruit regions on the basis of the plurality of images corresponding to the first sub-crop row; the step S1830 of obtaining the first threshold distance value on the basis of the identification information for the first sub-crop row; the step S1840 of determining the number of fruits corresponding to the first sub-crop row by comparing the representative distance values for the plurality of fruit regions with the first threshold distance value; the step S1850 of obtaining the plurality of images corresponding to the second sub-crop row and the identification information for the second sub-crop row; the step S1860 of obtaining the representative distance values for the plurality of fruit regions on the basis of the plurality of images corresponding to the second sub-crop row; the step S1870 of obtaining the second threshold distance value on the basis of the identification information for the second sub-crop row; and the step S1880 of determining the number of fruits corresponding to the second sub-crop row by comparing the representative distance values for the plurality of fruit regions with the second threshold distance value.

In addition, in this case, the plurality of images corresponding to the first sub-crop row may be images obtained while a monitoring robot moves in a second direction on an adjacent first rail spaced apart from the first crop row in a first direction.

In addition, in this case, the plurality of images corresponding to the second sub-crop row may be images obtained while the monitoring robot moves in a fourth direction on an adjacent second rail spaced apart from the first crop row in a third direction.

In addition, in this case, the first direction and the second direction may be perpendicular to each other, and the third direction and the fourth direction may be perpendicular to each other.

In addition, in this case, when the first direction and the third direction are different from each other, the third direction and the fourth direction may be different from each other.

In addition, in this case, the first threshold distance value and the second threshold distance value may be different from each other.

In addition, in this case, the first threshold distance value may be stored on the basis of a distance between the first crop row and the first rail, and the second threshold distance value may be stored on the basis of a distance between the first crop row and the second rail.

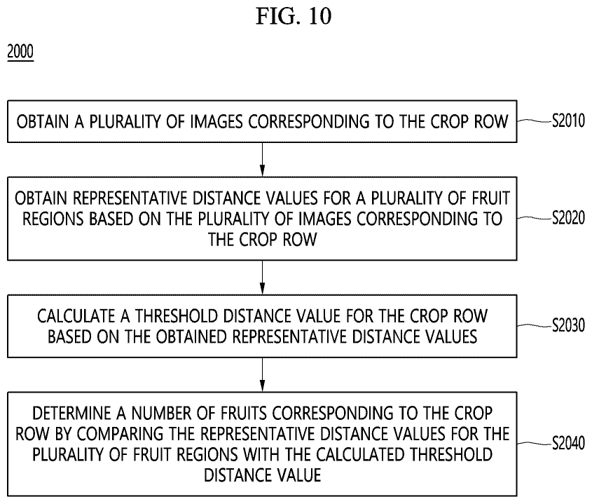

FIG. 10 is a view illustrating a fruit counting method according to one exemplary embodiment.

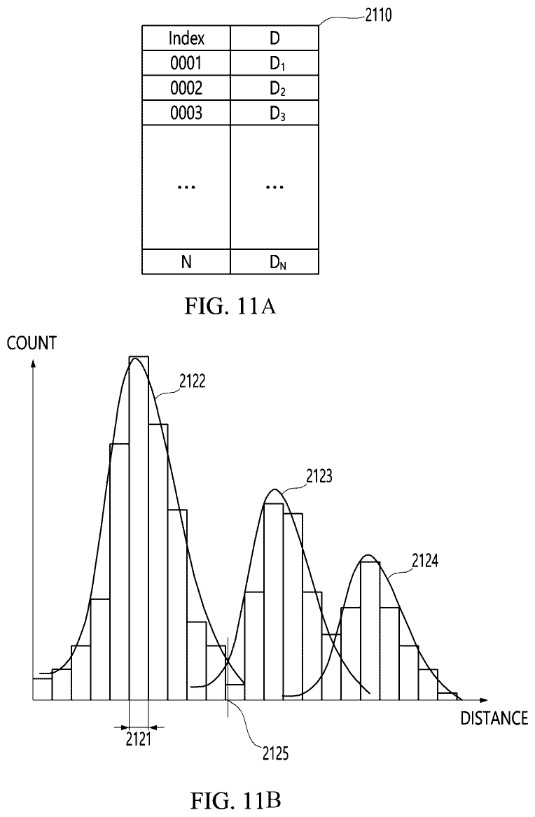

Before describing FIG. 10, it should be noted that at least some of the steps in FIG. 10 can be described with reference to FIGS. 11A and 11B.

Referring to FIG. 10, the fruit counting method 2000 according to one exemplary embodiment may include: step S2010 of obtaining a plurality of images corresponding to a crop row; step S2020 of obtaining representative distance values for a plurality of fruit regions on the basis of the plurality of images corresponding to the crop row; step S2030 of calculating a threshold distance value for the crop row on the basis of the obtained representative distance values; and step S2040 of determining the number of fruits corresponding to the crop row by comparing the representative distance values for the plurality of fruit regions with the calculated threshold distance value.

In this case, the above-described content may be applied to the step S2010 of obtaining the plurality of images corresponding to the crop row and the step S2020 of obtaining the representative distance values for the plurality of fruit regions on the basis of the plurality of images corresponding to the crop row, so redundant descriptions will be omitted.

The step S2030 of calculating the threshold distance value for the crop row on the basis of the obtained representative distance values according to one exemplary embodiment may be performed in a threshold distance value calculation unit, but is not limited thereto.

In addition, the step S2030 of calculating the threshold distance value for the crop row on the basis of the obtained representative distance values according to one exemplary embodiment may include step S2030 of calculating a threshold distance value by considering distribution of the obtained representative distance values.

For example, the step S2030 of calculating the threshold distance value for the crop row on the basis of the obtained representative distance values according to one exemplary embodiment may include a step of generating histogram data for the obtained representative distance values and calculating a threshold distance value on the basis of the generated histogram data, but is not limited thereto.

This will be described in more detail through FIGS. 11A and 11B.

In addition, for example, the step S2030 of calculating the threshold distance value for the crop row on the basis of the obtained representative distance values according to one exemplary embodiment may include, but is not limited to, a step of generating a distance-height distribution map for the obtained representative distance values and relative heights, and calculating a threshold distance value on the basis of the generated distance-height distribution map.

In addition, in addition to the examples described above, the step S2030 of calculating the threshold distance value for the crop row on the basis of the obtained representative distance values according to one exemplary embodiment may use various algorithms for calculating a threshold distance value for a crop row on the basis of obtained representative distance values.

The step S2040 of determining the number of fruits corresponding to the crop row by comparing the representative distance values for the plurality of fruit regions with the calculated threshold distance value according to one exemplary embodiment may include a step of determining fruit regions whose representative distance values are smaller than the calculated threshold distance value as fruit regions corresponding to the crop row among the plurality of fruit regions.

For example, in the step S2040 of determining the number of fruits corresponding to the crop row by comparing the representative distance values for the fruit regions with the calculated threshold distance value according to one exemplary embodiment, 800 fruit regions whose representative distance values are smaller than the calculated threshold distance value among 1,000 fruit regions may be determined as fruit regions corresponding to the first crop row, but is not limited thereto.

The step S2040 of determining the number of fruits corresponding to the crop row by comparing the representative distance values for the fruit regions with the calculated threshold distance value according to one exemplary embodiment may include a step of determining the number of fruits corresponding to the crop row on the basis of the number of determined fruit regions.

For example, in the step S2040 of determining the number of fruits corresponding to the crop row by comparing the representative distance values for the fruit regions with the calculated threshold distance value according to one exemplary embodiment, the number of fruits corresponding to the first crop row may be determined to be 800 in a case where the 800 fruit regions whose representative distance values are smaller than the calculated threshold distance value among 1,000 fruit regions are determined as the fruit regions corresponding to the first crop row, but is not limited thereto.

In addition, for example, in the step S2040 of determining the number of fruits corresponding to the crop row by comparing the representative distance values for the fruit regions with the calculated threshold distance value according to one exemplary embodiment, the number of fruits corresponding to the first crop row including the first and second sub-crop rows may be determined as 1,550 in a case where there are 800 fruit regions whose representative distance values are smaller than the first threshold distance value calculated on the basis of the representative distance values obtained from the plurality of images corresponding to the first sub-crop row among 1,000 fruit regions obtained on the basis of the plurality of images corresponding to the first sub-crop row, and also there are 750 fruit regions whose representative distance values are smaller than the second threshold distance value calculated on the basis of the representative distance values obtained from the plurality of images corresponding to the second sub-crop row among 950 fruit regions obtained on the basis of the plurality of images corresponding to the second sub-crop row, but is not limited thereto.

In addition, according to one exemplary embodiment, the step S2030 of calculating the threshold distance value for the crop row on the basis of the obtained representative distance values and the step S2040 of determining the number of fruits corresponding to the crop row by comparing the representative distance values for the fruit regions with the calculated threshold distance value may be performed in one step.

For example, according to one exemplary embodiment, the number of fruits corresponding to a crop row may be determined by generating a distance-height distribution map for the obtained representative distance values and relative heights, and applying a clustering technique to the generated distance-height distribution map, but is not limited thereto.

In this case, various clustering techniques such as a K-means clustering technique may be used.

In addition, in this case, in a case where a clustering technique is applied to the generated distance-height distribution map, a plurality of fruit regions included in a first cluster may be extracted, and the number of the plurality of fruit regions included in the first cluster may be determined as the number of fruits corresponding to a crop row, but is not limited thereto.

FIGS. 11A and 11B are a view more specifically illustrating a fruit counting method according to one exemplary embodiment.

To this end, FIG. 11A illustrates exemplary output data in obtaining representative distance values for a plurality of fruit regions on the basis of a plurality of images corresponding to the crop row described above, and FIG. 11B illustrates a view more specifically calculating a threshold distance value for the crop row on the basis of the obtained representative distance values described above.

Referring to FIG. 11A, in the step S2020 of obtaining the representative distance values for the plurality of fruit regions on the basis of the plurality of images corresponding to the crop row according to one exemplary embodiment, representative distance value data 2110 for the plurality of fruit regions may be obtained.

In this case, the representative distance value data 2110 for the plurality of fruit regions according to one exemplary embodiment may include index values respectively corresponding to the plurality of fruit regions, and may include distance values respectively corresponding to the plurality of fruit regions.

For example, the representative distance value data 2110 for the plurality of fruit regions according to one exemplary embodiment may include an index value “0001” and a distance value “D_1” corresponding to a first fruit region, and may include an index value “0002” and a distance value “D_2” corresponding to a second fruit region, but is not limited thereto.

In addition, in this case, each of the plurality of fruit regions may mean one fruit included in the crop row, and may mean a feature determined to be one fruit included in the crop row on the basis of the plurality of images, but for convenience of description, it will be described as a fruit region.

In addition, in this case, the representative distance value data 2110 for the plurality of fruit regions according to one exemplary embodiment may include the index values respectively corresponding to the plurality of fruit regions.

In addition, referring to FIG. 11B, in the step S2030 of calculating the threshold distance value for the crop row on the basis of the obtained representative distance values according to one exemplary embodiment, histogram data 2120 may be generated on the basis of the obtained representative distance values.

In this case, the histogram data 2120 may be data representing the number of fruit regions whose representative distance values are included in a unit distance range.

For example, in a case where a first representative distance value for a first fruit region is 1 cm, a second representative distance value for a second fruit region is 2 cm, a third representative distance value for a third fruit region is 3 cm, a first unit distance range is 1 to 2 cm, and a second unit distance range is 3 to 4 cm, the histogram data 2120 may be data that assigns a counting value corresponding to 2 to the first unit distance range and assigns a counting value corresponding to 1 to the second unit distance range, but is not limited thereto.

In addition, a size 2121 of the unit distance range of the histogram data 2120 according to one exemplary embodiment may be provided in various ways.

For example, the size of the unit distance range of the histogram data 2120 according to one exemplary embodiment may be provided in various ways, such as 1 cm, 2 cm, 3 cm, 4 cm, 5 cm, 6 cm, 7 cm, 8 cm, 9 cm, 10 cm, 11 cm, 12 cm, 13 cm, 14 cm, 15 cm, 16 cm, 17 cm, 18 cm, 19 cm, 20 cm or more, but it is not limited thereto.

In addition, the size 2121 of the unit distance range of the histogram data 2120 according to one exemplary embodiment may be provided identically for each unit distance.

For example, according to one exemplary embodiment, a size of a first unit distance range of the histogram data 2120 may be provided to be the same as a size of a second unit distance range, but is not limited thereto.

In addition, the size 2121 of the unit distance range of the histogram data 2120 according to one exemplary embodiment may be provided at least partially different for each unit distance.

For example, in the histogram data 2120 according to one exemplary embodiment, the size of the first unit distance range may be provided differently from the size of the second unit distance range, but is not limited thereto.

In addition, referring to FIG. 11B, the histogram data 2120 generated in the step S2030 of calculating the threshold distance value for the crop row on the basis of the obtained representative distance values according to one exemplary embodiment may be processed to calculate a threshold distance value.

In this case, according to one exemplary embodiment, at least one mixture model may be applied in order to process the generated histogram data 2120, and the at least one mixture model may mean a probability model for statistically representing distribution of subgroups within the entire group, but is not limited thereto, and may include a model having a concept commonly understood as a mixture model.

For example, according to one exemplary embodiment, a Gaussian mixture model may be applied in order to process the generated histogram data 2120, but is not limited thereto.

In addition, according to one exemplary embodiment, a plurality of sub-distribution data may be generated on the basis of the generated histogram data 2120.

For example, in a case where the Gaussian mixture model is applied to the histogram data 2120 generated according to one exemplary embodiment, first Gaussian distribution data 2122, second Gaussian distribution data 2123, and third Gaussian distribution data 2124 may be generated, but it is not limited thereto.

In this case, each of the plurality of sub-distribution data may mean the distribution of fruits included in a different crop row within a greenhouse.

For example, the first Gaussian distribution data 2122 may mean the distribution of fruits included in a first sub-crop row, the second Gaussian distribution data 2123 may mean the distribution of fruits included in a second sub-crop row, and the third Gaussian distribution data 2124 may mean the distribution of fruits included in a third sub-crop row, but it is not limited thereto.

In addition, according to one exemplary embodiment, a threshold distance value for a crop row may be obtained on the basis of a plurality of generated sub-distribution data.

For example, a first distance value 2125 corresponding to an intersection of the first Gaussian distribution data 2122 and the second Gaussian distribution data 2123, which are generated according to one exemplary embodiment, may be obtained as a threshold distance value, but is not limited thereto.

In addition, according to one exemplary embodiment, the obtained threshold distance value may be different from the size of a unit distance range of the generated histogram data.

For example, according to one exemplary embodiment, the size of the unit distance range of the generated histogram data is 5 cm, but an obtained threshold distance value may be generated in units of 1 cm, but is not limited thereto.

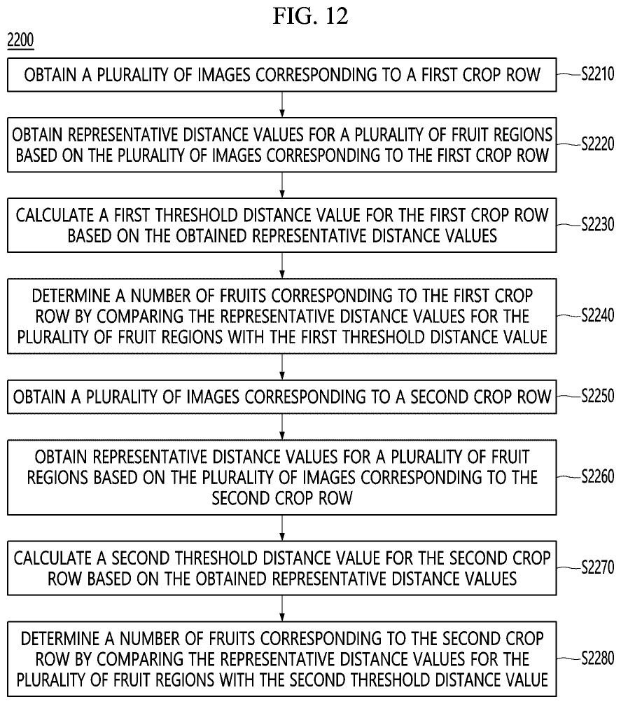

FIG. 12 is a view illustrating a fruit counting method according to one exemplary embodiment.

Referring to FIG. 12, the fruit counting method 2200 according to one exemplary embodiment may include: step S2210 of obtaining a plurality of images corresponding to a first crop row; step S2220 of obtaining representative distance values for a plurality of fruit regions on the basis of the plurality of images corresponding to the first crop row; step S2230 of calculating a first threshold distance value for the first crop row on the basis of the obtained representative distance values; step S2240 of determining the number of fruits corresponding to the first crop row by comparing the representative distance values for the plurality of fruit regions with the first threshold distance value; step S2250 of obtaining a plurality of images corresponding to a second crop row; step S2260 of obtaining representative distance values for a plurality of fruit regions on the basis of the plurality of images corresponding to the second crop row; step S2270 of calculating a second threshold distance value for the second crop row on the basis of the obtained representative distance values; and step S2280 of determining the number of fruits corresponding to the second crop row by comparing the representative distance values for the plurality of fruit regions with the second threshold distance value. Since the above-described content may be applied to this, redundant descriptions will be omitted.

In this case, the plurality of images corresponding to the first crop row may be images obtained by a monitoring robot while moving on a first rail adjacent to the first crop row in a first direction.

In addition, in this case, the plurality of images corresponding to the second crop row may be images obtained by the monitoring robot while moving the first rail adjacent to the second crop row in a second direction.

In addition, in this case, the plurality of images corresponding to the second crop row may be images obtained by the monitoring robot while moving on a second rail adjacent to the second crop row in a first direction.

In addition, in this case, the first direction and the second direction may be different from each other.

In addition, in this case, the first threshold distance value and the second threshold distance value may be different from each other.

In addition, in this case, a size of a unit distance range of the first histogram data generated in the step S2230 of calculating the first threshold distance value for the first crop row on the basis of the obtained representative distance values according to one exemplary embodiment may be the same as a size of a unit distance range of the second histogram data generated in the step S2270 of calculating the second threshold distance value for the second crop row on the basis of the obtained representative distance values according to one exemplary embodiment.

For example, the size of the unit distance range of the first histogram data may be 5 cm, and the size of the unit distance range of the second histogram data may be 5 cm, but is not limited thereto.

In addition, in this case, according to one exemplary embodiment, even when a distance between the first rail and the first crop row is the same as a distance between the second rail and the first crop row, the first threshold distance value and the second threshold distance value may be different from each other.

In addition, in this case, according to one exemplary embodiment, in a case where a distance between the first rail and the first crop row is longer than a distance between the second rail and the first crop row, a first threshold distance value may be greater than a second threshold distance value.

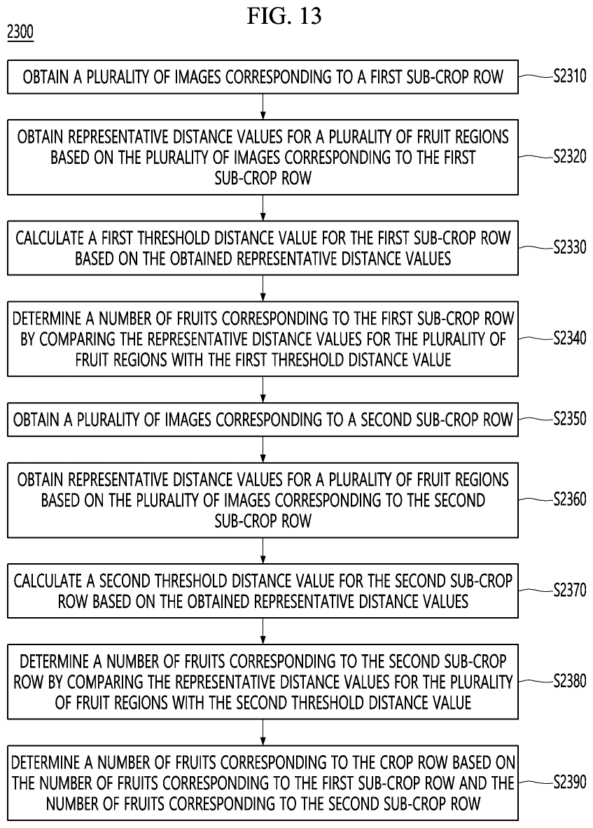

FIG. 13 is a view illustrating a fruit counting method according to one exemplary embodiment.

Referring to FIG. 13, the fruit counting method 2300 according to one exemplary embodiment may include: step S2310 of obtaining a plurality of images corresponding to a first sub-crop row; step S2320 of obtaining representative distance values for a plurality of fruit regions on the basis of the plurality of images corresponding to the first sub-crop row; step S2330 of calculating a first threshold distance value for the first sub-crop row on the basis of the obtained representative distance values; step S2340 of determining the number of fruits corresponding to the first sub-crop row by comparing the representative distance values for the plurality of fruit regions with the first threshold distance value; step S2350 of obtaining a plurality of images corresponding to a second sub-crop row; step S2360 of obtaining representative distance values for a plurality of fruit regions on the basis of the plurality of images corresponding to the second sub-crop row; step S2370 of calculating a second threshold distance value for the second sub-crop row on the basis of the obtained representative distance values; step S2380 of determining the number of fruits corresponding to the second sub-crop row by comparing the representative distance values for the plurality of fruit regions with the second threshold distance value; and a step S2390 of determining the number of fruits corresponding to the first crop row on the basis of the number of fruits corresponding to the first sub-crop row and the number of fruits corresponding to the second sub-crop row. Since the above-described content may be applied to this, redundant descriptions will be omitted.

In addition, in this case, the plurality of images corresponding to the first sub-crop row may be images obtained while a monitoring robot moves in a second direction on an adjacent first rail spaced apart from the first crop row in a first direction.

In addition, in this case, the plurality of images corresponding to the second sub-crop row may be images obtained while a monitoring robot moves in a fourth direction on an adjacent second rail spaced apart from the first crop row in a third direction.

In addition, in this case, the first direction and the second direction may be perpendicular to each other, and the third direction and the fourth direction may be perpendicular to each other.

In addition, in this case, when the first direction and the third direction are different from each other, the third direction and the fourth direction may be different from each other.

In addition, in this case, the first threshold distance value and the second threshold distance value may be different from each other.

In addition, in this case, the size of the unit distance range of the first histogram data generated in the step S2330 of calculating the first threshold distance value for the first crop row on the basis of the obtained representative distance values according to one exemplary embodiment may be the same as the size of the unit distance range of the second histogram data generated in the step S2370 of calculating the second threshold distance value for the second crop row on the basis of the obtained representative distance values according to one exemplary embodiment.

For example, the size of the unit distance range of the first histogram data may be 5 cm, and the size of the unit distance range of the second histogram data may be 5 cm, but is not limited thereto.

In addition, in this case, according to one exemplary embodiment, even when a distance between the first rail and the first crop row is the same as a distance between the second rail and the first crop row, a first threshold distance value and a second threshold distance value may be different from each other.

In addition, in this case, according to one exemplary embodiment, in a case where a distance between the first rail and the first crop row is longer than a distance between the second rail and the first crop row, a first threshold distance value may be greater than a second threshold distance value.

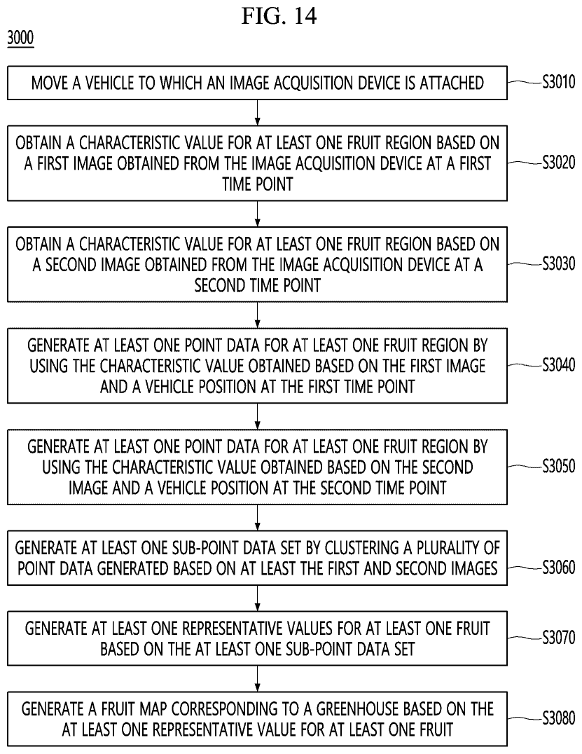

FIG. 14 is a view illustrating a fruit map generation method according to one exemplary embodiment.

Referring to FIG. 14, the fruit map generation method 3000 according to one exemplary embodiment may include: step S3010 of moving a vehicle to which an image acquisition device is attached; step S3020 of obtaining feature values for at least one fruit region on the basis of a first image obtained from the image acquisition device at a first time point; step S3030 of obtaining feature values for at least one fruit region on the basis of a second image obtained from the image acquisition device at a second time point; step S3040 of generating at least one piece of point data on the basis of the feature values for the at least one fruit region obtained on the basis of the first image and a vehicle position at the first time point; step S3050 of generating at least one piece of point data on the basis of the feature values for the at least one fruit region obtained on the basis of the second image and a vehicle position at the second time point; step S3060 of generating at least one sub-point data set by clustering a plurality of point data generated on the basis of at least the first and second images; and step S3070 of generating at least one representative value for at least one fruit on the basis of the at least one sub-point data set; and step S3080 of generating a fruit map corresponding to a greenhouse on the basis of the at least one representative value for the at least one fruit.

In the step S3010 of moving the vehicle to which the image acquisition device is attached according to one exemplary embodiment, the image acquisition device may be, but is not limited to, a depth camera and the like described above.

In addition, in the step S3010 of moving the vehicle to which the image acquisition device is attached according to one exemplary embodiment, the vehicle to which the image acquisition device is attached may correspond to the monitoring robot described above. Since the content of the monitoring robot described above may be applied to this, redundant descriptions will be omitted.

In addition, in the step S3010 of moving the vehicle to which the image acquisition device is attached according to one exemplary embodiment, the vehicle may be moved between crop rows located in a greenhouse.

For example, the vehicle may be moved on at least one rail located between the crop rows located in the greenhouse, but is not limited to this.

In addition, in the step S3010 of moving the vehicle to which the image acquisition device is attached according to one exemplary embodiment, the image acquisition device may be attached so as to have a height that is a predetermined distance or more from wheels included in the vehicle.

The above-described content may be applied to the step S3020 of obtaining the feature values for the at least one fruit region on the basis of the first image obtained from the image acquisition device at the first time point according to one exemplary embodiment, so redundant descriptions will be omitted.

In addition, in the step S3020 of obtaining the feature values for the at least one fruit region on the basis of the first image obtained from the image acquisition device at the first time point according to one exemplary embodiment, the first image may include an image captured from the image acquisition device at the first time point and obtained from a server after the first time point.

In addition, in the step S3020 of obtaining the feature values for the at least one fruit region on the basis of the first image obtained from the image acquisition device at the first time point according to one exemplary embodiment, the at least one fruit region may be a region corresponding to a fruit appearing in the first image.

In addition, in the step S3020 of obtaining the feature values for the at least one fruit region on the basis of the first image obtained from the image acquisition device at the first time point according to one exemplary embodiment, feature values for a plurality of fruit regions may be obtained.

For example, in a case where there is a plurality of fruits in a crop plant appearing in the first image, or in a case where there is a plurality of fruits in a plurality of crop plants appearing in the first image, a plurality of feature values for a plurality of fruit regions may be obtained, but the present disclosure is not limited thereto.

In addition, for example, in the step S3020 of obtaining the feature values for the at least one fruit region on the basis of the first image obtained from the image acquisition device at the first time point according to one exemplary embodiment, first feature values for the first fruit region and second feature values for the second fruit region may be obtained, but is not limited thereto.

In addition, in the step S3020 of obtaining the feature values for the at least one fruit region on the basis of the first image obtained from the image acquisition device at the first time point according to one exemplary embodiment, the feature values may include various values.

For example, the feature values may include, but are not limited to, pixel coordinate values for at least one fruit region and distance values for the at least one fruit region.

In this case, since the above-described content may be applied to the obtaining of the pixel coordinate values for the at least one fruit region or the distance values for the at least one fruit region, redundant descriptions will be omitted.

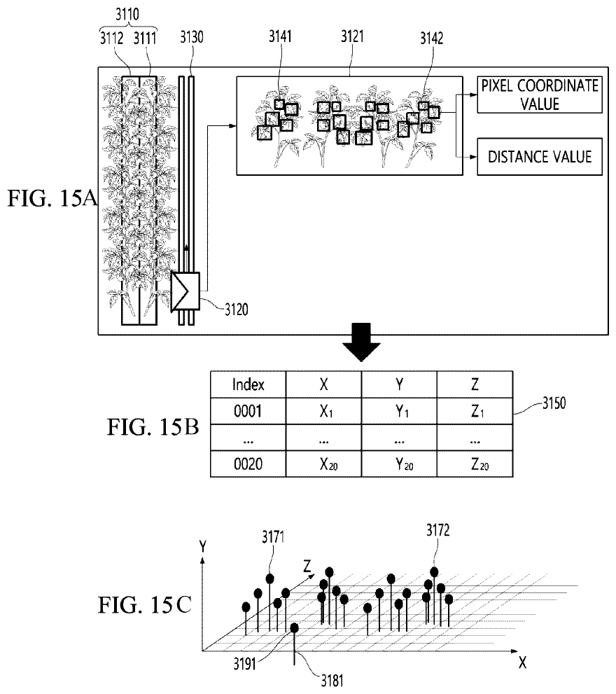

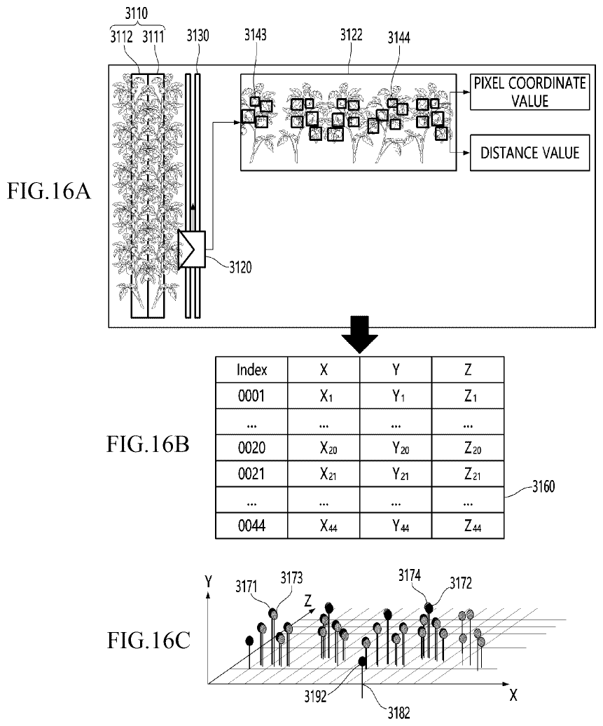

In addition, the step S3020 of obtaining the feature values for the at least one fruit region on the basis of the first image obtained from the image acquisition device at the first time point according to one exemplary embodiment will be described in more detail with reference to FIGS. 15A, 15B, 15C, 16A, 16B and 16C.

The above-described content may be applied to the step S3030 of obtaining the feature values for the at least one fruit region on the basis of the second image obtained from the image acquisition device at the second time point according to one exemplary embodiment, so redundant descriptions will be omitted.

In addition, in the step S3030 of obtaining the feature values for the at least one fruit region on the basis of the second image obtained from the image acquisition device at the second time point according to one exemplary embodiment, the second image may include an image that is captured from the image acquisition device at the second time point and then obtained from a server after the second time point.

In addition, in the step S3030 of obtaining the feature values for the at least one fruit region on the basis of the second image obtained from the image acquisition device at the second time point according to one exemplary embodiment, the at least one fruit region may be a region corresponding to a fruit appearing in the second image.

In addition, in the step S3030 of obtaining the feature values for the at least one fruit region on the basis of the second image obtained from the image acquisition device at the second time point according to one exemplary embodiment, feature values for a plurality of fruit regions may be obtained.

For example, in a case where there is a plurality of fruits in a crop plant appearing in the second image, or in a case where there is a plurality of fruits in a plurality of crop plants appearing in the second image, a plurality of feature values for a plurality of fruit regions may be obtained, but the present disclosure is not limited thereto.

In addition, for example, in the step S3030 of obtaining the feature values for the at least one fruit region on the basis of the second image obtained from the image acquisition device at the second time point according to one exemplary embodiment, third feature values for a third fruit region and fourth feature values for a fourth fruit region may be obtained, but it is not limited thereto.

In addition, in the step S3030 of obtaining the feature values for the at least one fruit region on the basis of the second image obtained from the image acquisition device at the second time point according to one exemplary embodiment, the feature values may include various values.

For example, the feature values may include, but are not limited to, pixel coordinate values for at least one fruit region and distance values for the at least one fruit region.

In this case, since the above-described content may be applied to the obtaining of the pixel coordinate values for the at least one fruit region or the distance values for at least one fruit region, redundant descriptions will be omitted.

In addition, the step S3030 of obtaining the feature values for the at least one fruit region on the basis of the second image obtained from the image acquisition device at the second time point according to one exemplary embodiment will be described in more detail with reference to FIGS. 15A, 15B, 15C, 16A, 16B and 16C.

The step S3040 of generating the at least one piece of point data on the basis of the feature values for the at least one fruit region obtained on the basis of the first image and the vehicle position at the first time point according to one exemplary embodiment may include a step of generating three-dimensional position coordinate values of the at least one piece of point data on the basis of the pixel coordinate values, distance value, and the vehicle position at the first time point for the at least one fruit region obtained on the basis of the first image.

For example, the step S3040 of generating the at least one piece of point data on the basis of the feature values for the at least one fruit region obtained on the basis of the first image and the vehicle position at the first time point according to one exemplary embodiment may include, but is not limited to: generating first position coordinate values of first point data on the basis of the first pixel coordinate values, a first distance value, and the vehicle position at the first time point for the first fruit region; and generating second position coordinate values of the second point data on the basis of the second pixel coordinate values, a second distance value, and the vehicle position at the second time point for the second fruit region.

In addition, in the step S3040 of generating the at least one piece of point data on the basis of the feature values for the at least one fruit region obtained on the basis of the first image and the vehicle position at the first time point according to one exemplary embodiment, the vehicle position at the first time point may be obtained from a positioning device included in a vehicle, but is not limited thereto, and may be obtained by considering movement speed, movement time, and the like of the vehicle.

In addition, in the step S3040 of generating the at least one piece of point data on the basis of the feature values for the at least one fruit region obtained on the basis of the first image and the vehicle position at the first time point according to one exemplary embodiment, the image acquisition device's position calculated on the basis of the vehicle position at the first time point may be used in order to generate the at least one piece of point data.

For example, in the point data generated in the step S3040 of generating the at least one piece of point data on the basis of the feature values for the at least one fruit region obtained on the basis of the first image and the vehicle position at the first time point according to one exemplary embodiment, first point data may be generated on the basis of the first pixel coordinate values for the first fruit region, the first distance value, the vehicle position at the first time point, and a height value of the image acquisition device attached to the vehicle, and second point data may be generated on the basis of the second pixel coordinate values for the second fruit region, the second distance value, the vehicle position at the first time point, and the height value of the image acquisition device attached to the vehicle, but is not limited thereto.

In addition, the step S3040 of generating the at least one piece of point data on the basis of the feature values for the at least one fruit region obtained on the basis of the first image and the vehicle position at the first time point according to one exemplary embodiment will be described in more detail with reference to FIGS. 15A, 15B, 15C, 16A, 16B and 16C.

The step S3050 of generating the at least one piece of point data on the basis of the feature values for the at least one fruit region obtained on the basis of the second image and the vehicle position at the second time point according to one exemplary embodiment may include a step of generating three-dimensional position coordinate values of the at least one piece of point data on the basis of the pixel coordinate values, the distance values, and the vehicle position at the second time point for the at least one fruit region obtained on the basis of the second image.

For example, the step S3050 of generating the at least one piece of point data on the basis of the feature values for the at least one fruit region obtained on the basis of the second image and the vehicle position at the second time according to one exemplary embodiment may include a step of generating third position coordinate values of third point data on the basis of third pixel coordinate values for a third fruit region, a third distance value, and the vehicle position at the second time, and generating fourth position coordinate values of fourth point data on the basis of fourth pixel coordinate values for the fourth fruit region, a fourth distance value, and the vehicle position at the second time, but is not limited thereto.

In addition, in the step S3050 of generating the at least one piece of point data on the basis of the feature values for the at least one fruit region obtained on the basis of the second image and the vehicle position at the second time point according to one exemplary embodiment, the vehicle position at the second time point may be obtained from the positioning device included in the vehicle, but is not limited thereto, and may be obtained by considering movement speed, movement time, and the like of the vehicle.

In addition, in the step S3050 of generating the at least one piece of point data on the basis of the feature values for the at least one fruit region obtained on the basis of the second image and the vehicle position at the second time point according to one exemplary embodiment, the image acquisition device's position calculated on the basis of the vehicle position at the second time point may be used to generate the at least one piece of point data.

For example, in the point data generated in the step S3050 of generating the at least one piece of point data on the basis of the feature values for the at least one fruit region obtained on the basis of the second image and the vehicle position at the second time according to one exemplary embodiment, the third point data may be generated on the basis of the third pixel coordinate values for the third fruit region, the third distance value, the vehicle position at the second time, and the height value of the image acquisition device attached to the vehicle, and the fourth point data may be generated on the basis of the fourth pixel coordinate values for the fourth fruit region, the fourth distance value, the vehicle position at the second time, and the height value of the image acquisition device attached to the vehicle, but is not limited thereto.

In addition, the step S3050 of generating the at least one piece of point data on the basis of the feature values for the at least one fruit region obtained on the basis of the second image and the vehicle position at the second time point according to one exemplary embodiment will be described in more detail with reference to FIGS. 15A, 15B, 15C, 16A, 16B and 16C.

The step S3060 of generating the at least one sub-point data set by clustering the plurality of point data generated on the basis of at least the first and second images according to one exemplary embodiment may include a step of generating at least one sub-point data set by performing clustering on the basis of position coordinate values included in the plurality of point data.

In addition, in the step S3060 of generating the at least one sub-point data set by clustering the plurality of point data generated on the basis of at least the first and second images according to one exemplary embodiment, various clustering algorithms may be used.

For example, in the step S3060 of generating the at least one sub-point data set by clustering the plurality of point data generated on the basis of at least the first and second images according to one exemplary embodiment, a K-means clustering technique may be used, but is not limited thereto, and various algorithms for clustering three-dimensional point data may be used.

In addition, in the step S3060 of generating the at least one sub-point data set by clustering the plurality of point data generated on the basis of at least the first and second images according to one exemplary embodiment, the at least one sub-point data set may mean at least one or more of point data groups for one fruit among the plurality of point data.

In addition, in the step S3060 of generating the at least one sub-point data set by clustering the plurality of point data generated on the basis of at least the first and second images according to one exemplary embodiment, the at least one sub-point data set may include at least one piece of point data.

For example, the first sub-point data set may include: first point data for a first fruit region included in a first image; and third point data for a third fruit region included in a second image. The second sub-point data set may include: second point data for a second fruit region included in the first image; and fourth point data for a fourth fruit region included in the second image, but is not limited thereto.

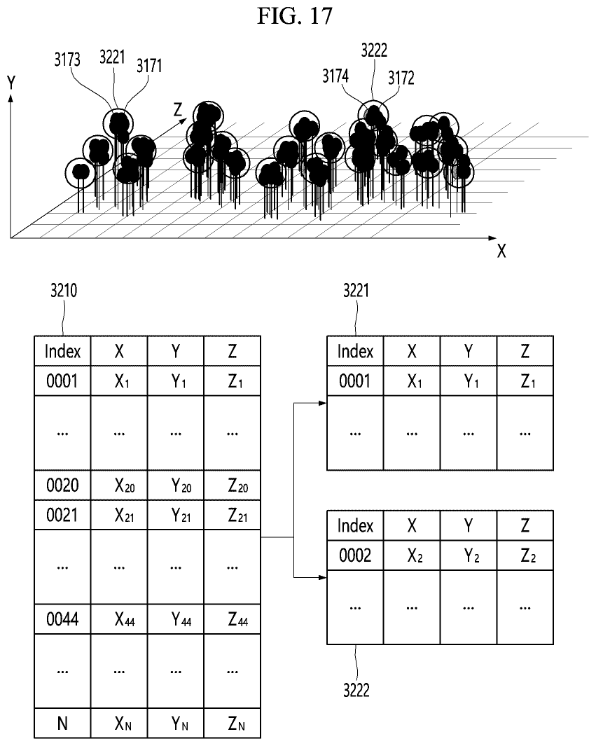

In addition, the step S3060 of generating the at least one sub-point data set by clustering the plurality of point data generated on the basis of at least the first and second images according to one exemplary embodiment will be described in more detail with reference to FIG. 17.

The step S3070 of generating the at least one representative value for the at least one fruit on the basis of the at least one sub-point data set according to one exemplary embodiment may include generating a plurality of representative values for a plurality of fruits on the basis of a plurality of sub-point data sets.

For example, the step S3070 of generating the at least one representative value for the at least one fruit on the basis of the at least one sub-point data set according to one exemplary embodiment may include, but is not limited to, generating first representative position coordinate values for a first fruit on the basis of the first sub-point data set and generating second representative position coordinate values for a second fruit on the basis of the second sub-point data set.

In addition, in the step S3070 of generating the at least one representative value for the at least one fruit on the basis of the at least one sub-point data set according to one exemplary embodiment, the at least one representative value may include representative position coordinate values.

In addition, in the step S3070 of generating the at least one representative value for the at least one fruit on the basis of the at least one sub-point data set according to one exemplary embodiment, various algorithms may be used to generate at least one representative value.

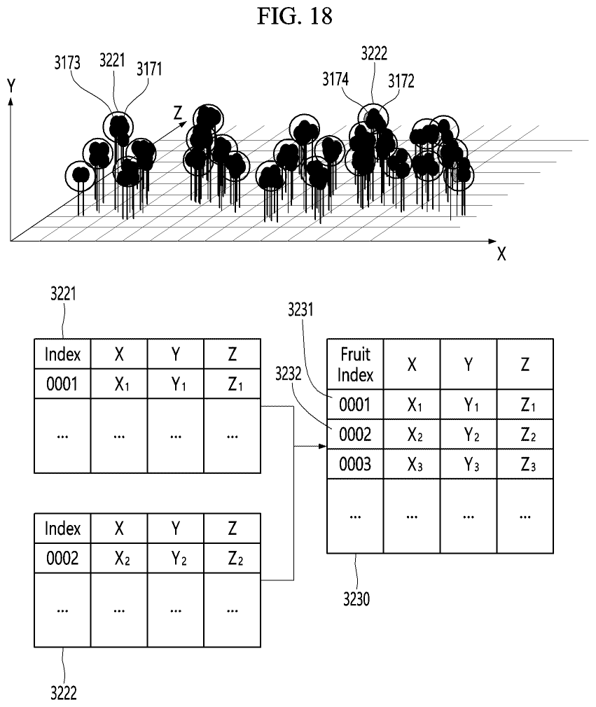

In addition, the step S3070 of generating the at least one representative value for the at least one fruit on the basis of the at least one sub-point data set according to one exemplary embodiment will be described in more detail with reference to FIG. 18.

The step S3080 of generating the fruit map corresponding to the greenhouse on the basis of the at least one representative value for the at least one fruit according to one exemplary embodiment may include a step of generating a fruit map by arranging at least one representative value for at least one fruit in a virtual space.

For example, the step S3080 of generating the fruit map corresponding to the greenhouse on the basis of the at least one representative value for the at least one fruit according to one exemplary embodiment may include, but is not limited to, a step of generating a fruit map by arranging at least one representative value for at least one fruit in a three-dimensional virtual space.

In addition, for example, the step S3080 of generating the fruit map corresponding to the greenhouse on the basis of the at least one representative value for the at least one fruit according to one exemplary embodiment may include, but is not limited to, a step of generating a fruit map by arranging at least one representative value for at least one fruit in a two-dimensional virtual space.

In addition, the step S3080 of generating the fruit map corresponding to the greenhouse on the basis of the at least one representative value for the at least one fruit according to one exemplary embodiment may include: a step of obtaining a plurality of representative values for a plurality of crop rows; and a step of generating a fruit map corresponding to the greenhouse on the basis of the plurality of representative values.

For example, the step S3080 of generating the fruit map corresponding to the greenhouse on the basis of the at least one representative value for the at least one fruit according to one exemplary embodiment may include: a step of generating at least one representative value for at least one fruit for a first crop row; a step of generating at least one representative value for at least one fruit for a second crop row; and a step of generating a fruit map corresponding to the greenhouse on the basis of a plurality of representative values generated for at least the first and second crop rows.

FIGS. 15A, 15B, 15C, 16A, 16B and 16C are views more specifically illustrating a method of obtaining feature values for a fruit region and a method of generating point data according to one exemplary embodiment.

To this end, FIG. 15A illustrates a first image obtained from an image acquisition device at a first time point and feature values for at least one fruit region obtained on the basis of the first image, FIG. 15B illustrates at least one piece of point data as an example, and FIG. 15C illustrates point data arranged in a three-dimensional coordinate system for understanding the at least one piece of point data as an example.

In addition, FIG. 16A illustrates a second image obtained from an image acquisition device at a second time point and feature values for at least one fruit region obtained on the basis of the second image, FIG. 16B illustrates at least one piece of point data as an example, and FIG. 16C illustrates point data arranged in a three-dimensional coordinate system for understanding the at least one piece of point data as an example.

First, referring to FIGS. 15A and 16A, a greenhouse according to one exemplary embodiment may include a first crop row 3110. The first crop row 3110 may include a first sub-crop row 3111 and a second sub-crop row 3112.

In addition, a vehicle 3120 to which the image acquisition device is attached according to one exemplary embodiment may move in a first direction on a first rail 3130 arranged in the greenhouse.

In addition, the vehicle 3120 to which the image acquisition device is attached according to one exemplary embodiment moves in the first direction on the first rail 3130 arranged in the greenhouse and may obtain a plurality of images of the first crop row 3110.

In addition, the vehicle 3120 to which the image acquisition device is attached according to one exemplary embodiment moves in the first direction on the first rail 3130 arranged in the greenhouse and may obtain a plurality of images of the first sub-crop row 3111.

In addition, referring to FIG. 15A, a first image 3121 may be obtained from the image acquisition device at a first time point. The first image 3121 may include pixels for a plurality of crop plants.

In addition, according to one exemplary embodiment, feature values for at least one fruit region may be obtained on the basis of the first image 3121.

For example, according to one exemplary embodiment, pixel coordinate values and distance values for the at least one fruit region may be obtained on the basis of the first image 3121, but it is not limited to this.

In addition, for example, according to one exemplary embodiment, on the basis of the first image 3121, first pixel coordinate values and a first distance value for a first fruit region 3141 may be obtained and second pixel coordinate values and a second distance value for a second fruit region 3142 may be obtained.

In addition, referring to FIG. 16A, a second image 3122 may be obtained from the image acquisition device at a second time point, and the second image 3122 may include pixels for a plurality of crop plants.

In addition, according to one exemplary embodiment, feature values for at least one fruit region may be obtained on the basis of the second image 3122.

For example, according to one exemplary embodiment, pixel coordinate values and distance values for the at least one fruit region may be obtained on the basis of the second image 3122, but it is not limited thereto.

In addition, for example, according to one exemplary embodiment, on the basis of the second image 3122, third pixel coordinate values and a third distance value for a third fruit region 3143 may be obtained and fourth pixel coordinate values and a fourth distance value for a fourth fruit region 3144 may be obtained.

Referring back to FIGS. 15A and 16A together, according to one exemplary embodiment, the first fruit region 3141 included in the first image 3121 and the third fruit region 3143 included in the second image 3122 may be regions of images expressing the same fruit.

In addition, according to one exemplary embodiment, the second fruit region 3142 included in the first image 3121 and the fourth fruit region 3144 included in the second image 3122 may be regions of images expressing the same fruit.

In addition, according to one exemplary embodiment, the first pixel coordinate values for the first fruit region 3141 obtained on the basis of the first image 3121 may be different from the third pixel coordinate values for the third fruit region 3143 obtained on the basis of the second image 3122.

This means that the first fruit region 3141 and the third fruit region 3143 may be the regions of images expressing the same fruit, but the pixel coordinate values within the first image 3121 or the second image 3122 may become different as the vehicle 3120 to which the image acquisition device is attached moves in a first direction.

In addition, according to one exemplary embodiment, the second pixel coordinate values for the second fruit region 3142 obtained on the basis of the first image 3121 may be different from the fourth pixel coordinate values for the fourth fruit region 3144 obtained on the basis of the second image 3122.

This means that the second fruit region 3142 and the fourth fruit region 3144 may be the regions of images expressing the same fruit, but the pixel coordinate values within the first image 3121 or the second image 3122 may become different as the vehicle 3120 to which the image acquisition device is attached moves in the first direction.

In addition, referring to FIG. 15B, according to one exemplary embodiment, at least one piece of point data 3150 may be generated on the basis of the first image 3121.

In this case, according to one exemplary embodiment, the at least one piece of point data 3150 generated on the basis of the first image 3121 may include position coordinate values.

For example, first point data generated on the basis of the first image 3121 may include first position coordinate values, and second point data may include second position coordinate values.

In addition, according to one exemplary embodiment, the at least one piece of point data 3150 generated on the basis of the first image 3121 may be generated on the basis of the pixel coordinate values, the distance values, and the vehicle position at the first time point for the at least one fruit region obtained on the basis of the first image 3121.

For example, referring to FIG. 15C, according to one exemplary embodiment, in the point data included in the at least one piece of point data 3150 generated on the basis of the first image 3121, first point data 3171 may be generated on the basis of the first pixel coordinate values for the first fruit region 3141, a first distance value, and the vehicle position 3181 at the first time point, and second point data 3172 may be generated on the basis of the second pixel coordinate values for the second fruit region 3142, a second distance value, and the vehicle position 3181 at the first time point.

In addition, according to one exemplary embodiment, the at least one piece of point data 3150 generated on the basis of the first image 3121 may be generated on the basis of the image acquisition device's position generated on the basis of the pixel coordinate values, the distance values, and the vehicle position at the first time point for the at least one fruit region obtained on the basis of the first image 3121.

For example, referring to FIG. 15C, according to one exemplary embodiment, in the point data included in the at least one piece of point data 3150 generated on the basis of the first image 3121, the first point data 3171 may be generated on the basis of the image acquisition device's position 3191 calculated on the basis of the first pixel coordinate values, the first distance value, and the vehicle position 3181 at the first time point for the first fruit region 3141, and the second point data 3172 may be generated on the basis of the image acquisition device's the position 3191 calculated on the basis of the second pixel coordinate values, the second distance value, and the vehicle position 3181 at the first time point for the second fruit region 3142.

In addition, according to one exemplary embodiment, the at least one piece of point data 3150 generated on the basis of the first image 3121 may include point data corresponding to the number of fruit regions included in the first image 3121.

For example, as shown in FIG. 15A, in a case where the number of fruit regions included in the first image 3121 is 20, the number of pieces of point data included in the at least one piece of point data 3150 generated on the basis of the first image 3121 may be 20, but is not limited thereto.

In addition, referring to FIG. 16B, according to one exemplary embodiment, at least one piece of point data 3160 may be generated on the basis of the second image 3122.

In this case, according to one exemplary embodiment, the at least one piece of point data 3160 generated on the basis of the second image 3122 may include position coordinate values.

For example, in point data generated on the basis of the second image 3122, third point data may include third position coordinate values, and fourth point data may include fourth position coordinate values.

In addition, according to one exemplary embodiment, the at least one piece of point data 3160 generated on the basis of the second image 3122 may be generated on the basis of pixel coordinate values, distance values, and a vehicle position at a second time point for the at least one fruit region obtained on the basis of the second image 3122.

For example, referring to FIG. 16C together, according to one exemplary embodiment, in point data included in the at least one piece of point data 3160 generated on the basis of the second image 3122, third point data 3173 may be generated on the basis of the third pixel coordinate values, the third distance value, and the vehicle position 3182 at the second time point for the third fruit region 3143, and fourth point data 3174 may be generated on the basis of the fourth pixel coordinate values, the fourth distance value, and the vehicle position 3182 at the second time point for the fourth fruit region 3144.

In addition, according to one exemplary embodiment, the at least one piece of point data 3160 generated on the basis of the second image 3122 may be generated on the basis of the pixel coordinate values, the distance values, and the image acquisition device's position calculated on the basis of the vehicle position at the second time point for the at least one fruit region obtained on the basis of the second image 3122.

For example, referring to FIG. 16C together, according to one exemplary embodiment, in point data included in the at least one piece of point data 3160 generated on the basis of the second image 3122, the third point data 3173 may be generated on the basis of the third pixel coordinate values, the third distance value, and the image acquisition device's position 3192 calculated on the basis of the position 3181 of the vehicle at the second time point for the third fruit region 3143, and the fourth point data 3174 may be generated on the basis of the fourth pixel coordinate values, the fourth distance value, and the image acquisition device's position 3192 calculated on the basis of the position 3181 of the vehicle at the second time point for the fourth fruit region 3144.

In addition, according to one exemplary embodiment, the at least one piece of point data 3160 generated on the basis of the second image 3122 may include point data corresponding to the number of fruit regions included in the second image 3122.

For example, as shown in FIG. 16A, in a case where the number of fruit regions included in the second image 3122 is 24, the number of pieces of point data included in the at least one piece of point data 3160 generated on the basis of the second image 3122 may be 24, but is not limited thereto.

In addition, according to one exemplary embodiment, the first position coordinate values of the first point data 3171 obtained on the basis of the first image 3121 may be similar to the third position coordinate values of the third point data 3173 obtained on the basis of the second image 3122.

This may mean that, even when the first pixel coordinate values for the first fruit region 3141 and the third pixel coordinate values for the third fruit region 3143 are different from each other, the first fruit region 3141 and the third fruit region 3143 are regions for the same fruit, so the position coordinate values of the point data generated by considering the vehicle position at the time each image is obtained may be similar to each other.

In addition, according to one exemplary embodiment, the second position coordinate values of the second point data 3172 obtained on the basis of the first image 3121 may be similar to the fourth position coordinate values of the fourth point data 3174 obtained on the basis of the second image 3122.

This may mean that, even when the second pixel coordinate values for the second fruit region 3142 and the fourth pixel coordinate values for the fourth fruit region 3144 are different from each other, the second fruit region 3142 and the fourth fruit region 3144 are regions for the same fruit, so the position coordinate values of the point data generated by considering the vehicle position at the time each image is obtained may be similar to each other.

In addition, according to one exemplary embodiment, the point data generated on the basis of the first image 3121 and the second image 3122 may include: at least one piece of point data 3150 generated on the basis of the first image 3121; and at least one piece of point data 3160 generated on the basis of the second image 3122.

For example, the point data generated on the basis of the first image 3121 and the second image 3122 may include: 20 pieces of point data generated on the basis of the first image 3121; and 24 pieces of point data generated on the basis of the second image 3122, but is not limited thereto.

In addition, according to one exemplary embodiment, point data generated on the basis of a plurality of image data may include at least one piece of point data generated on the basis of each piece of the plurality of image data.

Hereinafter, the processing of point data generated on the basis of a plurality of image data will be described in more detail.

FIG. 17 is a view illustrating more specifically a method of clustering a plurality of point data according to one exemplary embodiment.

Before describing FIG. 17, for convenience of description, it is noted that FIG. 17 may be described together with the content of FIGS. 15A, 15B, 15C, 16A, 16B and 16C.

Referring to FIG. 17, according to one exemplary embodiment, a plurality of point data 3210 may be obtained.

In this case, the plurality of point data 3210 may mean a plurality of point data generated on the basis of at least first and second images, but is not limited thereto, and may mean a plurality of point data generated on the basis of a plurality of images.

In addition, the plurality of point data 3210 according to one exemplary embodiment may at least include at least of one piece of point data generated on the basis of a first image 3121 and at least of one piece of point data generated on the basis of a second image 3122.

For example, the plurality of point data 3210 according to one exemplary embodiment may include: first point data 3171 and second point data 3172, which are generated on the basis of the first image 3121; and third point data 3173 and fourth point data 3174, which are generated on the basis of a second image 3122.

In addition, according to one exemplary embodiment, at least one sub-point data set may be generated on the basis of a plurality of point data 3210.

For example, according to one exemplary embodiment, a first sub-point data set 3221 may at least be generated on the basis of the first point data 3171 generated on the basis of the first image 3121 and third point data 3173 generated on the basis of the second image 3122, and a second sub-point data set 3222 may at least be generated on the basis of the second point data 3172 generated on the basis of the first image 3121 and fourth point data 3174 generated on the basis of the second image 3122.

In addition, according to one exemplary embodiment, at least one clustering algorithm may be used to generate at least one sub-point data set on the basis of the plurality of point data 3210.

For example, according to one exemplary embodiment, a K-means clustering algorithm may be used to generate at least one sub-point data set on the basis of the plurality of point data 3210, but is not limited thereto, and various algorithms for clustering three-dimensional point data may be used.

In addition, according to one exemplary embodiment, at least one sub-point data set may include a plurality of point data for one fruit.

For example, according to one exemplary embodiment, the first sub-point data set 3221 may include: first point data 3171 for a first fruit expressed in the first image 3121; and third point data 3173 for the first fruit expressed in the second image 3122.

In addition, for example, according to one exemplary embodiment, the second sub-point data set 3222 may include: second point data 3172 for a second fruit expressed in the first image 3121; and fourth point data 3174 for the second fruit expressed in the second image 3122.

Hereinafter, a method of generating at least one representative value for at least one fruit by processing at least one sub-point data set is described in more detail.

FIG. 18 is a view illustrating more specifically a method of generating at least one representative value for at least one fruit according to one exemplary embodiment.

Referring to FIG. 18, according to one exemplary embodiment, the at least one representative value 3230 for the at least one fruit may be generated.

According to one exemplary embodiment, the at least one representative value 3230 for the at least one fruit may include representative values for a plurality of fruits.

For example, according to one exemplary embodiment, the at least one representative value 3230 for the at least one fruit may include: first representative position coordinate values 3231 for a first fruit; and second representative position coordinate values 3232 for a second fruit.

According to one exemplary embodiment, the at least one representative value 3230 for the at least one fruit may be generated on the basis of a corresponding sub-point data set.

For example, according to one exemplary embodiment, the first representative position coordinate values 3231 for the first fruit may be generated on the basis of a plurality of point data included in a first sub-point data set 3221, and the second representative position coordinate values 3232 for the second fruit may be generated on the basis of a plurality of point data included in a second sub-point data set 3222.

For example, according to one exemplary embodiment, the first representative position coordinate values 3231 for the first fruit may be generated as average values of position coordinate values of the plurality of point data included in the first sub-point data set 3221, and the second representative position coordinate values 3232 for the second fruit may be generated as average values of position coordinate values of the plurality of point data included in the second sub-point data set 3222.

In addition, according to one exemplary embodiment, the at least one representative value 3230 for the at least one fruit may be selected as ones from among position coordinate values of a plurality of point data included in a corresponding sub-point data set.

For example, according to one exemplary embodiment, the first representative position coordinate values 3231 for the first fruit may be selected as the first position coordinate values of the first point data 3171 from among the plurality of point data included in the first sub-point data set 3221, and the second representative position coordinate value 3232 for the second fruit may be selected as the second position coordinate values of the second point data 3172 from among the plurality of point data included in the second sub-point data set 3222, but is not limited thereto.

In addition, according to one exemplary embodiment, the at least one representative value 3230 for the at least one fruit may be generated by applying weights to the position coordinate values of the plurality of point data included in the corresponding sub-point data set.

For example, according to one exemplary embodiment, the first representative position coordinate values 3231 for the first fruit may be generated by applying weights of Gaussian shapes to the position coordinate values of the plurality of point data included in the first sub-point data set 3221, and the second representative position coordinate values 3232 for the second fruit may be generated by applying weights of Gaussian shapes to the position coordinate values of the plurality of point data included in the second sub-point data set 3222, but it is not limited to this.

In addition, for example, according to one exemplary embodiment, the first representative position coordinate values 3231 for the first fruit may be generated by applying weights of Laplacian shapes to the position coordinate values of the plurality of point data included in the first sub-point data set 3221, and the second representative position coordinate value 3232 for the second fruit may be generated by applying weights of Laplacian shapes to the position coordinate values of the plurality of point data included in the second sub-point data set 3222, but is not limited thereto.

In addition, various algorithms may be used to generate at least one representative value in addition to the examples described above.

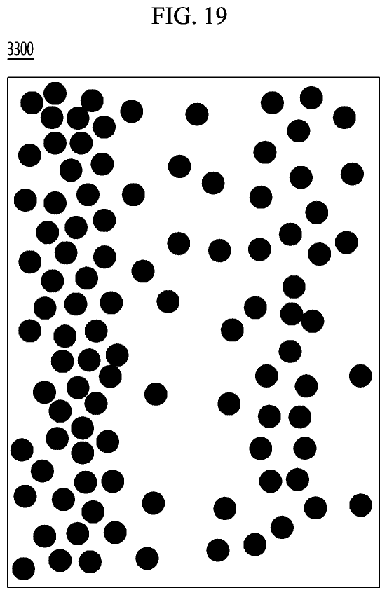

FIG. 19 is a view exemplarily illustrating a fruit map generated according to one exemplary embodiment.

Referring to FIG. 19, in the fruit map 3300 generated according to one exemplary embodiment, at least one representative value for at least one fruit may be expressed in a virtual space.

In addition, as illustrated in FIG. 19, the fruit map 3300 generated according to one exemplary embodiment may be a map in which the at least one representative position coordinate value for the at least one fruit is expressed in a two-dimensional virtual space, but is not limited thereto.

In addition, the fruit map 3300 generated according to one exemplary embodiment may be a map in which the at least one representative position coordinate value for the at least one fruit is expressed in a three-dimensional virtual space, unlike that illustrated in FIG. 19, but is not limited thereto.

Hereinafter, a method of counting fruits corresponding to a crop row on the basis of a generated fruit map or at least one representative value for at least one fruit will be described in more detail.

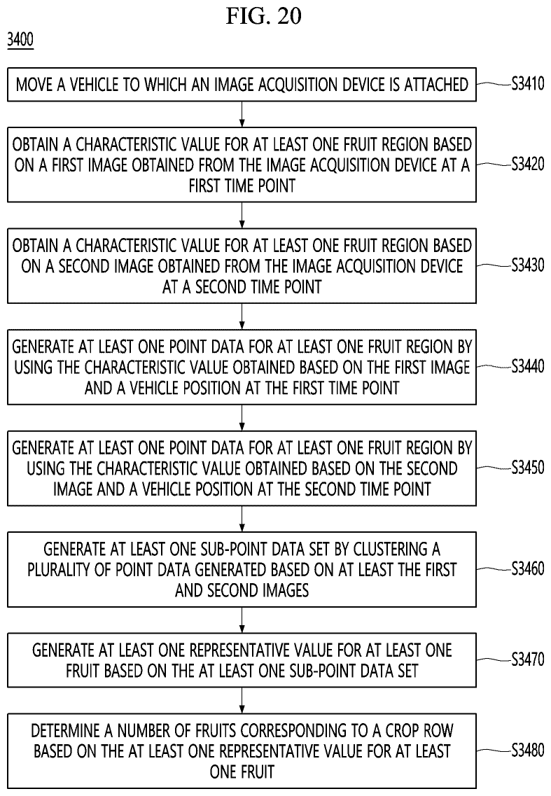

FIG. 20 is a view illustrating a fruit counting method according to one exemplary embodiment.

Referring to FIG. 20, the fruit counting method 3400 according to one exemplary embodiment may include: step S3410 of moving a vehicle to which an image acquisition device is attached; step S3420 of obtaining feature values for at least one fruit region on the basis of a first image obtained from the image acquisition device at a first time point; step S3430 of obtaining feature values for at least one fruit region on the basis of a second image obtained from the image acquisition device at a second time point; step S3440 of generating at least one piece of point data on the basis of the feature values for the at least one fruit region obtained on the basis of the first image and a vehicle position at the first time point; step S3450 of generating at least one piece of point data on the basis of the feature values for the at least one fruit region obtained on the basis of the second image and a vehicle position at the second time point; step S3460 of generating at least one sub-point data set by clustering a plurality of point data generated on the basis of at least the first and second images; step S3470 of generating at least one representative value for at least one fruit on the basis of the at least one sub-point data set; and step S3480 of determining the number of fruits corresponding to a crop row on the basis of the at least one representative value for the at least one fruit.

In this case, redundant descriptions will be omitted because the above-described content may be applied to the steps including: the step S3410 of moving the vehicle to which the image acquisition device is attached; the step S3420 of obtaining the feature values for the at least one fruit region on the basis of the first image obtained from the image acquisition device at the first time point; the step S3430 of obtaining the feature values for the at least one fruit region on the basis of the second image obtained from the image acquisition device at the second time point; the step S3440 of generating the at least one piece of point data on the basis of the feature values for the at least one fruit region obtained on the basis of the first image and the vehicle position at the first time point; the step S3450 of generating the at least one piece of point data on the basis of the feature values for the at least one fruit region obtained on the basis of the second image and the vehicle position at the second time point; the step S3460 of generating the at least one sub-point data set by clustering the plurality of point data generated on the basis of at least the first and second images; and the step S3470 of generating the at least one representative value for the at least one fruit on the basis of the at least one sub-point data set.

In addition, the step S3480 of determining the number of fruits corresponding to the crop row on the basis of the at least one representative value for the at least one fruit according to one exemplary embodiment may include a step of determining the number of fruits corresponding to the crop row by comparing the at least one representative value for the at least one fruit with a preset threshold distance value.

In this case, the step of determining the number of fruits corresponding to the crop row by comparing the at least one representative value for the at least one fruit with the preset threshold distance value may be applied as described through FIGS. 5 and 6, so redundant descriptions will be omitted.

In addition, the step S3480 of determining the number of fruits corresponding to the crop row on the basis of the at least one representative value for the at least one fruit according to one exemplary embodiment may include a step of determining the number of fruits corresponding to the crop row by comparing the at least one representative value for the at least one fruit with the threshold distance value obtained on the basis of identification information for the crop row.

In this case, the content described through FIGS. 7 to 9 may be applied to the step of determining the number of fruits corresponding to the crop row by comparing the at least one representative value for the at least one fruit with the threshold distance value obtained on the basis of the identification information for the crop row, so redundant descriptions will be omitted.

In addition, the step S3480 of determining the number of fruits corresponding to the crop row on the basis of the at least one representative value for the at least one fruit according to one exemplary embodiment may include a step of determining the number of fruits corresponding to the crop row by comparing the at least one representative value for the at least one fruit with the threshold distance value calculated on the basis of the at least one representative value for the at least one fruit.

In this case, the content described through FIGS. 10 to 13 may be applied to the step of determining the number of fruits corresponding to the crop row by comparing the at least one representative value for the at least one fruit with the threshold distance value calculated on the basis of the at least one representative value for the at least one fruit, so redundant descriptions will be omitted.

In addition, the step S3480 of determining the number of fruits corresponding to the crop row on the basis of the at least one representative value for the at least one fruit according to one exemplary embodiment may include a step of determining the number of fruits corresponding to the crop row by applying both the at least one representative value for the at least one fruit and a clustering technique to the at least one representative value for the at least one fruit.

In this case, various clustering techniques such as the K-means clustering technique may be used for the clustering technique, but is not limited thereto, and various algorithms for clustering two-dimensional or three-dimensional point data may be used.

In addition, in this case, a plurality of representative values included in a first cluster may be extracted, and the number of representative values included in the first cluster may be determined as the number of fruits corresponding to a crop row, but is not limited thereto.

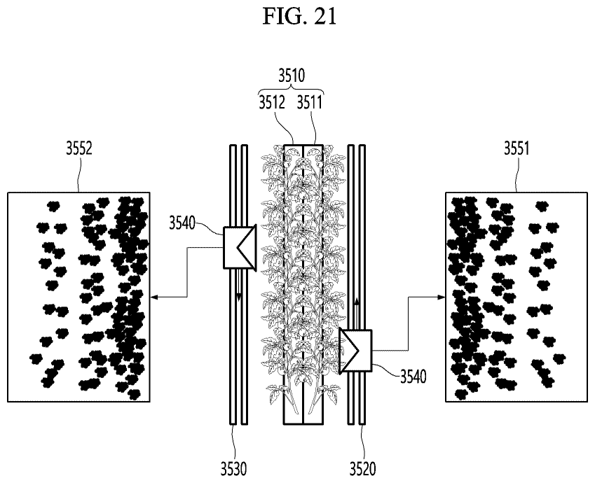

FIG. 21 is a view illustrating an environment for monitoring a crop row included in a greenhouse according to one exemplary embodiment.

Referring to FIG. 21, the greenhouse according to one exemplary embodiment may include a first crop row 3510. The first crop row 3510 may include a first sub-crop row 3511 and a second sub-crop row 3512.

In addition, a vehicle 3540 to which an image acquisition device is attached according to one exemplary embodiment moves in a first direction on a first rail 3520 arranged in the greenhouse and may obtain a plurality of images of the first crop row 3510.

In addition, the vehicle 3540 to which the image acquisition device is attached according to one exemplary embodiment moves in the first direction on the first rail 3520 arranged in the greenhouse and may obtain a plurality of images for the first sub-crop row 3511.

In addition, the vehicle 3540 to which the image acquisition device is attached according to one exemplary embodiment moves in a second direction on a second rail 3530 arranged in the greenhouse and may obtain a plurality of images of the first crop row 3510.

In addition, the vehicle 3540 to which the image acquisition device is attached according to one exemplary embodiment moves in the second direction on the second rail 3530 arranged in the greenhouse and may obtain a plurality of images of the second sub-crop row 3512.

In addition, according to one exemplary embodiment, a first plurality of point data 3551 may be generated on the basis of the plurality of images obtained while the vehicle 3540 to which the image acquisition device is attached moves in the first direction on the first rail 3520 arranged in the greenhouse.

In addition, according to one exemplary embodiment, a second plurality of point data 3552 may be generated on the basis of the plurality of images obtained while the vehicle 3540 to which the image acquisition device is attached moves in the second direction on the second rail 3530 arranged in the greenhouse.

In this case, in the first plurality of point data 3551, relatively much data may be applied for the first sub-crop row 3511 included in the first crop row 3510, but relatively little data may be applied for the second sub-crop row 3512. In the second plurality of point data 3552, relatively much data may be applied for the second sub-crop row 3512 included in the first crop row 3510, but relatively little data may be applied for the first sub-crop row 3511.

This may be because at least a part of the second sub-crop row 3512 is blocked from view by the first sub-crop row 3511, or at least a part of the first sub-crop row 3511 is blocked from view by the second sub-crop row 3512.

In addition, according to one exemplary embodiment, the plurality of images obtained while the vehicle 3540 to which the image acquisition device is attached moves in the first direction on the first rail 3520 arranged in the greenhouse and the plurality of images obtained while the vehicle 3540 to which the image acquisition device is attached moves in the second direction on the second rail 3530 arranged in the greenhouse may represent different sides of the first crop row 3510.

Accordingly, a method of generating a plurality of enhanced point data may be required in order to apply diverse information to the first crop row 3510.

In addition, in a case of performing the step of generating the sub-point data set described above through FIG. 14 or FIG. 20 by using the plurality of enhanced point data, a more accurate representative value for a fruit may be generated.

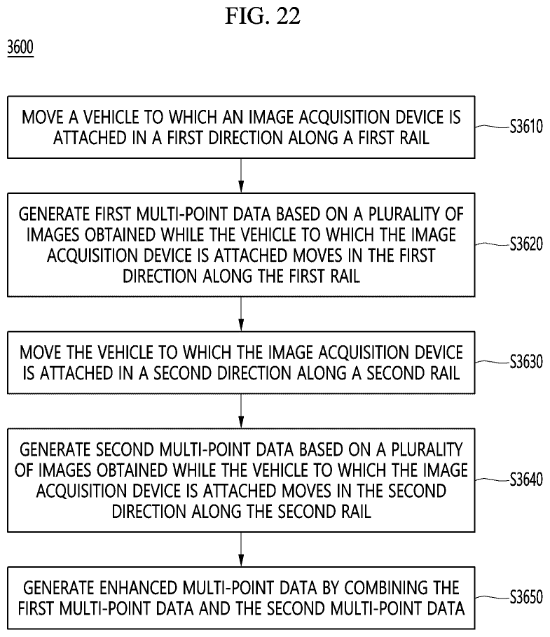

FIG. 22 is a view illustrating a method of generating a plurality of enhanced point data according to one exemplary embodiment.

Referring to FIG. 22, the method 3600 of generating the plurality of enhanced point data according to one exemplary embodiment may include: step S3610 of moving a vehicle to which an image acquisition device is attached in a first direction on a first rail; step S3620 of generating a first plurality of point data on the basis of a plurality of images obtained while the vehicle to which the image acquisition device is attached is moving in the first direction on the first rail; step S3630 of moving the vehicle to which the image acquisition device is attached in a second direction on a second rail; step S3640 of generating a second plurality of point data on the basis of a plurality of images obtained while the vehicle to which the image acquisition device is attached is moving in the second direction on the second rail; and step S3650 of generating the plurality of enhanced point data by aligning the first plurality of point data and the second plurality of point data.

In this case, redundant descriptions will be omitted because the above-described content may be applied to the steps including: the step S3610 of moving the vehicle to which the image acquisition device is attached in the first direction on the first rail; the step S3620 of generating the first plurality of point data on the basis of the plurality of images obtained while the vehicle to which the image acquisition device is attached is moving in the first direction on the first rail; the step S3630 of moving the vehicle to which the image acquisition device is attached in the second direction on the second rail; and the step S3640 of generating the second plurality of point data on the basis of the plurality of images obtained while the vehicle to which the image acquisition device is attached is moving in the second direction on the second rail.

In addition, in this case, the first rail and the second rail may be rails positioned adjacent to a first crop row.

In addition, in this case, the first rail and the second rail may be positioned to face each other relative to the first crop row.

In addition, in this case, the first direction and the second direction may be different from each other.

In addition, in this case, the first plurality of point data and the second plurality of point data may include point data for the same fruit.

For example, the first plurality of point data may include first point data for a first fruit, and the second plurality of point data may include second point data for the first fruit, but is not limited thereto.

In the step S3650 of generating the plurality of enhanced point data by aligning the first plurality of point data and the second plurality of point data according to one exemplary embodiment, a distance between the first rail and the second rail may be considered in order to align the first plurality of point data and the second plurality of point data.

In addition, in the step S3650 of generating the plurality of enhanced point data by aligning the first plurality of point data and the second plurality of point data according to one exemplary embodiment, a coordinate system of the second plurality of point data may be expressed on a coordinate system of the first plurality of point data in order to align the first plurality of point data and the second plurality of point data.

In addition, in the step S3650 of generating the plurality of enhanced point data by aligning the plurality of first point data and the second plurality of point data according to one exemplary embodiment, the coordinate system of the first plurality of point data may be expressed on the coordinate system of the second plurality of point data in order to align the first plurality of point data and the second plurality of point data.

In addition, in the step S3650 of generating the plurality of enhanced point data by aligning the first plurality of point data and the second plurality of point data according to one exemplary embodiment, the coordinate system of the first plurality of point data and the coordinate system of the second plurality of point data may be converted into a global coordinate system. in order to align the first plurality of point data and the second plurality of point data.

In this case, the global coordinate system may mean a coordinate system based on a greenhouse, but is not limited thereto.

In addition, the plurality of enhanced point data generated according to one exemplary embodiment may be used to generate a sub-point data set as described above with reference to FIG. 14 or FIG. 20, more specifically, may be used to generate the fruit map corresponding to the greenhouse as described above with reference to FIG. 14, and may be used to determine the number of fruits corresponding to the crop row as described above with reference to FIG. 20. However, since the above-described content may be applied to this, redundant descriptions will be omitted.

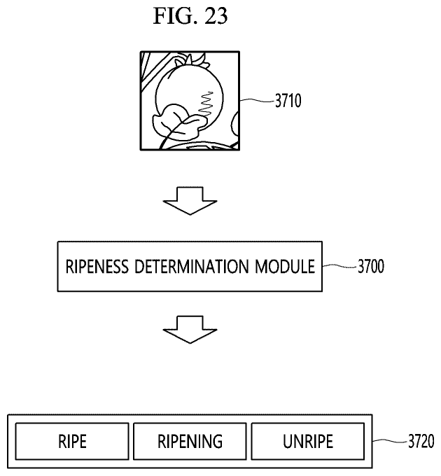

FIG. 23 is a view illustrating a ripeness determination module according to one exemplary embodiment.

Referring to FIG. 23, the ripeness determination module 3700 according to one exemplary embodiment may be a module for outputting a ripeness classification value 3720 for a fruit region on the basis of at least one piece of image data 3710 for a fruit.

The at least one piece of image data 3710 for the fruit according to one exemplary embodiment may be an image obtained from a monitoring robot included in a crop management system.

For example, first image data included in the at least one piece of image data 3710 for the fruit according to one exemplary embodiment may be, but is not limited to, at least a part of an area of the image obtained from the monitoring robot at a first time point.

In addition, the at least one piece of image data 3710 for the fruit according to one exemplary embodiment may be image data cropped from image data including at least a part of at least one or more crop plants.

For example, the first image data included in the at least one piece of image data 3710 for the fruit according to one exemplary embodiment is obtained from the monitoring robot at the first time point, and may be an image generated by cropping a region corresponding to a fruit region from image data for at least a part of the at least one or more crop plants, but is not limited thereto.

In addition, the ripeness determination module 3700 according to one exemplary embodiment may be implemented by using a machine learning method. For example, the fruit detection module 1100 according to one exemplary embodiment may be a model implemented through supervised learning, but is not limited thereto, and may be a model implemented through unsupervised learning, semi-supervised learning, reinforcement learning, etc.

In addition, the ripeness determination module 3700 according to one exemplary embodiment may be implemented with at least one artificial neural network (ANN). For example, the fruit detection module 1100 according to one exemplary embodiment may include at least one artificial neural network layer among various artificial neural network layers such as a feedforward neural network, a radial basis function network or a Cohen self-organizing network, a convolutional neural network (CNN), a recurrent neural network (RNN), a long short term memory network (LSTM), or gated recurrent units (GRUs), but is not limited thereto.

In addition, the at least one artificial neural network layer included in the ripeness determination module 3700 according to one exemplary embodiment may use the same or different activation functions.

In this case, the activation functions may include a sigmoid function, a hyperbolic tangent function (Tanh function), a rectified linear unit function (ReLU function), a leaky ReLU function, an exponential linear unit function (ELU function), a Softmax function, etc., but is not limited thereto, and may include various activation functions (including custom activation functions) for outputting result values or transmitting them to other artificial neural network layers.

In addition, the ripeness determination module 3700 according to one exemplary embodiment may be trained by using a training data set including at least one piece of image data for a fruit.

For example, the ripeness determination module 3700 according to one exemplary embodiment may be trained by using the training data set including the at least one piece of image data for the fruit and an annotation corresponding to this image data, but is not limited thereto.

In addition, the ripeness determination module 3700 according to one exemplary embodiment may be trained by using at least one loss function.

In this case, the at least one loss function may include a Mean Squared Error (MSE), a Root Mean Squared Error (RMSE), Binary Crossentropy, Categorical Crossentropy, Sparse Categorical Crossentropy, etc., but is not limited thereto, and may include various functions (including custom loss functions) or calculating a difference between a predicted result value and an actual result value.

In addition, at least one optimizer may be used for training of the ripeness determination module 3700 according to one exemplary embodiment.

In this case, the at least one optimizer may include Gradient descent, Batch Gradient Descent, Stochastic Gradient Descent, Mini-batch Gradient Descent, Momentum, AdaGrad, RMSProp, AdaDelta, Adam, NAG, NAdam, RAdam, AdamW, etc., but is not limited thereto.

In addition, the ripeness classification value 3720 according to one exemplary embodiment may be provided as a probability value.

For example, the ripeness classification value 3720 according to one exemplary embodiment may be provided as a probability value that a class is included in ripeness, a probability value that a class is included in ripening, or a probability value that a class is included in unripeness, but is not limited thereto.

In addition, the ripeness classification value 3720 according to one exemplary embodiment may be provided as a classification result.

For example, the ripeness classification value 3720 according to one exemplary embodiment may be provided as a classification result regarding whether a class of an image for an input fruit is in “ripeness”, “ripening”, or “unripeness”, but is not limited thereto.

In addition, the class for “ripeness”, “ripening”, or “unripeness” described above are only a name of the class for convenience of description, and class distinction is not limited to the naming.

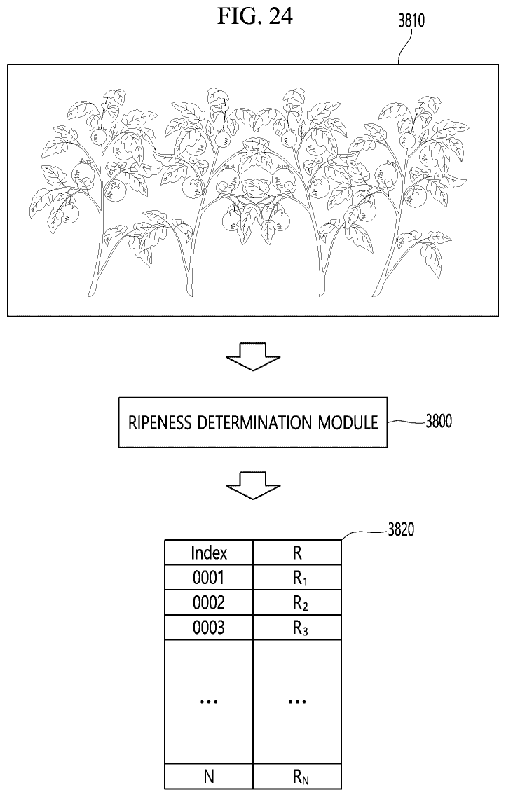

FIG. 24 is a view illustrating a ripeness determination module according to one exemplary embodiment.

Referring to FIG. 24, the ripeness determination module 3800 according to one exemplary embodiment may be a module for outputting at least one representative value 3820 for at least one fruit region on the basis of image data 3810 for a crop plant.

In this case, the above-described content may be applied to the ripeness determination module 3800, so redundant descriptions will be omitted.

The image data 3810 for the crop plants according to one exemplary embodiment may be an image obtained from a monitoring robot included in a crop management system.

For example, in image data included in the image data 3810 for the crop plants according to one exemplary embodiment, first image data may be an image obtained from the monitoring robot at a first time point, second image data may be an image obtained from the monitoring robot at a second time point, and third image data may be an image obtained from the monitoring robot at a third time point, but is not limited thereto.

In addition, the at least one representative value 3820 for the at least one fruit region according to one exemplary embodiment may include a ripeness value for each of a plurality of fruit regions.

For example, the at least one representative value 3820 for the at least one fruit region according to one exemplary embodiment may include, but is not limited to, a first ripeness value for a first fruit region and a second ripeness value for a second fruit region.

In a case of using the ripeness determination module described through FIGS. 23 and 24, the ripeness values for the at least one fruit region may be additionally obtained.

Accordingly, below, a method of generating a fruit map by using ripeness values for at least one fruit region will be described in more detail.

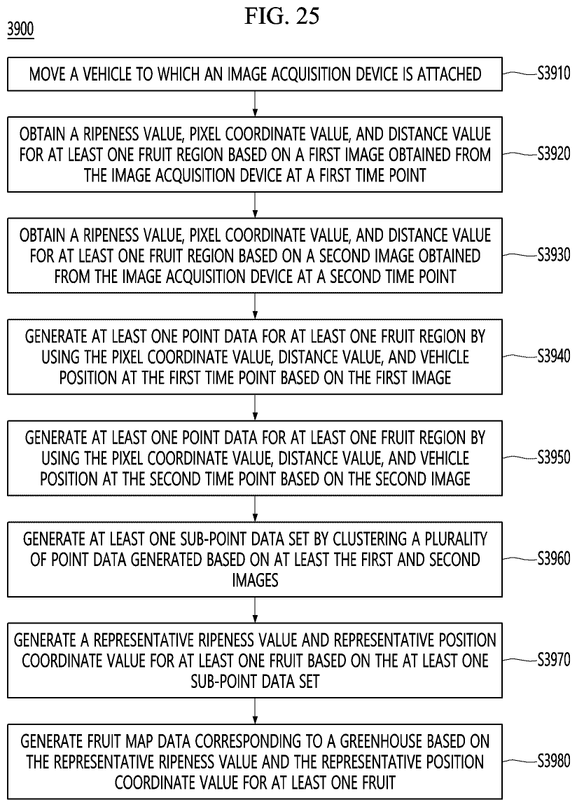

FIG. 25 is a view illustrating a fruit map generation method according to one exemplary embodiment.

Referring to FIG. 25, the fruit map generation method 3900 according to one exemplary embodiment may include: step S3910 of moving a vehicle to which an image acquisition device is attached; step S3920 of obtaining ripeness values, pixel coordinate values, and distance values for at least one fruit region on the basis of a first image obtained from the image acquisition device at a first time point; step S3930 of obtaining ripeness values, pixel coordinate values, and distance values for at least one fruit region on the basis of a second image obtained from the image acquisition device at a second time point; step S3940 of generating at least one piece of point data on the basis of the pixel coordinate values, the distance values, and a vehicle position at the first time point for the at least one fruit region obtained on the basis of the first image; step S3950 of generating at least one piece of point data on the basis of the pixel coordinate values, the distance values, and a vehicle position at the second time point for the at least one fruit region obtained on the basis of the second image; step S3960 of generating at least one sub-point data set by clustering a plurality of point data generated on the basis of at least the first and second images; step S3970 of generating representative ripeness values and representative position coordinate values for the at least one fruit on the basis of at least one sub-point data set; and step S3080 of generating a fruit map corresponding to a greenhouse on the basis of the representative ripeness values and the representative position coordinate values for the at least one fruit. Since the content described with reference to FIGS. 14 to 19 may be applied to this, redundant descriptions will be omitted.

The above-described content may be applied to the step S3920 of obtaining the ripeness values, the pixel coordinate values, and the distance values for the at least one fruit region on the basis of the first image obtained from the image acquisition device at the first time point according to one exemplary embodiment, so redundant descriptions will be omitted.

In the step S3920 of obtaining the ripeness values, the pixel coordinate values, and the distance values for the at least one fruit region on the basis of the first image obtained from the image acquisition device at the first time point according to one exemplary embodiment, ripeness values for a plurality of fruit regions may be obtained.

For example, in a case where there is a plurality of fruits in a crop plant appearing in the first image, or in a case where there is a plurality of fruits in a plurality of crop plants appearing in the first image, a plurality of ripeness values for a plurality of fruit regions may be obtained, but is not limited thereto.

In addition, for example, in the step S3920 of obtaining the ripeness values, the pixel coordinate values, and the distance values for the at least one fruit region on the basis of the first image obtained from the image acquisition device at the first time point according to one exemplary embodiment, a first ripeness value for a first fruit region and a second ripeness value for a second fruit region may be obtained, but it is not limited thereto.

In addition, since the obtaining of the ripeness values for the at least one fruit region may be applied to the content described through FIGS. 23 and 24, redundant descriptions will be omitted.

In addition, since the above-described content may be applied to the step S3930 of obtaining the ripeness values, the pixel coordinate values, and the distance values for the at least one fruit region on the basis of the second image obtained from the image acquisition device at the second time point according to one exemplary embodiment, redundant descriptions will be omitted.

In addition, in the step S3930 of obtaining the ripeness values, the pixel coordinate values, and the distance values for the at least one fruit region on the basis of the second image obtained from the image acquisition device at the second time point according to one exemplary embodiment, ripeness values for a plurality of fruit regions may be obtained.

For example, in a case there is a plurality of fruits in a crop plant appearing in the second image, or in a case where there is a plurality of fruits in a plurality of crop plants appearing in the second image, a plurality of ripeness values for the plurality of fruit regions may be obtained, but the present disclosure is not limited thereto.

In addition, for example, in the step S3930 of obtaining the ripeness values, the pixel coordinate values, and the distance values for the at least one fruit region on the basis of the second image obtained from the image acquisition device at the second time point according to one exemplary embodiment, a third ripeness value for a third fruit region and a fourth ripeness value for a fourth fruit region may be obtained, but it is not limited thereto.

In addition, since the obtaining of the ripeness values for the at least one fruit region may be applied to the content described through FIGS. 23 and 24, redundant descriptions will be omitted.

In addition, according to one exemplary embodiment, in addition to the above-described position coordinate values, corresponding ripeness values may be further included in the at least one piece of point data obtained in the step S3940 of generating the at least one piece of point data on the basis of the pixel coordinate values, the distance values, and the vehicle position at the first time point for the at least one fruit region obtained on the basis of the first image and in the step S3950 of generating the at least one piece of point data on the basis of the pixel coordinate values, the distance values, and the vehicle position at the second time point for the at least one fruit region obtained on the basis of the second image.

In addition, the step S3970 of generating the representative ripeness values and the representative position coordinate values for the at least one fruit on the basis of the at least one sub-point data set according to one exemplary embodiment may include a step of generating a plurality of representative ripeness values for a plurality of fruits on the basis of a plurality of sub-point data sets.

For example, the step S3970 of generating the representative ripeness values and the representative position coordinate values for the at least one fruit on the basis of the at least one sub-point data set according to one exemplary embodiment may include, but is not limited to, a step of generating a first representative ripeness value for a first fruit on the basis of a first sub-point data set and generating a second representative ripeness value for a second fruit on the basis of a second sub-point data set.

In addition, in the step S3970 of generating the representative ripeness values and the representative position coordinate values for the at least one fruit on the basis of the at least one sub-point data set according to one exemplary embodiment, various algorithms may be used to generate the representative ripeness values for the at least one fruit.

This will be described in more detail below.

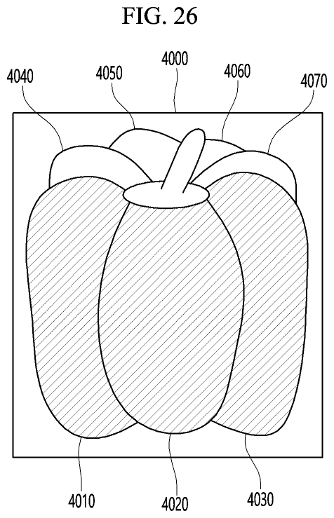

FIG. 26 is a view illustrating a situation in which a problem may occur in obtaining a ripeness value for a single fruit.

Before describing FIG. 26, to briefly describe a conventional technique of obtaining a ripeness value, the conventional technique of obtaining the ripeness value may be a technique of obtaining the ripeness value by analyzing an image of one side of a single fruit.

For example, similar to a technique of obtaining a ripeness value by obtaining an image of one side of a tomato and using the number of pixels each having a pixel value corresponding to red in the obtained image in order to obtain the ripeness value of the tomato, the conventional technique of obtaining a ripeness value may be a technique of obtaining the ripeness value by utilizing the degree of distribution of color values (e.g., RGB values) included within an image of one side of a single fruit.

The problems that may arise in the above-described related art will be described in more detail below.

FIG. 26 is a view illustrating a fruit image for one fruit obtained according to one exemplary embodiment.

Referring to FIG. 26, the fruit image 4000 illustrated in FIG. 26 is shown by depicting a fruit image corresponding to a paprika among fruits, and a region colored in a diagonal stripe shape corresponds to a color (e.g., red) of the paprika when it is ripe, and a region colored in white corresponds to the original color (e.g., green) of the paprika before it is ripe. However, this is only an example for convenience of description, and it is natural that it may be applied to other fruits as well as paprika.

In this case, in a case of determining the level of ripeness from the fruit image 4000 in FIG. 26, the fruit image 4000 may be evaluated as “ripeness”.

To be specific, in the fruit image 4000, a first region 4010, a second region 4020, and a third region 4030 are shown in the color of a ripeness state, and a fourth region 4040, a fifth region 4050, a sixth region 4060, and a seventh region 4070 are shown in a color of an unripeness state. Since the first region 4010, the second region 4020, and the third region 4030 occupy a significant portion of the fruit image 4000, the level of ripeness may be obtained as a value corresponding to “ripeness”.

However, as shown in FIG. 26, an actual fruit corresponding to the fruit image 4000 may have an unripe portion, which is also shown in the fourth region 4040, the fifth region 4050, the sixth region 2060, and the seventh region 4070.

As a result, when ripeness is determined by using a fruit image, in obtaining a ripeness value by using the fruit image representing one side of a fruit, there is a high possibility that an incorrect value different from an actual ripeness value may be obtained in a case where the level of ripeness of the target fruit is not uniform.

In addition, in a greenhouse, since various stages of fruits may be grown depending on various environmental conditions such as the degree of sunlight received and the degree of sunlight blocked depending on regions where the fruits are grown, the problem of incorrectly obtaining ripeness values for the fruits causes not only a major problem in accurately monitoring the states of fruits in the greenhouse as a whole, but also a major problem in making predictions, such as predicting the yield or harvest time.

Accordingly, there is a need for development of technology capable of solving the problems described above, and the content of this subject matter will be described in more detail below in the present specification.

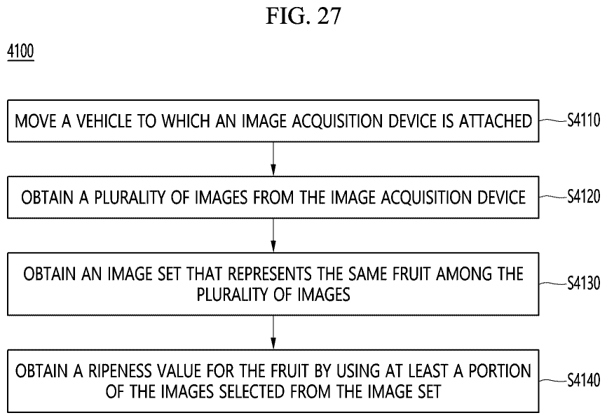

FIG. 27 is a view illustrating a method of obtaining ripeness values for at least one fruit located in a greenhouse according to one exemplary embodiment.

Referring to FIG. 27, the method of obtaining ripeness values for at least one fruit located in a greenhouse according to one exemplary embodiment may include: step S4110 of moving a vehicle to which an image acquisition device is attached; step S4120 of obtaining a plurality of images from the image acquisition device; step S4130 of obtaining an image set representing the same fruit from among the plurality of images; and step S4140 of obtaining a ripeness value for the fruit by using at least some images selected from the image set.

In this case, according to one exemplary embodiment, at least some of the steps described above may be omitted.

For example, the method of obtaining the ripeness values for the at least one fruit located in the greenhouse according to one exemplary embodiment may include, but is not limited to: the step of obtaining the plurality of images from the image acquisition device; the step of obtaining the image set representing the same fruit from among the plurality of images; and the step of obtaining the ripeness value for the fruit by using the at least some images selected from the image set.

Since the above-described content may be applied to the step S4110 of moving the vehicle to which the image acquisition device is attached according to one exemplary embodiment, redundant descriptions will be omitted.

In addition, in the step S4110 of moving the vehicle to which the image acquisition device is attached according to one exemplary embodiment, the vehicle to which the image acquisition device is attached may be moved at least along a predetermined path.

In this case, the predetermined path may be determined by the positions of a plurality of crop plants or trees that include fruits.

For example, in a case where the plurality of crop plants is arranged along a plurality of rows, a predetermined path may be determined between the plurality of rows, but is not limited thereto.

In the step S4120 of obtaining the plurality of images from the image acquisition device according to one exemplary embodiment, the vehicle to which the image acquisition device is attached moves and obtains images of the plurality of crop plants, and the plurality of images may be images captured at positions substantially different from each other.

In this case, each of the plurality of images may include position information corresponding thereto or may be stored in a manner of being matched with position information corresponding thereto.

For example, each of the plurality of images may be stored in the manner of being matched with position information of the vehicle to which the image acquisition device is attached at a time point when each of the plurality of images is captured, but is not limited thereto.

In addition, in the step S4120 of obtaining the plurality of images from the image acquisition device according to one exemplary embodiment, at least some of the plurality of images may include image regions representing the same fruit.

For example, the number of images including an image region representing the specific fruit may be theoretically calculated to be approximately 300 (10 sec*30 frames/see=300 frames) under the conditions including: i) the angle of view of the image acquisition device is 90 degrees; ii) the center line of the angle of view of the image acquisition device is arranged to be perpendicular to a movement path of the vehicle to which the image acquisition device is attached; iii) a distance from the movement path of the vehicle to which the image acquisition device is attached to a specific fruit is 0.5 m; iv) the speed of the vehicle to which the image acquisition device is attached is 1 m/s; and v) the frame rate of the image acquisition device is 30 FPS (frame per second).

That is, 300 images, which are at least some of the plurality of images, may be images including the image regions representing the same specific fruit.

Accordingly, the step S4130 of obtaining the image set representing the same fruit from among the plurality of images according to one exemplary embodiment may be implemented.

In the step S4130 of obtaining the image set representing the same fruit from among the plurality of images according to one exemplary embodiment, the obtaining of the image set representing the same fruit will be described in more detail below by using other drawings.

The step S4130 of obtaining the image set representing the same fruit from among the plurality of images according to one exemplary embodiment may include obtaining a plurality of image set respectively representing a plurality of specific fruits.

For example, the step S4130 of obtaining the image set representing the same fruit from among the plurality of images according to one exemplary embodiment may include obtaining a first image set representing a first fruit, a second image set representing a second fruit, and an N-th image set representing an N-th fruit.

In this case, the number of images included in each of the plurality of image sets respectively representing the plurality of specific fruits may not be constant.

For example, the number of images included in each of the plurality of image sets respectively representing the plurality of specific fruits may not be constant depending on various situations, such as respective positions of the plurality of specific fruits are different from each other or leaves obscure the view during a process of obtaining the images.

Accordingly, considering the objectives to be achieved by the method of obtaining the ripeness value of each fruit according to one exemplary embodiment of the present application, it is required that images including an image region representing the same fruit or images representing the same fruit should be selected more precisely.

For example, it may be preferable for an image representing one fruit to be determined as an image captured in a state where the one fruit captured in the image is not blocked from view by other fruits or leaves, but this is not limited thereto.

In addition, for example, a predetermined standard for the degree of obscuration may be established for a case where one fruit captured in an image representing one fruit is captured while being blocked from view by other fruits or leaves, so that the image may be determined as an image representing the one fruit in a case where the image satisfies the predetermined standard, and the image may be determined as an image not representing the one fruit in a case where the image does not satisfy the predetermined standard.

As described above, after performing the step S4130 of obtaining the image set representing the same fruit, images used to obtain ripeness values among the plurality of images included in the image set may be further selected.

In addition, as described above, when a specific situation is assumed, the number of images representing the same fruit may be around 300. In order to solve the conventional problem in determining the ripeness of a fruit, when a plurality of images is used instead of using one image, excessive computing may be required if all the 300 fruit images are used, and thus such a method is not preferable. Accordingly, it is preferable to select more images to be used for determining ripeness among the plurality of images.

In addition, in order to select images to be used for determining ripeness among images representing the same fruit, images representing various sides of the same fruit are required to be selected, so in order to achieve the above-described objectives, the images to be used for determining the ripeness among the images representing the same fruit may be selected according to various standards.

In the step S4140 of obtaining the ripeness value for the fruit by using the at least some images selected from the image set according to one exemplary embodiment, the at least some images selected from the image set may be selected on the basis of position information of the vehicle to which the image acquisition device is attached.

In addition, in the step S4140 of obtaining the ripeness value for the fruit by using the at least some images selected from the image set according to one exemplary embodiment, the at least some images selected from the image set may be selected on the basis of position information corresponding to each of the images.

In addition, in the step S4140 of obtaining the ripeness value for the fruit by using the at least some images selected from the image set according to one exemplary embodiment, the at least some images selected from the image set may be selected on the basis of view point information corresponding to each of the images.

In addition, in the step S4140 of obtaining the ripeness value for the fruit by using the at least some images selected from the image set according to one exemplary embodiment, the at least some images selected from the image set may be selected on the basis of analysis for each of the images.

In addition, in the step S4140 of obtaining the ripeness value for the fruit by using the at least some images selected from the image set according to one exemplary embodiment, various standards for selecting the at least some images selected from the image set will be described in more detail below by using other drawings.

In addition, in the step S4140 of obtaining the ripeness value for the fruit by using the at least some images selected from the image set according to one exemplary embodiment, the obtaining of the ripeness value for the fruit by using the at least some images will be described in more detail below by using other drawings as well.

The step S4130 of obtaining the image set representing the same fruit from among the plurality of images described above and the step S4140 of obtaining the ripeness value for the fruit by using the at least some images selected from the image set have been described as two separated steps for convenience of description. However, according to one exemplary embodiment of the present application, the step S4130 of obtaining the image set representing the same fruit from among the plurality of images described above and the step S4140 of obtaining the ripeness value for the fruit by using the at least some images selected from the image set may be understood as one step.

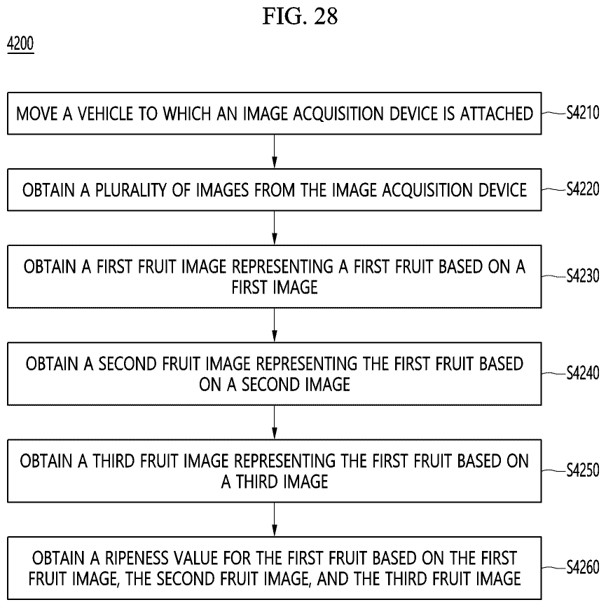

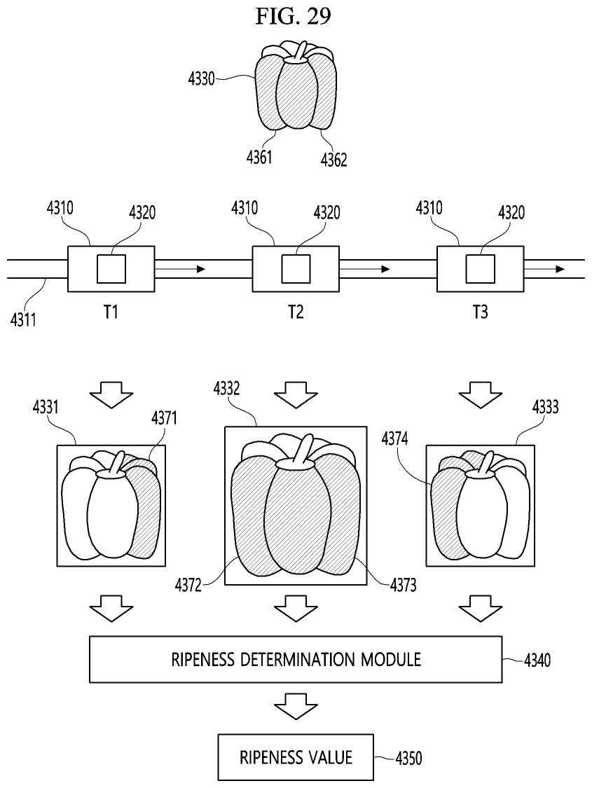

FIGS. 28 and 29 are views illustrating a method of obtaining ripeness values for at least one fruit located in a greenhouse according to one exemplary embodiment.

More specifically, FIG. 28 is a flowchart illustrating a method of obtaining ripeness values for at least one fruit located in a greenhouse according to one exemplary embodiment, and FIG. 29 is a view illustrating the method of obtaining the ripeness value according to FIG. 28 for the convenience of understanding.

Referring to FIG. 28, the method 4200 of obtaining ripeness values for at least one fruit located in a greenhouse according to one exemplary embodiment may include: step S4210 of moving a vehicle to which an image acquisition device is attached; step S4220 of obtaining a plurality of images from the image acquisition device; step S4230 of obtaining a first fruit image representing a first fruit on the basis of a first image; step S4240 of obtaining a second fruit image representing the first fruit on the basis of a second image; step S4250 of obtaining a third fruit image representing the first fruit on the basis of a third image; and step S4260 of obtaining a ripeness value for the first fruit on the basis of the first fruit image, the second fruit image, and the third fruit image.

In this case, according to one exemplary embodiment, at least some of the steps described above may be omitted.

For example, the method of obtaining the ripeness values for the at least one fruit located in the greenhouse according to one exemplary embodiment may include, but is not limited to: a step of obtaining a first fruit image representing a first fruit on the basis of a first image; a step of obtaining a second fruit image representing the first fruit on the basis of a second image; a step of obtaining a third fruit image representing the first fruit on the basis of a third image; and a step of obtaining a ripeness value for the first fruit on the basis of the first fruit image, the second fruit image, and the third fruit image.

For the step S4210 of moving the vehicle to which the image acquisition device is attached according to one exemplary embodiment, the content described may be applied for the step of moving the vehicle to which the image acquisition device is attached described above, so redundant descriptions will be omitted.

In this case, referring to FIG. 29, the vehicle 4310 to which the image acquisition device 4320 is attached according to one exemplary embodiment may move along a pre-installed rail 4311.

For example, the vehicle 4310 to which the image acquisition device 4320 is attached according to one exemplary embodiment may move along the pre-installed rail 4311 and be positioned at a first position at a first time point T1, at a second position at a second time point T2, and at a third position at a third time point T3.

The above-described content may be applied to the step S4220 of obtaining the plurality of images from the image acquisition device according to one exemplary embodiment, so redundant descriptions will be omitted.

In addition, the step S4220 of obtaining the plurality of images from the image acquisition device according to one exemplary embodiment may include a step of obtaining an image of a crop plant including at least one fruit from the image acquisition device.

For example, the step S4220 of obtaining the plurality of images from the image acquisition device according to one exemplary embodiment may include a step of obtaining a plurality of images for a crop plant including a first fruit 4330.

In this case, only the first fruit 4330 is illustrated in FIG. 29 for convenience of description, but in the image obtained from the image acquisition device according to one exemplary embodiment, other fruits, crop plants, or the like located in the greenhouse can be illustrated in addition to the first fruit 4330.

In the step S4230 of obtaining the first fruit image representing the first fruit on the basis of the first image according to one exemplary embodiment, the first image may be an image captured from the image acquisition device at a specific time point.

For example, referring to FIG. 29, in the step S4230 of obtaining the first fruit image representing the first fruit on the basis of the first image according to one exemplary embodiment, the first image may be an image captured from the image acquisition device at the first time point T1.

In addition, for example, in the step S4230 of obtaining the first fruit image representing the first fruit on the basis of the first image according to one exemplary embodiment, the first image may include an image captured from the image acquisition device at the first time point T1 and obtained from a server after the first time point, but is not limited thereto.

In addition, in the step S4230 of obtaining the first fruit image representing the first fruit on the basis of the first image according to one exemplary embodiment, the first image may be an image captured from the image acquisition device when the image acquisition device is at a specific position.

For example, in the step S4230 of obtaining the first fruit image representing the first fruit on the basis of the first image according to one exemplary embodiment, the first image may be an image captured from the image acquisition device when the image acquisition device is at a first position, but is not limited thereto.

In this case, referring to FIG. 29, it may be understood that the image acquisition device 4320 being in the first position means that the vehicle 4310 to which the image acquisition device 4320 is attached is in the first position, but is not limited thereto.

Referring to FIG. 29, the first position of the vehicle 4310 to which the image acquisition device 4320 is attached according to one exemplary embodiment may mean a position spaced apart in the opposite direction of a movement direction of the vehicle 4310 relative to the first fruit 4330 located in the greenhouse, but is not limited thereto.

In addition, in this case, referring to FIG. 29, the first position of the vehicle 4310 to which the image acquisition device 4320 is attached according to one exemplary embodiment may mean a position where the first image expressing the first fruit 4330 located in the greenhouse is obtained, but is not limited thereto.

In addition, in this case, referring to FIG. 29, the first position of the vehicle 4310 to which the image acquisition device 4320 is attached according to one exemplary embodiment may mean a position at which an image expressing a first side of the first fruit 4330 is obtained, but is not limited thereto.

In addition, in this case, referring to FIG. 29, the first position of the vehicle 4310 to which the image acquisition device 4320 is attached according to one exemplary embodiment may mean a position where the first fruit 4330 is included within the field of view of the image acquisition device 4320, but the first fruit 4330 is expressed at a position spaced apart along the movement direction of the vehicle 4310 on the basis of the center of the field of view of the image acquisition device 4320, but is not limited thereto.

In addition, in this case, referring to FIG. 29, the first position of the vehicle 4310 to which the image acquisition device 4320 is attached according to one exemplary embodiment may mean a position where an angle formed by a virtual line passing through the center of the image acquisition device 4320 in a direction perpendicular to the movement direction of the vehicle 4310 and a virtual line passing through both the center of the image acquisition device 4320 and the center of the first fruit 4330 is included within a first angle range.

For example, the first position of the vehicle 4310 to which the image acquisition device 4320 is attached according to one exemplary embodiment may mean a position where the angle formed by the virtual line passing through the center of the image acquisition device 4320 in the direction perpendicular to the movement direction of the vehicle 4310 and the virtual line passing through both the center of the image acquisition device 4320 and the center of the first fruit 4330 is within a range of 30 to 45 degrees, but is not limited thereto.

In addition, in this case, referring to FIG. 29, the first position of the vehicle 4310 to which the image acquisition device 4320 is attached according to one exemplary embodiment may mean a position where the vehicle 4310 is located in a direction of a starting point of a fruit row on the basis of the first fruit 4330, but is not limited thereto.

In this case, the starting point of the fruit row may mean a position where the vehicle 4310 to which the image acquisition device 4320 is attached according to one exemplary embodiment enters the fruit row.

In addition, in this case, referring to FIG. 29, the first position of the vehicle 4310 to which the image acquisition device 4320 is attached according to one exemplary embodiment may be a position of the vehicle 4310 to which the image acquisition device 4320 is attached according to one exemplary embodiment at the first time point T1, but is not limited thereto.

In addition, in the step S4230 of obtaining the first fruit image representing the first fruit on the basis of the first image according to one exemplary embodiment, the first image may be an image expressing at least one crop plant located in the greenhouse.

For example, in the step S4230 of obtaining the first fruit image representing the first fruit on the basis of the first image according to one exemplary embodiment, the first image may be an image expressing at least one crop plant including the first fruit 4330 located in the greenhouse, but is not limited thereto.

In addition, in the step S4230 of obtaining the first fruit image representing the first fruit on the basis of the first image according to one exemplary embodiment, the first fruit image may be an image representing a first side of the first fruit.

For example, referring to FIG. 29, the first fruit image 4331 according to one exemplary embodiment is an image representing the first side of the first fruit 4330, and may be an image in which a region having a color corresponding to the ripeness of the first fruit 4330 is expressed on the right and upper right, but is not limited thereto.

In addition, in the step S4230 of obtaining the first fruit image representing the first fruit on the basis of the first image according to one exemplary embodiment, the first fruit image 4331 may be an image having a first size when referring to FIG. 29.

In this case, the first size may be defined by a height and width of the first fruit image 4331, but is not limited thereto.

In addition, the step S4230 of obtaining the first fruit image representing the first fruit on the basis of the first image according to one exemplary embodiment may include a step of obtaining pixel coordinate values for at least one fruit region, depth values for the at least one fruit region, and crop plant image data for the at least one fruit region on the basis of the first image.

In this case, the first fruit image may mean crop plant image data for the first fruit region among the at least one fruit region, but is not limited thereto.

In addition, in this case, the operations of the fruit detection module described through FIG. 2 may be applied to the step S4230 of obtaining the first fruit image representing the first fruit on the basis of the first image according to one exemplary embodiment, so redundant descriptions will be omitted.

In the step S4240 of obtaining the second fruit image representing the first fruit on the basis of the second image according to one exemplary embodiment, the second image may be an image captured from the image acquisition device at a specific time point.

For example, referring to FIG. 29, in the step S4240 of obtaining the second fruit image representing the first fruit on the basis of the second image according to one exemplary embodiment, the second image may be an image captured from the image acquisition device at a second time point T2.

In addition, for example, in the step S4240 of obtaining the second fruit image representing the first fruit on the basis of the second image according to one exemplary embodiment, the second image may include an image captured from the image acquisition device at the second time point and obtained from a server after the second time point, but is not limited thereto.

In addition, in the step S4240 of obtaining the second fruit image representing the first fruit on the basis of the second image according to one exemplary embodiment, the second image may be an image captured from the image acquisition device when the image acquisition device is at a specific position.

For example, in the step S4240 of obtaining the second fruit image representing the first fruit on the basis of the second image according to one exemplary embodiment, the second image may be an image captured from the image acquisition device when the image acquisition device is at a second position, but is not limited thereto.

In this case, referring to FIG. 29, it may be understood that the image acquisition device 4320 being in the second position means that the vehicle 4310 to which the image acquisition device 4320 is attached is in the second position, but is not limited thereto.

Referring to FIG. 28, the second position of the vehicle 4310 to which the image acquisition device 4320 is attached according to one exemplary embodiment may mean, but is not limited to, a position at which an N-th image expressing the first fruit 4330 located in the greenhouse is obtained.

In this case, the N-th image may be an image obtained after obtaining the first image in which the first fruit 4330 is expressed.

In addition, in this case, referring to FIG. 28, the second position of the vehicle 4310 to which the image acquisition device 4320 is attached according to one exemplary embodiment may mean a position for obtaining an image expressing a second side of the first fruit 4330, but is not limited thereto.

In this case, the second side of the first fruit 4330 may be a different side from the first side of the first fruit 4330.

In addition, in this case, referring to FIG. 28, the second position of the vehicle 4310 to which the image acquisition device 4320 is attached according to one exemplary embodiment may mean, but is not limited to, a position of the vehicle 4310 in which the first fruit 4330 is included within the field of view of the image acquisition device 4320, and the first fruit 4330 is located in the center region of the horizontal field of view of the image acquisition device 4320.

In addition, in this case, referring to FIG. 28, the second position of the vehicle 4310 to which the image acquisition device 4320 is attached according to one exemplary embodiment may mean a position where an angle formed by a virtual line passing through the center of the image acquisition device 4320 in a direction perpendicular to a movement direction of the vehicle 4310 and a virtual line passing through both the center of the image acquisition device 4320 and the center of the first fruit 4330 is included within a second angle range.

In this case, the second angle range may be a range that includes angles smaller than the angles included in the first angle range.

For example, the second position of the vehicle 4310 to which the image acquisition device 4320 is attached according to one exemplary embodiment may mean a position where an angle formed by a virtual line passing through the center of the image acquisition device 4320 in the direction perpendicular to the movement direction of the vehicle 4310 and a virtual line passing through both the center of the image acquisition device 4320 and the center of the first fruit 4330 is within a range of 0 to 30 degrees, but is not limited thereto.

In addition, in this case, referring to FIG. 29, the second position of the vehicle 4310 to which the image acquisition device 4320 is attached according to one exemplary embodiment may be a position of the vehicle 4310 to which the image acquisition device 4320 is attached according to one exemplary embodiment at a second time point T2, but is not limited thereto.

In addition, in the step S4240 of obtaining the second fruit image representing the first fruit on the basis of the second image according to one exemplary embodiment, the second image may be an image expressing at least one crop plant located in the greenhouse.

For example, in the step S4240 of obtaining the second fruit image representing the first fruit on the basis of the second image according to one exemplary embodiment, the second image may be an image expressing the at least one crop plant including the first fruit 4330 located in the greenhouse, but is not limited thereto.

In addition, in the step S4240 of obtaining the second fruit image representing the first fruit on the basis of the second image according to one exemplary embodiment, the second fruit image may be an image representing the second side of the first fruit.

For example, referring to FIG. 28, the second fruit image 4332 according to one exemplary embodiment is an image representing the second side of the first fruit 4330, and may be an image in which a region having a color corresponding to ripeness of the first fruit 4330 is expressed on a front side, but is not limited thereto.

In addition, in the step S4240 of obtaining the second fruit image representing the first fruit on the basis of the second image according to one exemplary embodiment, the second fruit image 4332 may be an image having a second size when referring to FIG. 28.

In this case, the second size may be defined by a height and width of the second fruit image 4332, but is not limited thereto.

In addition, in this case, the second size may be larger than the first size.

For example, the second size, which is the size of the second fruit image 4332 obtained on the basis of the second image obtained when the vehicle 4310 is located at the position where the angle formed by the virtual line passing through the center of the image acquisition device 4320 in the direction perpendicular to the movement direction of the vehicle 4310 and the virtual line passing through both the center of the image acquisition device 4320 and the center of the first fruit 4330 is included within the second angle range, may be larger than the first size, which is the size of the first fruit image 4331 obtained on the basis of the first image obtained when the vehicle 4310 is located at the position where the angle formed by the virtual line passing through the center of the image acquisition device 4320 in the direction perpendicular to the movement direction of the vehicle 4310 and the virtual line passing through both the center of the image acquisition device 4320 and the center of the first fruit 4330 is included within the first angle range in this case, the first angle range includes angles greater than the angles included in the second angle range, but is not limited thereto.

In addition, the step S4240 of obtaining the second fruit image representing the first fruit on the basis of the second image according to one exemplary embodiment may include a step of obtaining pixel coordinate values for at least one fruit region, depth values for the at least one fruit region, and crop plant image data for the at least one fruit region on the basis of the second image.

In this case, the second fruit image may mean crop plant image data for the second fruit region within the at least one fruit region, but is not limited thereto.

In addition, in this case, the operations of the fruit detection module described through FIG. 2 may be applied to the step S4240 of obtaining the second fruit image representing the first fruit on the basis of the second image according to one exemplary embodiment, so redundant descriptions will be omitted.

In the step S4250 of obtaining the third fruit image representing the first fruit on the basis of the third image according to one exemplary embodiment, the third image may be an image captured from the image acquisition device at a specific time point.

For example, referring to FIG. 29, in the step S4250 of obtaining the third fruit image representing the first fruit on the basis of the third image according to one exemplary embodiment, the third image may be an image captured from the image acquisition device at a third time point T3.

In addition, for example, in the step S4250 of obtaining the third fruit image representing the first fruit on the basis of the third image according to one exemplary embodiment, the third image may include an image captured from the image acquisition device at the third time point and obtained from the server after the third time point, but is not limited thereto.

In addition, in the step S4250 of obtaining the third fruit image representing the first fruit on the basis of the third image according to one exemplary embodiment, the third image may be an image captured from the image acquisition device at a specific position.

For example, in the step S4250 of obtaining the third fruit image representing the first fruit on the basis of the third image according to one exemplary embodiment, the third image may be an image captured from the image acquisition device when the image acquisition device is at a third position, but is not limited thereto.

In this case, referring to FIG. 29, it may be understood that the image acquisition device 4320 being in the third position means that the vehicle 4310 to which the image acquisition device 4320 is attached is at the third position, but is not limited thereto.

Referring to FIG. 28, the third position of the vehicle 4310 to which the image acquisition device 4320 is attached according to one exemplary embodiment may mean a position spaced apart in the movement direction of the vehicle 4310 relative to the first fruit 4330 located in the greenhouse, but is not limited thereto.

In addition, in this case, referring to FIG. 28, the third position of the vehicle 4310 to which the image acquisition device 4320 is attached according to one exemplary embodiment may mean a position where the last image expressing the first fruit 4330 located in the greenhouse is obtained, but is not limited thereto.

In addition, in this case, referring to FIG. 28, the third position of the vehicle 4310 to which the image acquisition device 4320 is attached according to one exemplary embodiment may mean a position for obtaining an image expressing a third side of the first fruit 4330, but is not limited thereto.

In this case, the third side of the first fruit 4330 may be a different side from the first side of the first fruit 4330 and the second side of the first fruit 4330.

In addition, in this case, referring to FIG. 28, the third position of the vehicle 4310 to which the image acquisition device 4320 is attached according to one exemplary embodiment may mean a position where the first fruit 4330 is included within the field of view of the image acquisition device 4320, and the first fruit 4330 is expressed at a position spaced apart along the opposite direction of the movement direction of the vehicle 4310 on the basis of the center of the field of view of the image acquisition device 4320, but is not limited thereto.

In addition, in this case, referring to FIG. 28, the third position of the vehicle 4310 to which the image acquisition device 4320 is attached according to one exemplary embodiment may mean a position where an angle formed by a virtual line passing through the center of the image acquisition device 4320 in the direction perpendicular to the movement direction of the vehicle 4310 and a virtual line passing through both the center of the image acquisition device 4320 and the center of the first fruit 4330 is included within a third angle range.

In this case, the third angle range may be a range that includes angles greater than the angles included in the second angle range.

In addition, in this case, the third angle range may be the same angle range as the first angle range, but is not limited thereto.

For example, the third position of the vehicle 4310 to which the image acquisition device 4320 is attached according to one exemplary embodiment may mean a position where an angle formed by a virtual line passing through the center of the image acquisition device 4320 in the direction perpendicular to the movement direction of the vehicle 4310 and a virtual line passing through both the center of the image acquisition device 4320 and the center of the first fruit 4330 is within a range of 30 to 45 degrees, but is not limited thereto.

In addition, in this case, referring to FIG. 28, the third position of the vehicle 4310 to which the image acquisition device 4320 is attached according to one exemplary embodiment may mean a position where the vehicle 4310 is located in a direction of an ending point of the fruit row on the basis of the first fruit 4330, but is not limited thereto.

In this case, the ending point of the fruit row may mean a position where the vehicle 4310 to which the image acquisition device 4320 is attached according to one exemplary embodiment moves along the movement direction so as to advance or turn around relative to the fruit row.

In addition, in this case, referring to FIG. 29, the third position of the vehicle 4310 to which the image acquisition device 4320 is attached according to one exemplary embodiment may be a position of the vehicle 4310 to which the image acquisition device 4320 is attached according to one exemplary embodiment at a third time point T3, but is not limited thereto.

In addition, in the step S4250 of obtaining the third fruit image representing the first fruit on the basis of the third image according to one exemplary embodiment, the third image may be an image expressing at least one crop plant located in the greenhouse.

For example, in the step S4230 of obtaining the third fruit image representing the first fruit on the basis of the third image according to one exemplary embodiment, the third image may be an image expressing at least one crop plant including the first fruit 4330 located in the greenhouse, but is not limited thereto.

In addition, in the step S4250 of obtaining the third fruit image representing the first fruit on the basis of the third image according to one exemplary embodiment, the third fruit image may be an image representing the third side of the first fruit.

For example, referring to FIG. 28, the third fruit image 4333 according to one exemplary embodiment is an image representing the third side of the first fruit 4330, and may be an image in which a region having a color corresponding to ripeness of the first fruit 4330 is expressed on the left and upper left, but is not limited thereto.

In addition, in the step S4250 of obtaining the third fruit image representing the first fruit on the basis of the third image according to one exemplary embodiment, the third fruit image 4333 may be an image having a third size when referring to FIG. 28.

In this case, the third size may be defined by a height and width of the third fruit image 4333, but is not limited thereto.

In addition, in this case, the third size may be smaller than the first size.

For example, the third size, which is the size of the third fruit image 4333 obtained on the basis of the third image obtained when the vehicle 4310 is located at a position where the angle formed by the virtual line passing through the center of the image acquisition device 4320 in the direction perpendicular to the movement direction of the vehicle 4310 and the virtual line passing through both the center of the image acquisition device 4320 and the center of the first fruit 4330 is included within the third angle range, may be smaller than the second size, which is the size of the second fruit image 4332 obtained on the basis of the second image obtained when the vehicle 4310 is located at the position where the angle formed by the virtual line passing through the center of the image acquisition device 4320 in the direction perpendicular to the movement direction of the vehicle 4310 and the virtual line passing through both the center of the image acquisition device 4320 and the center of the first fruit 4330 is included within the second angle range (i.e., in this case, the second angle range includes angles smaller than the angles included in the third angle range), but is not limited thereto.

In addition, the step S4250 of obtaining the third fruit image representing the first fruit on the basis of the third image according to one exemplary embodiment may include a step of obtaining pixel coordinate values for at least one fruit region, depth values for the at least one fruit region, and crop plant image data for the at least one fruit region on the basis of the third image.

In this case, the third fruit image may mean crop plant image data for the third fruit region within the at least one fruit region, but is not limited thereto.

In addition, in this case, the operations of the fruit detection module described through FIG. 2 may be applied to the step S4250 of obtaining the third fruit image representing the first fruit on the basis of the third image according to one exemplary embodiment, so redundant descriptions will be omitted.

In addition, in the steps S4230 to S4250 of obtaining the first to third fruit images according to one exemplary embodiment, the same part of the first fruit 4330 may be expressed at positions different from each other in the first fruit image 4331 representing the first side of the first fruit 4330 and the second fruit image 4332 representing the second side of the first fruit 4330.

For example, in the first fruit image 4331 representing the first side of the first fruit 4330, a first part 4361 of the first fruit 4330 may be expressed in a first region 4371, and in a second fruit image 4332 representing the second side of the first fruit 4330, the first part 4361 of the first fruit 4330 may be expressed in a second region 4372, but is not limited thereto.

In addition, in the steps S4230 to S4250 of obtaining the first to third fruit images according to one exemplary embodiment, the same part of the first fruit 4330 may be expressed at positions different from each other in the second fruit image 4332 representing the second side of the first fruit 4330 and the third fruit image 4333 representing the third side of the first fruit 4330.

For example, in the second fruit image 4332 representing the second side of the first fruit 4330, the second part 4362 of the first fruit 4330 may be expressed in a third region 4373, and in the third fruit image 4333 representing the third side of the first fruit 4330, the second part 4362 of the first fruit 4330 may be expressed in a fourth region 4374, but is not limited thereto.

In addition, in the steps S4230 to S4250 of obtaining the first to third fruit images according to one exemplary embodiment, different parts of the first fruit 4330 may be expressed in the first fruit image 4331 representing the first side of the first fruit 4330 and the third fruit image 4333 representing the third side of the first fruit 4330.

In the step S4260 of obtaining the ripeness value for the first fruit on the basis of the first fruit image, the second fruit image, and the third fruit image according to one exemplary embodiment, at least one ripeness determination module may be used.

For example, as illustrated in FIG. 28, in the step S4260 of obtaining the ripeness value for the first fruit on the basis of the first fruit image, the second fruit image, and the third fruit image according to one exemplary embodiment, a ripeness determination module 4340 for receiving the first fruit image 4331, the second fruit image 4332, and the third fruit image 4333 and obtaining a ripeness value 4350 for the first fruit 4330 may be used, but is not limited thereto.

In addition, for example, although not illustrated in FIG. 28, in the step S4260 of obtaining the ripeness value for the first fruit on the basis of the first fruit image, the second fruit image, and the third fruit image according to one exemplary embodiment, a first ripeness determination module for receiving the first fruit image 4331 and obtaining a first ripeness value, a second ripeness determination module for receiving the second fruit image 4332 and obtaining a second ripeness value, and a third ripeness determination module for receiving the third fruit image 4333 and obtaining a third ripeness value may be used, and the ripeness value for the first fruit 4330 may be obtained on the basis of the first to third ripeness values, but is not limited thereto.

In addition, specific content regarding the step S4260 of obtaining the ripeness value for the first fruit on the basis of the first fruit image, the second fruit image, and the third fruit image according to one exemplary embodiment will be described in more detail by using other drawings.

In addition, as described above, in a case of obtaining a ripeness value for the same fruit by using at least two images representing the same fruit but using at least a partially overlapping image and at least a partially non-overlapping image simultaneously, the ripeness value may be obtained for the fruit more accurately by representing different sides of the fruit but representing continuous sides of the fruit.

In addition, the first to third images described above may mean some of the images selected as an image set representing the same fruit among the plurality of images described through FIG. 26.

In this case, the method for selecting the image set representing the same fruit will be described in more detail below.

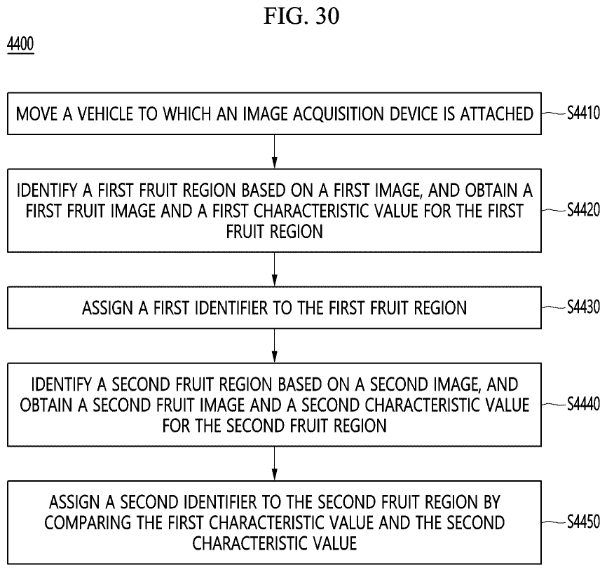

FIG. 30 is a view illustrating a method of obtaining an image set representing the same fruit according to one exemplary embodiment.

Before describing FIG. 30, it should be noted that the first to third fruit images described in FIGS. 28 and 29 may mean images obtained or selected by the method described through FIG. 30.

Referring to FIG. 30, the method 4400 of obtaining an image set representing the same fruit according to one exemplary embodiment may include: step S4410 of moving a vehicle to which an image acquisition device is attached; step S4420 of identifying a first fruit region on the basis of a first image and obtaining a first fruit image and first feature values for the first fruit region; step S4430 of assigning a first identifier to the first fruit region; step S4440 of identifying a second fruit region on the basis of a second image and obtaining a second fruit image and second feature values for the second fruit region; and step S4450 of assigning a second identifier to the second fruit region by comparing the first feature values and the second feature values.

In this case, according to one exemplary embodiment, at least some of the steps described above may be omitted.

For example, a method of obtaining an image set representing the same fruit according to one exemplary embodiment may include, but is not limited to: a step of identifying a first fruit region on the basis of a first image and obtaining a first fruit image and first feature values for the first fruit region; a step of assigning a first identifier to the first fruit region; a step of identifying a second fruit region on the basis of a second image and obtaining a second fruit image and second feature values for the second fruit region; and a step of assigning a second identifier to the second fruit region by comparing the first feature values and the second feature values.

In addition, according to one exemplary embodiment, at least some steps may be added.

For example, the method of obtaining the image set representing the same fruit according to one exemplary embodiment may include, but is not limited to: a step of identifying a first fruit region on the basis of a first image and obtaining a first fruit image and first feature values for the first fruit region; a step of assigning a first identifier to the first fruit region; a step of identifying a second fruit region on the basis of a second image and obtaining a second fruit image and second feature values for the second fruit region; a step of assigning a second identifier to the second fruit region by comparing the first feature values and the second feature values; a step of identifying a third fruit region on the basis of a third image and obtaining a third fruit image and third feature values for the third fruit region; and a step of assigning a third identifier to the third fruit region by comparing the second feature values and the third feature values when the second identifier and the first identifier are the same.

The content described for the step of moving the vehicle to which the image acquisition device is attached described above may be applied to the step S4410 of moving the vehicle to which the image acquisition device is attached according to one exemplary embodiment, so redundant descriptions will be omitted.

In the step S4420 of identifying the first fruit region on the basis of the first image and obtaining the first fruit image and the first feature values for the first fruit region according to one exemplary embodiment, the first image may be applied with the content of the first image described through FIGS. 28 and 29, so redundant descriptions will be omitted.

In addition, in the step S4420 of identifying the first fruit region on the basis of the first image and obtaining the first fruit image and the first feature values for the first fruit region according to one exemplary embodiment, the operations of the fruit detection module described through FIG. 2 may be applied to the identifying of the first fruit region on the basis of the first image, so redundant descriptions will be omitted.

In addition, in the step S4420 of identifying the first fruit region on the basis of the first image and obtaining the first fruit image and the first feature values for the first fruit region according to one exemplary embodiment, the operations of the fruit detection module described through FIG. 2 may be applied to the obtaining of the first fruit image and the first feature values for the first fruit region, so redundant descriptions will be omitted.

In addition, in the step S4420 of identifying the first fruit region on the basis of the first image and obtaining the first fruit image and the first feature values for the first fruit region according to one exemplary embodiment, the first fruit region may mean one fruit region among a plurality of fruit regions detected in the first image.

In addition, as a result of the step S4420 of identifying the first fruit region on the basis of the first image and obtaining the first fruit image and the first feature values for the first fruit region according to one exemplary embodiment, at least some values may be obtained from the first fruit image for the first fruit region, and from among pixel coordinate values corresponding to the first fruit region, pixel values corresponding to the first fruit region, a depth value corresponding to the first fruit region, and a ripeness value corresponding to the first fruit region.

In this case, the first feature values may include at least one of the pixel coordinate values corresponding to the first fruit region, the pixel values corresponding to the first fruit region, the depth value corresponding to the first fruit region, and the ripeness value corresponding to the first fruit region.

The step S4430 of assigning the first identifier to the first fruit region according to one exemplary embodiment may be understood as assigning a first ID to the first fruit region.

For example, the step S4430 of assigning the first identifier to the first fruit region according to one exemplary embodiment may be understood as assigning an ID of 0001 to the first fruit region, but is not limited thereto.

In addition, in the step S4430 of assigning the first identifier to the first fruit region according to one exemplary embodiment, the first identifier may mean an identifier for the first fruit.

In the step S4440 of identifying the second fruit region on the basis of the second image and obtaining the second fruit image and the second feature values for the second fruit region according to one exemplary embodiment, the content of the second image described through FIGS. 28 and 29 may be applied to the second image, so redundant descriptions will be omitted.

In addition, in the step S4440 of identifying the second fruit region on the basis of the second image and obtaining the second fruit image and the second feature values for the second fruit region according to one exemplary embodiment, the operations of the fruit detection module described through FIG. 2 may be applied to the identifying of the second fruit region on the basis of the second image, so redundant descriptions will be omitted.

In addition, in the step S4440 of identifying the second fruit region on the basis of the second image and obtaining the second fruit image and the second feature values for the second fruit region according to one exemplary embodiment, the operations of the fruit detection module described through FIG. 2 may be applied to the obtaining of the second fruit image and the second feature values for the second fruit region, so redundant descriptions will be omitted.

In addition, in the step S4440 of identifying the second fruit region on the basis of the second image and obtaining the second fruit image and the second feature values for the second fruit region according to one exemplary embodiment, the second fruit region may mean one fruit region among the plurality of fruit regions detected in the second image.

In addition, as a result of the step S4440 of identifying the second fruit region on the basis of the second image and obtaining the second fruit image and the second feature values for the second fruit region according to one exemplary embodiment, at least some values may be obtained from the second fruit image for the second fruit region, and from among pixel coordinate values corresponding to the second fruit region, pixel values corresponding to the second fruit region, a depth value corresponding to the second fruit region, and a ripeness value corresponding to the second fruit region.

In this case, the second feature values may include at least one of the pixel coordinate values corresponding to the second fruit region, the pixel values corresponding to the second fruit region, the depth value corresponding to the second fruit region, and the ripeness value corresponding to the second fruit region.

In the step S4450 of assigning the second identifier to the second fruit region by comparing the first feature values and the second feature values according to one exemplary embodiment, in a case where results of the comparison between the first feature values and the second feature values satisfy a first condition, the second identifier may be identical to the first identifier, and in a case where the results of the comparison between the first feature values and the second feature values does not satisfy the first condition, the second identifier may be different from the first identifier.

For example, in the step S4450 of assigning the second identifier to the second fruit region by comparing the first feature values and the second feature values according to one exemplary embodiment, in one case where the second pixel coordinate values for the second fruit region are for a position within a region preset on the basis of the first pixel coordinate values for the first fruit region, the second identifier may be the same as the first identifier, and in the other case of being located outside the preset region, the second identifier may be different from the first identifier, but is not limited thereto.

In addition, for example, in the step S4450 of assigning the second identifier to the second fruit region by comparing the first feature values and the second feature values according to one exemplary embodiment, in one case where the second pixel coordinate values and the second pixel values for the second fruit region satisfy a condition preset on the basis of the first pixel coordinate values for the first fruit region and the first pixel values, the second identifier may be the same as the first identifier, and in the other case of not satisfying the preset condition, the second identifier may be different from the first identifier, but is not limited thereto.

In addition, for example, in the step S4450 of assigning the second identifier to the second fruit region by comparing the first feature values and the second feature values according to one exemplary embodiment, in one case where the second pixel coordinate values, the second pixel values, and the second ripeness value for the second fruit region satisfy a condition preset on the basis of the first pixel coordinate values, the first pixel values, and the first ripeness value for the first fruit region, the second identifier may be the same as the first identifier, and in the other case of not satisfying the preset condition, the second identifier may be different from the first identifier, but is not limited thereto.

In addition, the step S4450 of assigning the second identifier to the second fruit region by comparing the first feature values and the second feature values according to one exemplary embodiment may be understood as a step of determining whether the second fruit region and the first fruit region represent are the same fruit on the basis of the first feature values and the second feature values.

In this case, in a case where the second fruit region and the first fruit region are determined to be the same fruit, the second identifier may be the same as the first identifier, and in a case where the second fruit region and the first fruit region are determined to be regions for fruits different from each other, the second identifier may be different from the first identifier.

In addition, the examples described above for the step S4450 of assigning the second identifier to the second fruit region by comparing the first feature values and the second feature values according to one exemplary embodiment are merely described as some representative examples, and the content of the present application is not limited to the examples described above. On the basis of the first feature values and the second feature values, various algorithms may be applied to determine whether the first fruit region and the second fruit region represent the same fruit.

The step S4450 of assigning the second identifier to the second fruit region by comparing the first feature values and the second feature values according to one exemplary embodiment may be understood as assigning a second ID to the second fruit region.

For example, the step S4450 of assigning the second identifier to the second fruit region by comparing the first feature values and the second feature values according to one exemplary embodiment may be understood as assigning an ID of 0001 to the second fruit region in the case where the second identifier is the same as the first identifier, but is not limited thereto.

In addition, for example, the step S4450 of assigning the second identifier to the second fruit region by comparing the first feature values and the second feature values according to one exemplary embodiment may be understood as assigning an ID of 0002 to the second fruit region in the case where the second identifier is different from the first identifier, but is not limited thereto.

In addition, in the step S4450 of assigning the second identifier to the second fruit region by comparing the first feature values and the second feature values according to one exemplary embodiment, in the case where the second identifier is the same as the first identifier, the second identifier may mean an identifier for the first fruit, but is not limited thereto.

In addition, in the step S4450 of assigning the second identifier to the second fruit region by comparing the first feature values and the second feature values according to one exemplary embodiment, in the case where the second identifier is different from the first identifier, the second identifier may mean an identifier for the second fruit different from the first fruit, but is not limited thereto.

According to one exemplary embodiment, in the case where the first identifier and the second identifier are the same, the first fruit image and second fruit image, which represent the first fruit described in FIGS. 28 and 29, may be obtained.

That is, in a case where the first identifier and the second identifier are the same, an image set representing the same fruit may be obtained.

For example, in the case where the first identifier and the second identifier are the same, the first fruit image and second fruit image, which represent the first fruit, may be obtained as an image set, but is not limited thereto.

In addition, a plurality of crop plants or a plurality of fruit regions may be located in one image as described throughout the present application, so a plurality of fruit images may be obtained for one fruit according to the above-described method.

That is, according to the above-described method, an image set including the plurality of fruit images may be obtained for the same one fruit.

In addition, according to the above-described method, the plurality of fruit images, the plurality of pixel coordinate values, the plurality of pixel values, the plurality of depth values, and/or the plurality of ripeness values may be obtained for one fruit.

For example, according to the method described above, in a case where a first identifier and a second identifier are the same, an image set including a first fruit image and a second fruit image may be stored for an ID for a first fruit, a pixel coordinate value set including first pixel coordinate values corresponding to a first fruit region and second pixel coordinate values corresponding to a second fruit region may be stored, a pixel value set including first pixel values corresponding to the first fruit region and second pixel values corresponding to the second fruit region may be stored, a depth value set including a first depth value corresponding to the first fruit region and a second depth value corresponding to the second fruit region may be stored, and a ripeness value set including a first ripeness value corresponding to the first fruit region and a second ripeness value corresponding to the second fruit region may be stored.

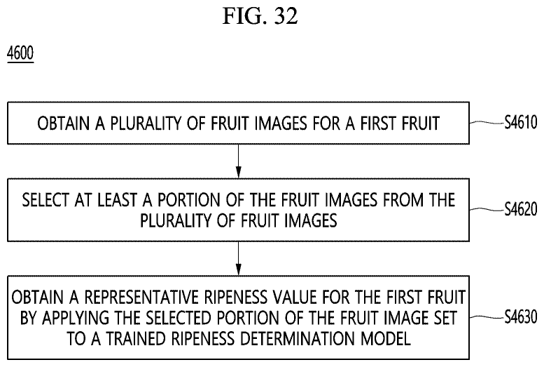

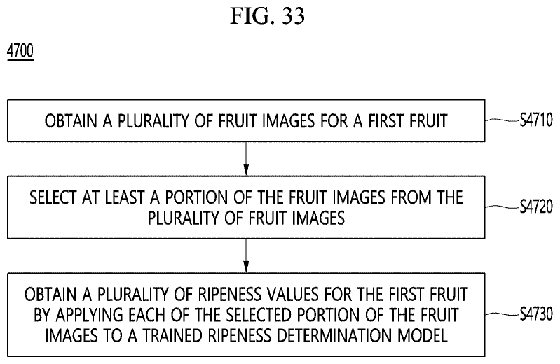

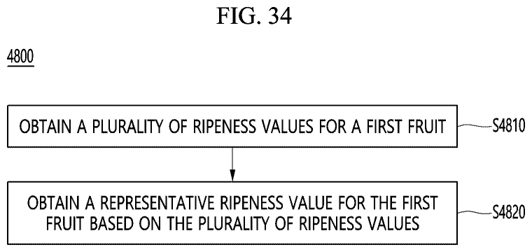

In the following FIGS. 32 and 33, in a case where a plurality of images is obtained for one fruit, a method of obtaining a representative ripeness value or a plurality of ripeness values for one fruit on the basis of the plurality of images will be described in more detail. In FIG. 34, in a case where a plurality of ripeness values is obtained for one fruit, a method of obtaining a representative ripeness value for one fruit on the basis of the plurality of ripeness values will be described in more detail.

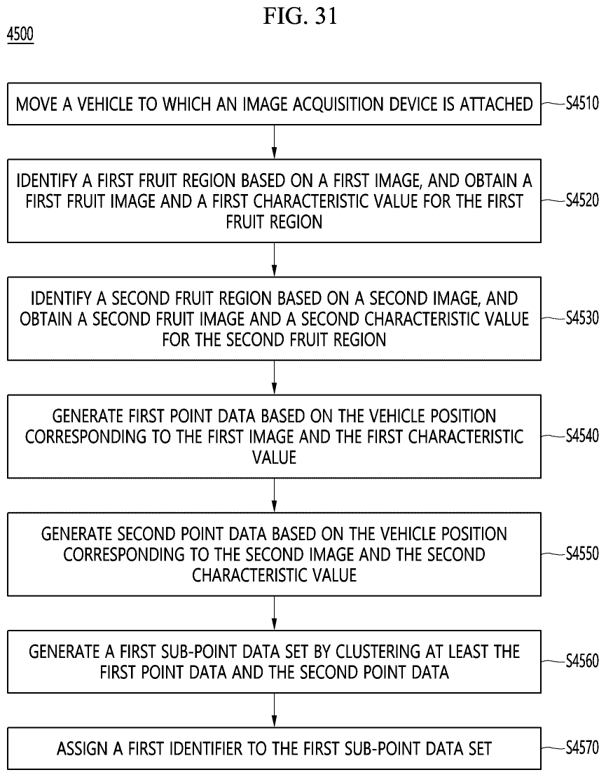

FIG. 31 is a view illustrating a method of obtaining an image set representing the same fruit according to one exemplary embodiment.

Before describing FIG. 31, it should be noted that the first to third fruit images described in FIGS. 28 and 29 may mean images obtained or selected by the method described through FIG. 31.

Referring to FIG. 31, the method 4500 of obtaining the image set representing the same fruit according to one exemplary embodiment may include: step S4510 of moving a vehicle to which an image acquisition device is attached; step S4520 of identifying a first fruit region on the basis of a first image and obtaining a first fruit image and first feature values for the first fruit region; step S4530 of identifying a second fruit region on the basis of a second image and obtaining a second fruit image and second feature values for the second fruit region; step S4540 of generating first point data on the basis of a vehicle position corresponding to the first image and the first feature values; step S4550 of generating second point data on the basis of a vehicle position corresponding to the second image and the second feature values; step S4560 of generating a first sub-point data set by clustering at least the first point data and the second point data; and step S4570 of assigning a first identifier to the first sub-point data set.

In this case, according to one exemplary embodiment, at least some of the steps described above may be omitted or at least some of the steps may be added.

The content described for the moving of the vehicle to which the image acquisition device is attached described above may be applied the step S4510 of moving the vehicle to which the image acquisition device is attached according to one exemplary embodiment, so redundant descriptions will be omitted.

In addition, the content described through FIG. 30 may be applied to the step S4520 of identifying the first fruit region on the basis of the first image and obtaining the first fruit image and the first feature values for the first fruit region according to one exemplary embodiment, so redundant descriptions will be omitted.

In addition, the content described through FIG. 30 may be applied to the step S4530 of identifying the second fruit region on the basis of the second image and obtaining the second fruit image and second feature values for the second fruit region according to one exemplary embodiment, so redundant descriptions will be omitted.

In addition, in the step S4540 of generating the first point data on the basis of the vehicle position corresponding to the first image and the first feature values according to one exemplary embodiment, when the vehicle position corresponding to the first image is understood as the vehicle position at the first time point, the content described about the step of generating the at least one piece of point data on the basis of the feature values for the at least one fruit region obtained on the basis of the above-described first image and the vehicle position at the first time point may be applied to the step S4540 of generating the first point data on the basis of the vehicle position corresponding to the first image and the first feature values according to one exemplary embodiment, so redundant descriptions will be omitted.

In addition, in the step S4550 of generating the second point data on the basis of the second feature values and the vehicle position corresponding to the second image according to one exemplary embodiment, when the vehicle position corresponding to the second image is understood as the vehicle position at the second time point, the content described about the step of generating the at least one piece of point data on the basis of the vehicle position at the second time point and the feature values for the at least one fruit region obtained on the basis of the above-described second image may be applied to the step S4550 of generating the second point data on the basis of the vehicle position and the second feature values corresponding to the second image according to one exemplary embodiment, so redundant descriptions will be omitted.

In addition, the content described about the step of generating the at least one sub-point data set by clustering the plurality of point data generated on the basis of at least the first and second images described above may be applied to the step S4560 of generating the first sub-point data set by clustering the at least the first point data and the second point data according to one exemplary embodiment, so redundant descriptions will be omitted.

The step S4570 of assigning the first identifier to the first sub-point data set according to one exemplary embodiment may be understood as assigning a first ID to the first sub-point data set.

For example, the step S4570 of assigning the first identifier to the first sub-point data set according to one exemplary embodiment may be understood as assigning an ID of 0001 to the first sub-point data set, but is not limited thereto.

In addition, in the step S4570 of assigning the first identifier to the first sub-point data set according to one exemplary embodiment, the first identifier may mean an identifier for the first fruit.

According to one exemplary embodiment, the first fruit image and the second fruit image, which represent the first fruit described in FIG. 28 and FIG. 29, may be obtained.

For example, the first fruit image and the second fruit image, which are included in the first sub-point data set, may be obtained as an image set representing the first fruit.

In addition, as described throughout the present application, a plurality of crop plants or a plurality of fruit regions may be located in one image, so a plurality of fruit images may be obtained for one fruit according to the above-described method.

That is, according to the above-described method, an image set including the plurality of fruit images may be obtained for the same one fruit.

In addition, according to the above-described method, the plurality of fruit images, the plurality of pixel coordinate values, the plurality of pixel values, the plurality of depth values, and/or the plurality of ripeness values may be obtained for one fruit.

For example, according to the method described above, for an ID for a first sub-point data set, an image set including a first fruit image and a second fruit image may be stored, a pixel coordinate value set including first pixel coordinate values corresponding to a first fruit region and second pixel coordinate values corresponding to a second fruit region may be stored, a pixel value set including first pixel values corresponding to the first fruit region and second pixel values corresponding to the second fruit region may be stored, a depth value set including a first depth value corresponding to the first fruit region and a second depth value corresponding to the second fruit region may be stored, and a ripeness value set including a first ripeness value corresponding to the first fruit region and a second ripeness value corresponding to the second fruit region may be stored.

In the following FIGS. 32 and 33, a method of obtaining a representative ripeness value or a plurality of ripeness values for one fruit on the basis of a plurality of images in a case where the plurality of images is obtained for the one fruit will be described in more detail. In the following FIG. 34, a method of obtaining a representative ripeness value for one fruit on the basis of a plurality of ripeness values in a case where the plurality of ripeness values is obtained for the one fruit will be described in more detail.

FIG. 32 is a view illustrating a method of obtaining a representative ripeness value for a fruit according to one exemplary embodiment.

More specifically, FIG. 32 is a view illustrating a method of obtaining a representative ripeness value for a fruit by using a plurality of fruit images obtained in a case where the plurality of fruit images for the same fruit is obtained by the method described in FIG. 30 or FIG. 31.

In addition, for convenience of description, FIG. 32 is illustrated with the method of obtaining the representative ripeness value for the first fruit, but the content described in FIG. 32 may be used to obtain a representative ripeness value for each of a plurality of fruits.

Referring to FIG. 32, the method 4600 of obtaining the representative ripeness value for the fruit according to one exemplary embodiment may include: step S4610 of obtaining a plurality of fruit images for a first fruit; step S4620 of selecting at least some of the fruit images from among the plurality of fruit images; and step S4630 of obtaining a representative ripeness value for the first fruit by applying a set of the selected at least some of the fruit images to a trained ripeness determination model.

In the step S4610 of obtaining the plurality of fruit images for the first fruit according to one exemplary embodiment, the plurality of fruit images for the first fruit may be obtained as a result of the method described in FIG. 30 or FIG. 31, so redundant descriptions will be omitted.

In the step S4620 of selecting the at least some of the fruit images from among the plurality of fruit images according to one exemplary embodiment, the at least some of the fruit images may be selected on the basis of frame numbers of images including fruit images.

For example, the at least some of the fruit images may be selected so as to include fruit images respectively having the earliest and the latest frame numbers for the images including the fruit images.

For a more specific example, in a case where the frame numbers of the images respectively including the plurality of fruit images for the first fruit are given from 1 to 20, the at least some of the fruit images may be selected to include: a fruit image included in an image having a frame number 1; and a fruit image included in an image having a frame number 20, but is not limited thereto.

In addition, for example, the at least some of the fruit images may be selected so as not to include fruit images respectively having the earliest and the latest frame numbers for the images including the fruit images.

For a more specific example, in a case where the frame numbers of the images respectively including the plurality of fruit images for the first fruit are given from 1 to 20, the at least some of the fruit images may be selected not to include: the fruit image included in the image having the frame number 1; and the fruit image included in the image having the frame number 20, but is not limited thereto.

The reason for this is that among the images obtained for one fruit, the earliest and the latest images obtained include little information about the fruit or include noise, and thus excluding these images may secure higher accuracy in obtaining a ripeness value.

In addition, for example, the at least some of the fruit images may be selected so as to include fruit images in which the frame numbers of images including the fruit images are numbers in a preset order.

For a more specific example, in a case where the frame numbers of the images respectively including the plurality of fruit images for the first fruit are given from 1 to 20 and the preset order is 5-th, 10-th, and 15-th, the at least some of the fruit images may be selected to include: a fruit image included in an image having a frame number of 5; a fruit image included in an image having a frame number of 10; and a fruit image included in an image having a frame number of 15, but it is not limited to this.

In addition, in the step S4620 of selecting the at least some of the fruit images from among the plurality of fruit images according to one exemplary embodiment, the at least some of the fruit images may be selected on the basis of acquisition times of the images including the fruit images.

For example, the at least some of the fruit images may be selected so as to include the fruit images respectively having the earliest and the latest acquisition times for the images including the fruit images.

In addition, for example, the at least some of the fruit images may be selected so as not to include the fruit images respectively having the earliest and the latest acquisition times for the images including the fruit images.

In addition, for example, the at least some of the fruit images may be selected to include fruit images in which the acquisition times of the images including the fruit images are in a preset order.

In addition, in the step S4620 of selecting the at least some of the fruit images from among the plurality of fruit images according to one exemplary embodiment, the at least some of the fruit images may be selected so as to have a preset number.

For example, in a case of a preset number that is four, four of the at least some of the fruit images may be selected, but this is not limited thereto.

In addition, in the step S4620 of selecting the at least some of the fruit images from among the plurality of fruit images according to one exemplary embodiment, the at least some of the fruit images may be selected on the basis of analysis results for the images including the fruit images.

For example, the at least some of the fruit images may be selected on the basis of whether each of regions in which the fruit images are located within the images including the fruit images is within a preset region.

For a more specific example, in a case where the preset region is a predetermined region including the center of the horizontal field of view of an image, the at least some of the fruit images may be selected so as to include images where fruit images are included within a predetermined region in the images including the fruit images, but is not limited thereto.

In addition, for example, the at least some of the fruit images may be selected on the basis of whether the fruit images are located within a preset angular range from the image acquisition device.

For a more specific example, in a case where the preset angle range is a first angle range, the at least some of the fruit images may be selected to include fruit images in which an angle calculated on the basis of feature values (i.e., pixel coordinate values, depth values, etc.) corresponding to the fruit images is included within the first angle range, but is not limited thereto.

In addition, in the step S4620 of selecting the at least some of the fruit images from among the plurality of fruit images according to one exemplary embodiment, the at least some of the fruit images may be selected on the basis of the size of each fruit image.

For example, the at least some of the fruit images may be selected according to preset numbers in order of fruit image size from largest to smallest.

For a more specific example, in a case of a preset number that is 4, the at least some of the fruit images may be selected as four fruit images having the largest size, but this is not limited thereto.

In addition, for example, the at least some of the fruit images may be selected to include fruit images of different sizes.

For a more specific example, the at least some of the fruit images may be selected to include, but are not limited to, a first fruit image having a first size, a second fruit image having a second size, and a third fruit image having a third size.

In addition, in the step S4620 of selecting the at least some of the fruit images from among the plurality of fruit images according to one exemplary embodiment, the at least some of the fruit images may be selected on the basis of a ratio of a fruit within the fruit images.

For example, the at least some of the fruit images may be selected to include fruit images in which the ratio of the fruit within the fruit images is greater than or equal to a preset ratio.

This may be because, among the plurality of fruit images, a fruit image with a larger ratio of a fruit includes more information about the fruit than a fruit image with a fruit that is blocked from view by leaves, etc.

In addition, in the step S4620 of selecting the at least some of the fruit images among the plurality of fruit images according to one exemplary embodiment, the at least some of the fruit images may be selected so as to represent the same fruit's sides different from each other.

For example, the at least some of the fruit images may be selected to include a first fruit image representing a first side of a first fruit, a second fruit image representing a second side of the first fruit, and a third fruit image representing a third side of the first fruit. The first side, the second side, and the third side may be sides different from each other.

In addition, in the step S4620 of selecting the at least some of the fruit images from among the plurality of fruit images according to one exemplary embodiment, in a case where at least some of fruit images selected for the first fruit are referred to as a first fruit image set, and at least some of fruit images selected for the second fruit are referred to as a second fruit image set according to the above-described methods, the first fruit image set and the second fruit image set may include the fruit images included in the images different from each other.

For example, the first fruit image set may include, for the first fruit, a first fruit image, a second fruit image, and a third fruit image respectively included in a first image frame, a third image frame, and a fifth image frame. The second fruit image set may include, for the second fruit, a fourth fruit image, a fifth fruit image, and a sixth fruit image respectively included in a second image frame, a fourth image frame, and a sixth image frame.

In addition, in this case, both the first fruit and the second fruit may be expressed within the first to sixth image frames.

In addition, in the step S4620 of selecting the at least some of the fruit images from among the plurality of fruit images according to one exemplary embodiment, in a case where at least some of the fruit images selected for the first fruit are referred to as the first fruit image set, and at least some of the fruit images selected for the second fruit are referred to as the second fruit image set according to the above-described methods, the first fruit image set and the second fruit image set may include fruit images included in at least some images.

For example, the first fruit image set may include, for the first fruit, the first fruit image, the second fruit image, and the third fruit image respectively included in the first image frame, the second image frame, and the third image frame. The second fruit image set may include, for the second fruit, the fourth fruit image, the fifth fruit image, and the sixth fruit image respectively included in the second image frame, the third image frame, and the fourth image frame.

In addition, in this case, both the first fruit and the second fruit may be expressed within the first to fourth image frames.

For example, a first fruit image for a first fruit and a seventh fruit image for a second fruit may be expressed within a first image frame. A second fruit image for the first fruit and a fourth fruit image for the second fruit may be expressed within a second image frame. A third fruit image for the first fruit and a fifth fruit image for the second fruit may be expressed within a third image frame. An eighth fruit image for the first fruit and a sixth fruit image for the second fruit may be expressed within a fourth image frame.

In the step S4630 of obtaining the representative ripeness value for the first fruit by applying the set of the selected at least some of the fruit images to the trained ripeness determination model according to one exemplary embodiment, the trained ripeness determination model may be trained by using a plurality of fruit images and a single ripeness value corresponding to the plurality of fruit images.

For example, in the step S4630 of obtaining the representative ripeness value for the first fruit by applying the set of the selected at least some of the fruit images to the trained ripeness determination model according to one exemplary embodiment, the trained ripeness determination model may be a model trained by using the first fruit image, second fruit image, third fruit image, and fourth fruit image as first training input data, and using a first ripeness value corresponding to the first training input data as training output data, but is not limited thereto.

In addition, in the step S4630 of obtaining the representative ripeness value for the first fruit by applying the set of the selected at least some of the fruit images to the trained ripeness determination model according to one exemplary embodiment, the content related to the artificial intelligence described above may be applied to the trained ripeness determination model, so redundant descriptions will be omitted.

In addition, in the step S4630 of obtaining the representative ripeness value for the first fruit by applying the set of the selected at least some of the fruit images to the trained ripeness determination model according to one exemplary embodiment, the selected at least some of the fruit images may be input to the trained ripeness determination model as one input data set.

For example, in a case where the at least some of the selected fruit images include the first fruit image, the second fruit image, the third fruit image, and the fourth fruit image, the first to fourth fruit images may be input to the trained ripeness determination model as the one input data set, but is not limited thereto.

In addition, in the step S4630 of obtaining the representative ripeness value for the first fruit by applying the set of the selected at least some of the fruit images to the trained ripeness determination model according to one exemplary embodiment, in a case where the sizes of the selected at least some of the fruit images are different from each other, they may be converted to a preset size and input to the trained ripeness determination model.

For example, in a case where the at least some of the selected fruit images include a first fruit image having a first size and a second fruit image having a second size different from the first size, the first fruit image and the second fruit image may be converted to the same size, which is the preset size, and then input to the trained ripeness determination model, but is not limited thereto.

According to the above, one representative ripeness value may be obtained by considering different sides of the first fruit, which is one fruit, and this may be one technical solution capable of solving the problems described as the conventional problems.

FIG. 33 is a view illustrating a method of obtaining a plurality of ripeness values for a fruit according to one exemplary embodiment.

More specifically, FIG. 33 is a view illustrating a method of obtaining a plurality of representative ripeness values for a fruit by using a plurality of obtained fruit images in a case where the plurality of fruit images for the same fruit is obtained by the method described in FIG. 30 or FIG. 31.

In addition, for convenience of description, FIG. 33 is described as a method of obtaining the plurality of ripeness values for a first fruit, but the content described in FIG. 33 may be used to obtain a plurality of ripeness values for a plurality of respective fruits.

Referring to FIG. 33, the method 4700 of obtaining a plurality of ripeness values for the fruit according to one exemplary embodiment may include: step S4710 of obtaining a plurality of fruit images for a first fruit; step S4720 of selecting at least some of the fruit images from among the plurality of fruit images; and step S4730 of obtaining a plurality of ripeness values for the first fruit by applying each of the selected at least some of the fruit images to a trained ripeness determination model.

In the step S4710 of obtaining the plurality of fruit images for the first fruit according to one exemplary embodiment, the plurality of fruit images for the first fruit may be obtained as the result of the method described in FIG. 30 or FIG. 31, so redundant descriptions will be omitted.

The content described through FIG. 32 may be applied to the step S4720 of selecting the at least some of the fruit images among the plurality of fruit images according to one exemplary embodiment, so redundant descriptions will be omitted.

In the step S4730 of obtaining the plurality of ripeness values for the first fruit by applying each of the selected at least some of the fruit images to the trained ripeness determination model according to one exemplary embodiment, the trained ripeness determination model may be trained by using one fruit image and one ripeness value corresponding to the one fruit image.

For example, in the step S4730 of obtaining the plurality of ripeness values for the first fruit by applying each of the selected at least some of the fruit images to the trained ripeness determination model according to one exemplary embodiment, the trained ripeness determination model may be a model trained by using a first fruit image as first training input data and a first ripeness value corresponding to the first training input data as output data, but is not limited thereto.

In addition, in the step S4730 of obtaining the plurality of ripeness values for the first fruit by applying each of the selected at least some of the fruit images to the trained ripeness determination model according to one exemplary embodiment, the content related to the artificial intelligence described above may be applied to the trained ripeness determination model, so redundant descriptions will be omitted.

In addition, the step S4730 of obtaining the plurality of ripeness values for the first fruit by applying each of the selected at least some of the fruit images to the trained ripeness determination model according to one exemplary embodiment may include: a step of obtaining the first ripeness value by inputting the first fruit image representing a first side of the first fruit into a trained first ripeness determination model; and a step of obtaining a second ripeness value by inputting a second fruit image representing a second side of the first fruit into a trained second ripeness determination model.

In this case, the first side of the first fruit and the second side of the first fruit may mean the first fruit's sides different from each other.

In addition, in this case, the first fruit image and the second fruit image may be images representing the first fruit′ regions different from each other.

In addition, in this case, the first fruit's regions represented in the first and second fruit images may overlap each other at least partially.

In addition, in this case, the trained first ripeness determination model and the trained second ripeness determination model may be the same model.

For example, the trained first ripeness determination model and the trained second ripeness determination model may be models trained by using the same training data, but it is not limited thereto.

In this case, the trained ripeness determination model may be a model trained by using training data including images representing different sides of one fruit, so as to be commonly applied to both the first fruit image and second fruit image representing different sides of the first fruit.

In addition, in this case, the trained first ripeness determination model and the trained second ripeness determination model may be models different from each other.

For example, the trained first ripeness determination model may be a model trained by using first training data, and the trained second ripeness determination model may be a model trained by using second training data different from the first training data, but is not limited thereto.

In addition, the step S4730 of obtaining the plurality of ripeness values for the first fruit by applying each of the selected at least some of the fruit images to the trained ripeness determination model according to one exemplary embodiment may include: a step of converting the first fruit image having the first size into a converted first fruit image having a preset size; a step of obtaining a first ripeness value for the first fruit by applying the converted first fruit image to the trained ripeness judgment model; a step of converting the second fruit image having the second size different from the first size into a converted second fruit image having the preset size; and a step of obtaining a second ripeness value for the first fruit by applying the converted second fruit image to the trained ripeness determination model.

According to the above, a plurality of ripeness values may be obtained for the respective fruit images representing different sides of the first fruit, which is a single fruit. Hereinafter, a method of obtaining a representative ripeness value on the basis of a plurality of ripeness values for one fruit is described in more detail.

FIG. 34 is a view illustrating a method of obtaining a representative ripeness value for a fruit according to one exemplary embodiment.

More specifically, FIG. 34 is a view illustrating the method of obtaining the representative ripeness value by using a plurality of obtained ripeness values in a case where the plurality of ripeness values for the same fruit is obtained by the method described in FIG. 30, 31, or 33.

In addition, for convenience of description, FIG. 34 is described as the method of obtaining the representative ripeness value for the first fruit, but the content described in FIG. 34 may be used to obtain a representative ripeness value for each of a plurality of fruits.

Referring to FIG. 34, the method 4800 of obtaining the representative ripeness value for the fruit according to one exemplary embodiment may include; step S4810 of obtaining a plurality of ripeness values for a first fruit; and step S4820 of obtaining a representative ripeness value for the first fruit on the basis of the plurality of ripeness values.

In the step S4810 of obtaining the plurality of ripeness values for the first fruit according to one exemplary embodiment, the plurality of ripeness values for the first fruit may be obtained as the result of the method described in FIG. 30, 31, or 33, so redundant descriptions will be omitted.

In the step S4820 of obtaining the representative ripeness value for the first fruit on the basis of the plurality of ripeness values according to one exemplary embodiment, the plurality of ripeness values may be obtained as classification values.

For example, in the step S4820 of obtaining the representative ripeness value for the first fruit on the basis of the plurality of ripeness values according to one exemplary embodiment, the plurality of ripeness values may be obtained as respective values corresponding to ripeness, ripening, and unripeness, but is not limited thereto.

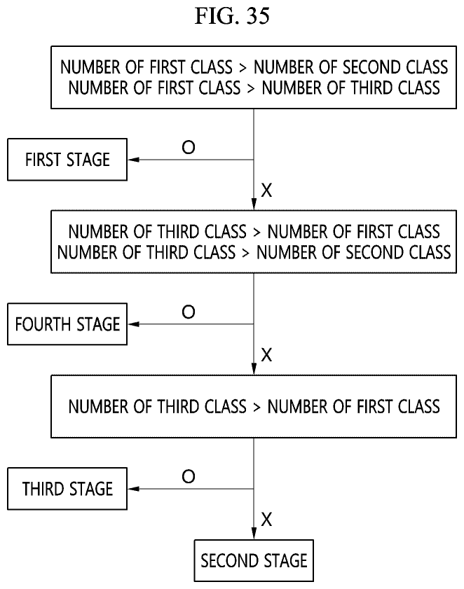

In addition, in the step S4820 of obtaining the representative ripeness value for the first fruit on the basis of the plurality of ripeness values according to one exemplary embodiment, in a case where the plurality of ripeness values is obtained as the classification values, the representative ripeness value for the first fruit may be obtained on the basis of the number of each class for the first fruit, which will be described in more detail below with reference to FIG. 35.

In addition, in the step S4820 of obtaining the representative ripeness value for the first fruit on the basis of the plurality of ripeness values according to one exemplary embodiment, in the case where the plurality of ripeness values is obtained as the classification values, the representative ripeness value for the first fruit may be obtained by assigning a weight to each class for the first fruit.

For example, a representative ripeness value for the first fruit may be obtained by assigning a weight of 1 to a class corresponding to ripeness, a weight of 0.5 to a class corresponding to ripening, and a weight of 0 to a class corresponding to unripeness.

For a more specific example, in a case where the plurality of ripeness values for the first fruit includes ripeness values, for the first to fourth fruit images, which are respectively obtained as ripeness, ripeness, ripening, and unripeness, the representative ripeness value for the first fruit may be obtained as a value of 2.5 that is 1+1+0.5+0, but is not limited thereto.

In addition, for example, the representative ripeness value for the first fruit may be obtained by assigning a weight of (1/the number of the plurality of ripeness values) to a class corresponding to ripeness, a weight of (0.5/the number of the plurality of ripeness values) to a class corresponding to ripening, and a weight of 0 to a class corresponding to unripeness.

For a more specific example, in a case where the plurality of ripeness values includes the ripeness values, for the first to fourth fruit images, which are respectively obtained as the ripeness, ripeness, ripening, and unripeness, a representative ripeness value for the first fruit may be obtained as 2.5/4=0.625, but is not limited thereto.

In addition, in the step S4820 of obtaining the representative ripeness value for the first fruit on the basis of the plurality of ripeness values according to one exemplary embodiment, in a case where the plurality of ripeness values is obtained as the classification values, a representative ripeness value for the first fruit may be obtained on the basis of comparisons of the number of each class for the first fruit.

For example, the representative ripeness value for the first fruit may be obtained with a larger number of classes.

For a more specific example, in a case where the plurality of ripeness values for the first fruit includes the ripeness values, for the first to fourth fruit images, which are respectively obtained as the ripeness, ripeness, ripening, and unripeness, a representative ripeness value for the first fruit may be obtained as a value corresponding to the ripeness, but is not limited thereto.

In addition, in the step S4820 of obtaining the representative ripeness value for the first fruit on the basis of the plurality of ripeness values according to one exemplary embodiment, the plurality of ripeness values may be obtained as probability values.

For example, in the step S4820 of obtaining the representative ripeness value for the first fruit on the basis of the plurality of ripeness values according to one exemplary embodiment, a plurality of ripeness values may be obtained as probability values including a probability value for ripeness, a probability value for ripening, and a probability value for unripeness, but is not limited thereto.

In addition, in the step S4820 of obtaining the representative ripeness value for the first fruit on the basis of the plurality of ripeness values according to one exemplary embodiment, in a case where each of the plurality of ripeness values is obtained as a probability value, a representative ripeness value for the first fruit may be obtained on the basis of a plurality of probability values.

For example, a representative ripeness value for the first fruit may be obtained as ripeness 0.4, ripening 0.325, unripeness 0.275 in a case where a plurality of ripeness values for the first fruit includes a ripeness value for each of the first to fourth fruit images, in which ripeness values for the first fruit image are obtained as ripeness 0.8, ripening 0.1, and unripeness 0.1, ripeness values for the second fruit image are obtained as ripeness 0.7, ripening 0.1, unripeness 0.2, ripeness values for the third fruit image are obtained as ripeness 0.1, ripening 0.8, unripeness 0.1, and ripeness values for the fourth fruit image are obtained as ripeness 0, ripening 0.3, unripeness 0.7, but it is not limited thereto.

In the step S4820 of obtaining the representative ripeness value for the first fruit on the basis of the plurality of ripeness values according to one exemplary embodiment, the plurality of ripeness values may be obtained as score values.

For example, in the step S4820 of obtaining the representative ripeness value for the first fruit on the basis of the plurality of ripeness values according to one exemplary embodiment, the plurality of ripeness values may be obtained as the score values including a score value for ripeness, a score value for ripening, and a score value for unripeness, but is not limited thereto.

In addition, in the step S4820 of obtaining the representative ripeness value for the first fruit on the basis of the plurality of ripeness values according to one exemplary embodiment, in a case where the plurality of ripeness values is obtained as a score value for each class, a representative ripeness value for the first fruit may be obtained on the basis of a plurality of score values.

For example, a representative ripeness value for the first fruit may be obtained as ripeness 4, ripening 3.25, unripeness 2.75 in a case where a plurality of ripeness values for the first fruit includes a ripeness value for each of the first to fourth fruit images, in which ripeness values for the first fruit image are obtained as ripeness 8, ripening 1, and unripeness 1, ripeness values for the second fruit image are obtained as ripeness 7, ripening 1, unripeness 2, ripeness values for the third fruit image are obtained as ripeness 1, ripening 8, unripeness 1, and ripeness values for the fourth fruit image are obtained as ripeness 0, ripening 3, unripeness 7, but it is not limited thereto.

In addition, in the step S4820 of obtaining the representative ripeness value for the first fruit on the basis of the plurality of ripeness values according to one exemplary embodiment, the plurality of ripeness values may be obtained as score values for ripeness.

In addition, in the step S4820 of obtaining the representative ripeness value for the first fruit on the basis of the plurality of ripeness values according to one exemplary embodiment, in a case where the plurality of ripeness values is obtained as the score values for ripeness, a representative ripeness value for the first fruit may be obtained on the basis of a plurality of score values.

For example, a representative ripeness value for the first fruit may be obtained as ripeness 4 in a case where a plurality of ripeness values for the first fruit includes a ripeness value for each of first to fourth fruit images, in which ripeness values for the first fruit image are obtained as ripeness 8, ripeness values for the second fruit image are obtained as ripeness 7, ripeness values for the third fruit image are obtained as ripeness 4, and ripeness values for the fourth fruit image are obtained as ripeness 0, but it is not limited thereto.

In addition, in the step S4820 of obtaining the representative ripeness value for the first fruit on the basis of the plurality of ripeness values according to one exemplary embodiment, the representative ripeness value for the first fruit may be determined by considering a confidence value for each of the plurality of ripeness values.

For example, when the step S4810 of obtaining the plurality of ripeness values for the first fruit is performed, the confidence value for each of the plurality of ripeness values may be obtained, and a representative ripeness value for the first fruit may be determined on the basis of ripeness values whose confidence values are greater than or equal to a preset confidence value among the plurality of ripeness values.

For a more specific example, in a case where a ripeness value for a first fruit image is obtained as “2” corresponding to “ripeness” and a confidence value of the ripeness value for the first fruit image is obtained as 50%; a ripeness value for a second fruit image is obtained as “2” corresponding to “ripeness” and a confidence value of the ripeness value for the second fruit image is obtained as 80%; a ripeness value for a third fruit image is obtained as “1” corresponding to “ripening” and a confidence value of the ripeness value for the third fruit image is obtained as 20%; a ripeness value for a fourth fruit image is obtained as “0” corresponding to “unripeness” and a confidence value of the ripeness value for the fourth fruit image is obtained as 20%; and a preset confidence value is 70%, the ripeness value of “2” corresponding to “ripeness” for the second fruit image may be obtained as a representative ripeness value for the first fruit, but is not limited thereto.

In addition, in the step S4820 of obtaining the representative ripeness value for the first fruit on the basis of the plurality of ripeness values according to one exemplary embodiment, the representative ripeness value for the first fruit may be determined by considering a confidence value obtained on the basis of the plurality of ripeness values.

In this case, the confidence value obtained on the basis of the plurality of ripeness values may be determined on the basis of whether how many of the plurality of ripeness values is obtained as the same ripeness value.

In this case, the reason why the determining of the confidence value obtained on the basis of the plurality of ripeness values is performed on the basis of whether how many of the plurality of ripeness values is obtained as the same ripeness value is that ripeness states may be more clearly specified according to changes in color during the growth process of fruits.

That is, as a fruit ripens, the color of the fruit changes from a color corresponding to “unripeness” to a color corresponding to “ripeness”. In a case where a fruit is not yet ripe, the color corresponding to “unripeness” is distributed evenly, and in a case where the fruit is ripe, the color corresponding to “ripeness” is distributed evenly. In contrast, in a case where a fruit is ripening, the color corresponding to “ripeness”, the color corresponding to “unripeness”, and a color corresponding to “ripening” are irregularly distributed, so the determining of the confidence value obtained on the basis of the plurality of ripeness values that is performed on the basis of whether how many of the plurality of ripeness values is obtained as the same ripeness value enables the state of “unripeness” and the state of “ripeness” to be more clearly specified.

In addition, in this case, in order to obtain the confidence value obtained on the basis of the plurality of ripeness values, a relational expression related to entropy may be used, and this may be specified as the following [relational expression].

EntropyH(X)=−ΣP(xᵢ)log P(xᵢ) [Relational Expression]

In this case, P(xi) may represent a ratio of the number of a plurality of ripeness values.

For example, in a case where a plurality of ripeness values for the first fruit includes 10 ripeness values, and the plurality of ripeness values is obtained as any one of “2” corresponding to “ripeness”, “1” corresponding to “ripening”, or “0” corresponding to “unripeness”, the P(xi) may mean ratios including: a ratio of the number of ripeness values having a “2” value corresponding to “ripeness” among the 10 ripeness values (i.e., the number of ripeness values having the “2” value corresponding to “ripeness”/10); a ratio of the number of ripeness values having a “1” value corresponding to “ripening” among the 10 ripeness values (i.e., the number of ripeness values having the “1” value corresponding to “ripening”/10); and a ratio of the number of ripeness values having a “0” value corresponding to “unripeness” among the 10 ripeness values (i.e., the number of ripeness values having the “0” value corresponding to “unripeness”/10).

In addition, in this case, a confidence value obtained on the basis of the plurality of ripeness values may be set so that the smaller an entropy value, the higher confidence to be determined.

For example, in a case where a range of a confidence value is set to 0 to 10, the confidence value may be set to be 10 when an entropy value is 0, and may be 0 when an entropy value is log 3, but is not limited thereto.

In addition, in this case, in order to obtain a representative ripeness value for the first fruit, a step of determining whether a confidence value obtained on the basis of the plurality of ripeness values satisfies a preset confidence value condition may be performed, and a step of obtaining the representative ripeness value may be performed through different methods on the basis of a determined result.

For example, in a case where a confidence value obtained on the basis of the plurality of ripeness values satisfies the preset confidence value condition, a representative ripeness value for the first fruit may be obtained as an average of the plurality of ripeness values.

For a more specific example, in a case where the plurality of ripeness values includes 9 ripeness values and is all obtained as “0” corresponding to “unripeness”, an entropy value may be 0, in which case a confidence value can be 10, so that in a case where a preset confidence value condition is 8 or higher, the preset confidence value condition may be satisfied and a representative ripeness value for the first fruit may be obtained as “0”.

In addition, for a more specific example, in a case where the plurality of ripeness values includes 9 ripeness values and is all obtained as “2” corresponding to “ripeness”, an entropy value may be 0, in which case a confidence value can be 10, so that in a case where a preset confidence value condition is 8 or higher, the preset confidence value condition may be satisfied and a representative ripeness value for the first fruit may be obtained as “2”.

In addition, for example, in a case where a confidence value obtained on the basis of the plurality of ripeness values satisfies the preset confidence value condition, a representative ripeness value for the first fruit may be obtained by the most ripeness values with the same ripeness value among the plurality of ripeness values.

For a more specific example, in the case where the plurality of ripeness values includes 9 ripeness values and is all obtained as “0” corresponding to “unripeness”, the entropy value may be 0, in which case the confidence value can be 10, so that in the case where the preset confidence value condition is 8 or higher, the preset confidence value condition may be satisfied and the representative ripeness value for the first fruit may be obtained as “0”.

In addition, for a more specific example, in the case where the plurality of ripeness values includes 9 ripeness values and is all obtained as “2” corresponding to “ripeness”, the entropy value may be 0, in which case the confidence value can be 10, so that in the case where the preset confidence value condition is 8 or higher, the preset confidence value condition may be satisfied and the representative ripeness value for the first fruit may be obtained as “2”.

In addition, for example, in a case where a confidence value obtained on the basis of the plurality of ripeness values does not satisfy the preset confidence value condition, a representative ripeness value for the first fruit may be obtained as the value corresponding to “ripening”.

For a more specific example, in a case where the plurality of ripeness values includes 9 ripeness values and the plurality of ripeness values is provided as 0, 0, 0, 1, 1, 1, 2, 2, and 2 (in this case, “0” is a ripeness value corresponding to unripeness, “1” is a ripeness value corresponding to ripening, and “2” is a ripeness value corresponding to ripeness), an entropy value may be log 3, in which case a confidence value can be 0, so that in a case where the preset confidence value condition is 8 or more, the preset confidence value condition is not satisfied and a representative ripeness value for the first fruit may be obtained as “1” corresponding to “ripening”.

That is, the reason may be that in a case where a fruit is determined as “unripeness” when viewed from a first side, “ripening” when viewed from a second side, and “ripeness” when viewed from a third side, the corresponding fruit in question is ultimately neither in a state corresponding to “unripeness” nor in a state corresponding to “ripeness”, so it is reasonable to ultimately determine that the fruit is in the state corresponding to “unripeness”.

In addition, for convenience of description, the examples described above are described by assuming a confidence value that is in the range of 0 to 10 and are described as obtaining the confidence value on the basis of entropy. However, the content described in the present specification is not limited thereto, and in order to determine the confidence value, various methods may be used to determine whether how many of the plurality of ripeness values is obtained as the same ripeness value, so that the entropy itself may be used as the confidence value, and the range of the confidence value may also be set in various ways.

That is, in a case where a plurality of ripeness values obtained for a single fruit is obtained as the same values that are above a predetermined standard, a representative ripeness value for the single fruit is determined on the basis of the plurality of ripeness values. However, in a case where a plurality of ripeness values obtained for the single fruit is not obtained as the same values that are above the predetermined standard, various methods may be used to determine that the fruit is in a “ripening” state.

In addition, various operations may be performed to obtain a representative ripeness value for a single fruit through methods different from each other in a case where a confidence value, which is obtained on the basis of the plurality of ripeness values, satisfies the preset confidence value condition and in a case where a confidence value does not satisfy the preset confidence value condition.

In addition, in a case where the confidence value obtained on the basis of the plurality of ripeness values does not satisfy the preset confidence value condition, various operations such as re-obtaining images or deleting the obtained ripeness values may be performed.

FIG. 35 is a view illustrating a method for generating a representative ripeness value according to one exemplary embodiment.

Referring to FIG. 35, according to one exemplary embodiment, representative ripeness values for at least one fruit may be generated.

In this case, the representative ripeness values for the at least one of the fruits may be provided as information on stages at which the fruits are ripening.

For example, in the stages included in the representative ripeness values for the at least one fruit, a first stage may mean an unripeness stage of a fruit, a second stage may mean that the unripeness stage of the fruit changes into a ripening stage, a third stage may mean a stage at which the fruit changes from the ripening state into a ripeness state, and a fourth stage may mean the ripeness state of the fruit, but is not limited thereto.

In addition, in the generating of the representative ripeness values for the at least one fruit, ripeness values determined on the basis of a plurality of images of a single fruit may differ from each other, so generating the representative ripeness values by considering the distribution of each ripeness value may derive a more accurate ripeness value for the single fruit.

In addition, the first to third classes illustrated in FIG. 26 may mean ripeness values included in the above-described sub-point data set, and more specifically, the first class may have a class value corresponding to “unripeness”, the second class may have a class value corresponding to “ripening”, and the third class may have a class value corresponding to “ripeness”.

Accordingly, in order to obtain representative ripeness values for at least one fruit on the basis of a sub-point data set according to one exemplary embodiment, the distribution of ripeness values of each point data included in the sub-point data set may be compared.

For example, among the plurality of point data included in the sub-point data set, the number of pieces of point data each having a ripeness value of the first class, the number of pieces of point data each having a ripeness value of the second class, and the number of pieces of point data each having a ripeness value of the third class may be compared with each other, but is not limited thereto.

In addition, in this case, according to an algorithm for obtaining a representative ripeness value according to one exemplary embodiment, in a case where a first condition is satisfied, the representative ripeness value as a first stage may be obtained. The first condition may be a condition in which the number of pieces of point data whose ripeness value is the first class is greater than the number of pieces of point data whose ripeness value is the second class, and the number of pieces of point data whose ripeness value is the first class is greater than the number of pieces of point data whose ripeness value is the third class.

This may correspond to a case where the number of pieces of point data having the class value corresponding to “unripeness” is the largest. This case may mean that a fruit is determined to be in the unripeness stage.

In addition, in this case, according to the algorithm for obtaining the representative ripeness value according to one exemplary embodiment, in a case where the first condition is not satisfied and the second condition is satisfied, the representative ripeness value as a fourth stage may be obtained, and the second condition may be a condition in which the number of pieces of point data whose ripeness value is the third class is greater than the number of pieces of point data whose ripeness value is the first class, and the number of pieces of point data whose ripeness value is the third class is greater than the number of pieces of point data whose ripeness value is the second class.

This may correspond to a case where the number of pieces of point data having the class value corresponding to “ripeness” is the largest. This case may mean that the fruit may be determined to be in the ripeness stage.

In addition, in this case, according to the algorithm for obtaining the representative ripeness value according to one exemplary embodiment, in a case where the first condition and the second condition are not satisfied and the third condition is satisfied, the representative ripeness value as a third stage may be obtained, and in a case where the third condition is not satisfied, the representative ripeness value as the second stage may be obtained, and the third condition may be a condition in which the number of pieces of point data whose ripeness value is the third class is greater than the number of pieces of point data whose ripeness value is the first class.

This may correspond to a case where the number of pieces of point data whose class value corresponding to “ripening” is the largest. This case may mean that determination may be performed on whether it will be the second stage where it goes from unripeness to ripening, or it will be the third stage where it goes from ripening to ripeness by comparing the number of pieces of point data having the class value corresponding to “ripeness” with the number of pieces of point data having the class value corresponding to “unripeness”.

The methods according to the exemplary embodiment may be implemented in the form of program instructions that may be executed through various computer means, and may be recorded in a computer-readable media. The computer-readable media may include program instructions, data files, data structures, and the like alone or in combination. The program instructions recorded on the media may be designed and configured specifically for the exemplary embodiments or may be publicly known and available to those skilled in the art regarding computer software. Examples of the computer-readable recording medium include: magnetic media, such as a hard disk, a floppy disk, and a magnetic tape; optical medal, such as CD-ROM and DVD; magneto-optical media such as a floptical disk; and a hardware device, such as a ROM, a RAM, and a flash memory, specially configured to store and perform program instructions. Examples of the computer instructions include not only machine language code generated by a compiler, but also high-level language code executable by a computer using an interpreter or the like. The hardware device described above may be configured to operate by one or more software modules to perform the operations of the exemplary embodiments, and vice versa.

As described above, although the exemplary embodiments have been described with reference to the limited exemplary embodiments and drawings, various modifications and variations are possible from the above description by those skilled in the art. For example, appropriate results may be achieved even when the described techniques are performed in a different order than that of the described method, and/or the described components of the system, structure, device, circuit, and the like are coupled to each other or combined in a different form than the described method, or rearranged or substituted by other elements or equivalents.

Therefore, other implementation, other exemplary embodiments, and equivalents to the patent claims also fall within the scope of the following claims.

### MODE FOR INVENTION

As described above, related subject matters have been described in the best mode for implementing the embodiments of the present disclosure.

1. A method for counting fruits corresponding to a crop row, performed by one or more processors, comprising:
obtaining a plurality of images corresponding to a first crop row, wherein at least one image of the plurality of images represents at least one fruit located in a second crop row;
obtaining a representative distance values for a plurality of fruit regions based on the plurality of images corresponding to the first crop row;
calculating a first threshold distance value for distinguishing between the first crop row and the second crop row, based on the representative distance values for the plurality of fruit regions; and
determining a number of fruits corresponding to the first crop row by comparing the representative distance values for the plurality of fruit regions with the first threshold distance value.

2. The method of claim 1, wherein the obtaining the representative distance values for the plurality of fruit regions comprises:
detecting a fruit regions included in the plurality of images corresponding to the first crop row; and
calculating the representative distance values for the detected fruit regions.

3. The method of claim 2, wherein the obtaining the representative distance values for the plurality of fruit regions comprises:
obtaining a pixel coordinate value and a distance value for a first fruit region included in a first image among the plurality of images corresponding to the first crop row;
obtaining a pixel coordinate value and a distance value for a second fruit region included in a second image among the plurality of images corresponding to the first crop row;
obtaining a representative distance value for a third fruit region based on the pixel coordinate value and the distance value of the first fruit region and the pixel coordinate value and the distance value of the second fruit region,
wherein the first fruit region, the second fruit region, and the third fruit region correspond to a first fruit located in the first crop row.

4. The method of claim 2, wherein the calculating the representative distance values for the detected fruit regions comprises:
calculating a first representative distance value based on distance values corresponding to pixel coordinates included in a first fruit region.

5. The method of claim 4, wherein the calculating the first representative distance value based on the distance values corresponding to the pixel coordinates included in the first fruit region comprises:
selecting a first distance value corresponding to a first pixel coordinate among the pixel coordinates included in the first fruit region as the first representative distance value.

6. The method of claim 5, wherein the first pixel coordinate is a pixel coordinate located at the center among the pixel coordinates included in the first fruit region.

7. The method of claim 4, wherein the calculating the first representative distance value based on the distance values corresponding to the pixel coordinates included in the first fruit region comprises:
calculating the first representative distance value by applying weights to the distance values corresponding to the pixel coordinates included in the first fruit region.

8. The method of claim 7, wherein the weights are Gaussian-shaped weights set based on distances from a center pixel coordinate among the pixel coordinates included in the first fruit region.

9. The method of claim 1, wherein the first threshold distance value is calculated based on a distribution of the representative distance values for the plurality of fruit regions.

10. The method of claim 9, wherein the calculating the first threshold distance value for the first crop row based on the representative distance values for the plurality of fruit regions comprises:
generating a first histogram data based on the representative distance values for the plurality of fruit regions; and
calculating the first threshold distance value based on the first histogram data.

11. The method of claim 10, wherein a size of a unit distance range of the first histogram data is 10 cm or less.

12. The method of claim 10, wherein the calculating the first threshold distance value based on the first histogram data comprises:
obtaining a first sub-distribution data and a second sub-distribution data by applying the first histogram data to at least one mixture model; and
calculating the first threshold distance value based on the first sub-distribution data and the second sub-distribution data.

13. The method of claim 1, wherein the method for counting fruits corresponding to the crop row comprises:
obtaining a plurality of images corresponding to a second crop row;
obtaining a second representative distance values for second fruit regions based on the plurality of images corresponding to the second crop row;
calculating a second threshold distance value for the second crop row based on the second representative distance values for the second fruit regions; and
determining a number of fruits corresponding to the second crop row by comparing the second representative distance values for the second fruit regions with the second threshold distance value.

14. The method of claim 13, wherein the first threshold distance value and the second threshold distance value are different from each other.

15. The method of claim 13, wherein the plurality of images corresponding to the first crop row includes images obtained while a vehicle to which an image acquisition device is attached is moved in a first direction along a first rail located in a greenhouse, and
wherein the plurality of images corresponding to the second crop row includes images obtained while the vehicle to which the image acquisition device is attached is moved in a second direction, different from the first direction, along the first rail located in the greenhouse.
